(19) United States
(12) Patent Application Publication
(10) Pub. No.: US 2004/0153366 A1
(43) Pub. Date: Aug. 5, 2004

(54) System and method for buying and selling spots for advertisements in mass-market media

(75) Inventors: Thomas Francis Olson, Westport, CT (US); Kenneth Ernest Little, Deer Park, IL (US); Andrew Carlton Ward, Sleepy Hollow, NY (US); Nicholas Michael Garramone, New York, NY (US); Robin Fran Schlossman, Plainview, NY (US)

Correspondence Address: FITZPATRICK CELLA HARPER & SCINTO, 30 ROCKEFELLER PLAZA, NEW YORK, NY, 10112, US

(73) Assignee: National Cable Communications, LLC, New York, NY (US)

(21) Appl. No.: 10/743,413

(22) Filed: Dec. 23, 2003

Related U.S. Application Data
(60) Provisional application No. 60/437,020, filed on Dec. 31, 2002.

(51) Int. Cl. G06F 17/60

(52) U.S. Cl. 705/14

(57) ABSTRACT

A system for buying and selling spots for advertisements includes a central computer system connected to a global communications network. The system also includes an agency unit, a facilitator unit, and an affiliate unit, each of which are connected to the computer system via the network. The computer system includes a memory system storing a computer-executable program that includes an agency module, a facilitator module, and an affiliate module. The facilitator module enables an authorized facilitator user to input information to the memory system of the computer system regarding an advertisement, to view and/or edit the inputted information, and to perform communications with the agency and the affiliate regarding the advertisement. The agency module enables an authorized agency user to view and/or obtain information regarding the advertisement from the memory system of the computer system, and to perform communications with the facilitator regarding the advertisement. The affiliate module enables an authorized affiliate user to view and/or obtain information regarding the advertisement from the memory system of the computer system, and to perform communications with the facilitator regarding the advertisement.

This application claims benefit of U.S. Provisional Application No. 60/437,020, filed on Dec. 31, 2002, the entire contents of which is incorporated herein by reference.

### BACKGROUND OF THE INVENTION

1. Field of the Invention

The present invention relates generally to a system and method for buying and selling spots for an advertisement to be placed in mass-market media, such as television broadcasts, radio broadcasts, newspapers, and magazines, for example. More particularly, the present invention relates to a system and method for facilitating how spots for an advertisement to be shown by cable television affiliates are bought and sold.

2. Related Art

When an advertisement agency wants to promote a product, advertisements are placed in selected sectors of consumer markets to target a particular category of consumers most likely to purchase and/or use that product. For example, children are the most likely consumers to use a toy. Therefore, the agency is likely to place advertisements (referred to herein as “ads”) for the toy on cable television stations such as Nickelodeon® and the Cartoon Network®, for example, and radio stations such as Radio Disney®, for example, to entice children to purchase the toy or to ask their parents to purchase the toy. Preferably, because most children watch television or listen to the radio only between approximately 6 a.m. and 9 p.m., it is desirable for the ads to be aired during those hours to increase the likelihood that the targeted audience, the children, sees or hears them.

Further, it is often desirable to target an ad to a particular geographic region or market. For example, an ad for an amusement park preferably is targeted to be aired predominantly in areas within driving distance of the amusement park. Furthermore, it is generally desirable to air a foreign-language ad only on television or radio stations that air programs in that language.

The foregoing identifies only a few examples of the many considerations involved in arranging for an ad to be aired on cable television or radio stations. Other considerations include, for example: cost per ad, number of airings, frequency of airings, range of dates, number of stations per geographic region, number of geographic regions, etc.

The following discussion focuses on buying and selling spots for ads to be shown by cable television affiliates. It should be understood, however, that the present invention is not limited to such ads, but encompasses ads for any mass-market communication medium, including television broadcasts, radio broadcasts, newspapers, and magazines, for example.

Conventionally, before an ad is shown on a local cable-television system or affiliate, numerous considerations, including those mentioned above, need to be resolved through negotiations between three parties: an advertisement agency (referred to herein as an “agency”), which produces the ad and arranges for the ad to be shown; a cable television affiliate (referred to herein as an “affiliate”), which broadcasts or airs the ad; and a facilitator, which acts as an intermediary between the agency and the affiliate to facilitate arrangements for the agency to purchase ad space (referred to herein as “spots” or “air time”) that the affiliate has to sell.

Often, the agency intends the ad to be run in particular geographic regions, each of which is served by one or more local affiliates. Therefore, the facilitator helps the agency negotiate with multiple affiliates to arrange multiple advertisement schedules, taking into consideration each affiliate's available spots, the agency's budget, time/date restrictions, etc. Therefore, many back-and-forth communications between the parties are required to resolve the numerous considerations before an agreement is reached on an ad schedule for each affiliate.

One problem with such a conventional process is that it is cumbersome for the agency, the facilitator, and the affiliates to keep track of the various communications that take place regarding the ad. The conventional process for buying and selling spots for ads requires a great of deal of time to organize the paperwork for and keep track of the many communications that occur between all the parties, which complicates the process and makes it difficult to monitor the status of ad proposals, orders, and agreements, among other things.

### SUMMARY OF INVENTION

In view of the above-mentioned problems and considerations, it is an object of the present invention to provide a system, based on communications via the Internet, in which an agency, a facilitator, and an affiliate may easily buy and sell spots for ads to be shown by the affiliate. The system includes a central computer system with a memory system that includes at least one memory storing computer-executable code of a program. The program may include three modules: an agency module, a facilitator module, and an affiliate module. The computer system also includes a processor for executing or running the program. Preferably, the computer system is controlled by the facilitator.

Each module is accessible by authorized users, through use of a logon identification code and a password (collectively referred to herein as a “logon ID”). The logon ID identifies the access privileges of the user. That is, some logon IDs enable the user to view and edit certain data associated with the inputted logon ID, as well as to enter and store new data, while other logon IDs allow the user only to view certain data but not make any changes.

The agency module enables any or all of the following functions to be performed:

submission of spot-availability requests to the facilitator;

review of proposals from the facilitator regarding the requests;

submission to the facilitator of responses to proposals;

review of orders arranged with the affiliate;

generation of contracts based on accepted orders;

review of contracts;

review of invoice information;

downloading (export) of a formatted version of requests, proposals, contracts, orders, and/or invoice information for further “off-line” analysis using the agency's software;

printing of a paper copy of requests, proposals, contracts, orders, and/or invoice information; and

tracking of the status of requests, proposals, orders, contracts, and/or invoices.

The agency module thus enables the agency to easily manage its advertising business. The program code and the agency data associated with the agency module are stored in the memory system of the computer system. Because the facilitator users generally are able to view the same information that is viewable by the agency users, use of the agency module promotes constructive dialogue, thus reducing the time and the paperwork involved in arranging for an ad to be shown.

Multiple agencies may access the agency module to communicate with the facilitator. To ensure privacy between the multiple agencies, each agency may be assigned logon IDs that enable the agency to access only data associated with that agency. Optionally, also to ensure privacy for each ad under consideration, an agency user's logon ID may provide access only to data associated with specific ads being handled by that agency user, and not all ads of the agency.

The facilitator module enables any or all of the following functions to be performed:

reception of spot-availability requests from the agency;

exchange of information with the affiliate regarding the availability of spots;

prepare and/or revise proposals for an ad schedule;

submission of proposals to the agency;

generation of orders based on accepted proposals;

submission of orders to the affiliate;

revision of order information;

generation of contracts based on accepted orders;

revision of contract information;

exchange of information with the affiliate regarding an affidavit of performance;

preparation and/or revision of invoice information; and

tracking of the status of requests, proposals, orders, contracts and/or invoices.

The facilitator module is accessible by facilitator users, who generally may view, edit, and add data. The program code and the data associated with the facilitator module are stored in the memory system of the computer system.

The affiliate module enables any or all of the following functions to be performed:

exchange of information with the facilitator regarding the availability of spots;

review of orders for ad schedules;

acceptance of orders;

revision of order information;

generation of contracts based on accepted orders;

review of contracts;

exchange of information with the facilitator regarding an affidavit of performance; and

tracking of the status orders and contracts.

The affiliate module thus enables the affiliate to easily manage its advertising business. The program code and the data associated with the affiliate module are stored in the memory system of the computer system. Because the facilitator users generally are able to view the same information that is viewable by the affiliate users, use of the affiliate module promotes constructive dialogue, thus reducing the time and the paperwork involved in arranging for an ad to be shown.

Multiple affiliates may access the affiliate module to communicate with the facilitator. To ensure privacy between the multiple affiliates, each affiliate is assigned logon IDs that enable the affiliate to access only data associated with that affiliate. Optionally, to ensure privacy for each ad under consideration, an affiliate user's logon ID may provide access only to data associated with specific ads being handled by that affiliate user, and not all ads to be shown by the affiliate.

These and other object, features, and advantages will be apparent from the following description of the preferred embodiments of the present invention.

### BRIEF DESCRIPTION OF THE DRAWINGS

The present invention will be more readily understood from a detailed description of the preferred embodiments taken in conjunction with the following figures.

FIG. 1 is a schematic diagram of a system for facilitating the process of buying and selling spots for ads;

FIG. 2 is a flow chart for understanding the process of buying a spot for an ad;

FIG. 3 is a flow chart for understanding a user logon process;

FIG. 4 shows an example of a LOGON page;

FIG. 5 shows an example of a FORGOT PASSWORD page;

FIG. 6 shows an example of a RE-LOGON page;

FIGS. 7 and 8 show examples of CHANGE PASSWORD pages;

FIG. 9 shows an example of a RE-CHANGE PASSWORD page;

FIG. 10 shows an example of a PASSWORD FAILURE page;

FIG. 11 shows an example of a PASSWORD CONFIRMED page;

FIG. 12 shows an example of a CHALLENGE page;

FIG. 13 shows an example of a REGISTRATION page;

FIG. 14 shows an example of a WELCOME page;

FIG. 15 shows an example of an initial page of a secure information site of an agency module of the system;

FIG. 16 shows an example of an FAQ page;

FIG. 17 shows an example of a CONTACTS page;

FIG. 18 shows an example of an ORDER SEARCH;

FIG. 19 shows an example of an order-list page resulting from a search;

FIGS. 20a through 20d show examples of order-information pages that may be viewed from the order list;

FIG. 21 shows an example of a displayed print version of an order;

FIG. 22 shows an example of a contract-list page;

FIG. 23 shows an example of a page contract-information page;

FIG. 23a shows an example of a displayed print version of a contract;

FIG. 24 is a flow chart for understanding the processing of viewing orders and contracts;

FIG. 25 shows an example of a DOWNLOAD page for downloading order information;

FIG. 26 shows an example of a page displayed when a downloading operation has finished;

FIG. 27 shows an example of a proposal-list page resulting from a search;

FIG. 28 shows an example of a page with proposal details;

FIG. 29 shows an example of an Email Comment sent as an email message;

FIG. 30 shows an example of how an agency user may make comments on a proposal;

FIG. 31 shows an example of how an agency user may make comments on a line item in a proposal;

FIG. 32 shows an example of a DOWNLOAD page for downloading proposal information;

FIG. 33 shows an example of downloaded/exported proposal information;

FIG. 34 shows an example of a printable version of proposal information;

FIG. 35 shows an example of a SEARCH page for searching for invoice information;

FIG. 36 shows an example of an INVOICE LIST page resulting from an invoice-information search;

FIG. 37 shows another example of an INVOICE LIST page resulting from an invoice-information search;

FIG. 38 shows an example of an invoice-information page for a selected invoice entry;

FIG. 39 shows an example of an invoice-information page for an invoiced directly billed by an affiliate;

FIG. 40 shows an example of an initial page of a secure information site of an affiliate module of the system;

FIG. 41 shows an example of an ORDER SEARCH page of the affiliate module;

FIG. 42 shows an example of a SYSTEM ORDER LIST page resulting from a system-order search;

FIG. 43 shows an example of a system-order information page for a selected system order;

FIG. 44 shows an example of a page for confirming acceptance of a system order;

FIG. 45 shows an example of an updated system-order information page;

FIG. 46 shows an example of a DOWNLOAD page for downloading system-order information;

FIG. 47 shows an example of an ORDER SEARCH page of a facilitator module of the system;

FIG. 48 shows an example of a page with a list of orders;

FIGS. 49a and 49b show examples of pages with order information;

FIGS. 50a and 50b show examples of pages with system-order information;

FIG. 51 shows an example of a page with a list of contracts;

FIG. 52 shows an example of a WELCOME P page of an availability request/projections sub-module;

FIG. 53 shows an example of a page for creating a new availability request;

FIG. 54 shows an example of a PROPOSAL SEARCH page;

FIG. 55 shows an example of a page with a list of proposals;

FIG. 56 shows an example of a page with proposal information;

FIG. 57 shows an example of a printable version of a proposal;

FIG. 58 shows an example of a page for attaching comments to a proposal; and

FIG. 59 shows an example of page with updated proposal information.

### DETAILED DESCRIPTION OF THE PREFERRED EMBODIMENTS

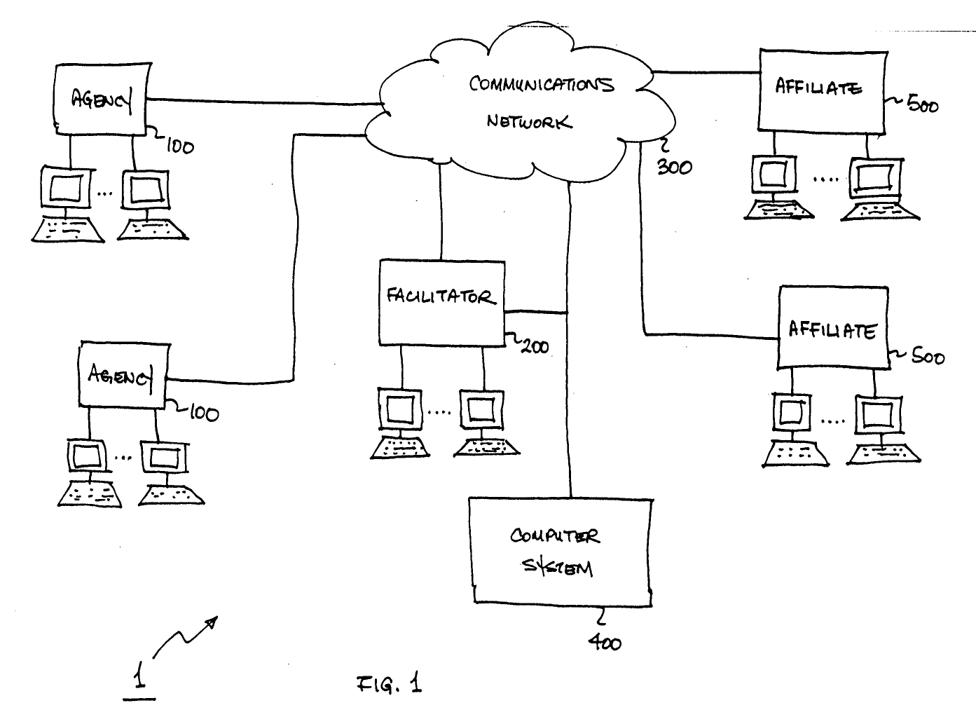

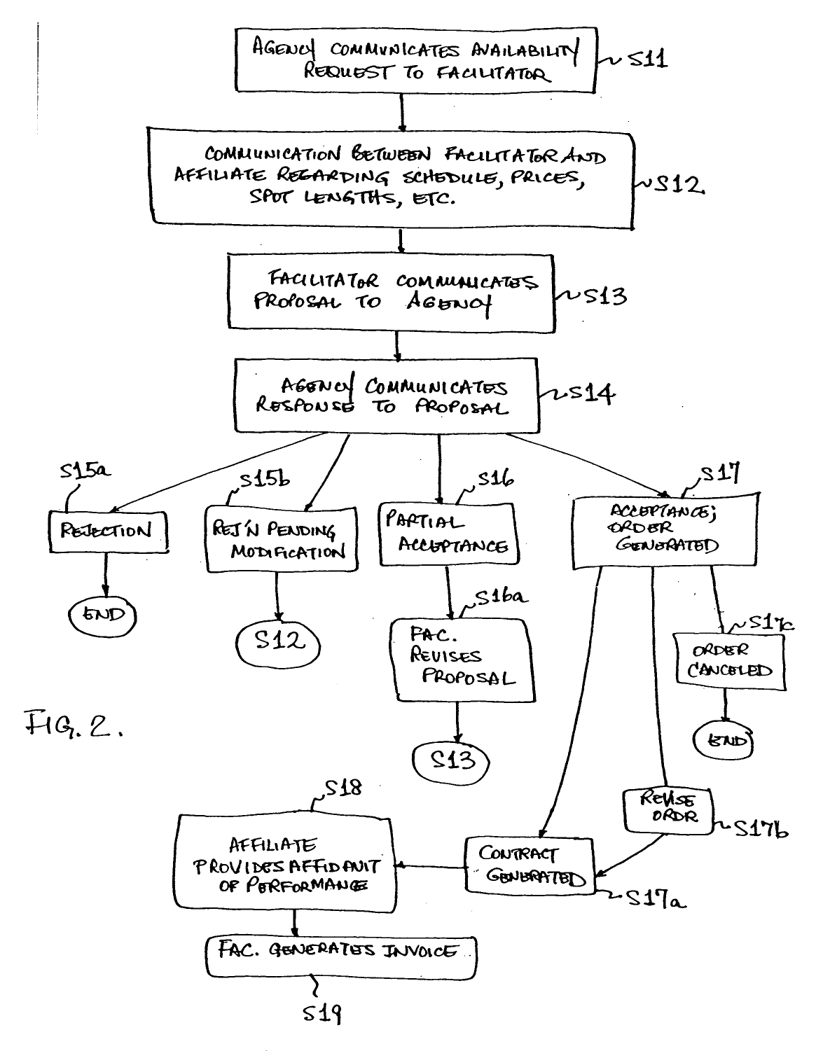

FIG. 1 schematically depicts a system 1 for facilitating the process of buying and selling spots for ads. The system includes agencies 100, a facilitator 200, and affiliates 500 connected to each other via at least one global communications network 300. For example, the network 300 may include either or both of the Internet and a public telephone network. A central computer system 400 is provided through which communications are performed between the agency 100, the facilitator 200, and the affiliate 500 via the network 300. As shown in FIG. 1, more than one agency 100 and more than one affiliate 500 may be included in the system 1. Also, each agency 100, each affiliate 500, and the facilitator 200 may have multiple users.

It should be understood that the facilitator may also interact with the agency and the affiliate via facsimile transmissions, overnight courier services, electronic mail, and/or the U.S. Postal Service, in addition to communications via the network 300.

The computer system 400 includes a memory system (not shown) with at least one memory storing computer-executable code of a program for implementing a process for buying and selling spots for ads, and at least one memory storing data associated with the buying and selling process. For example, the memory system includes at least one of the following: a read-only memory (ROM) unit, a random-access memory (RAM) unit, a hard disk unit, a floppy disk unit, a recordable/rewritable compact disk (CD) unit, a flash memory unit, an optical memory unit, a magneto-optical memory unit.

The computer system 400 also includes a processor (not shown) for executing or running the program stored in the memory system. Preferably, the computer system 400 is maintained by the facilitator 200.

Preferably, the program includes at least three modules: an agency module, a facilitator module, and an affiliate module. The modules are described in detail below. Each module is accessible by authorized users, through use of a logon ID. The logon ID identifies the access privileges of the user. More specifically, the logon ID determines whether the user is allowed only to view data, which is stored in the memory system, associated with the inputted logon ID, or whether the user is allowed to view and edit data stored in the memory system, as well as input new data to be stored in the memory system.

FIG. 2 is a flow chart for understanding the general process of buying an ad to be shown by the affiliate 500, according to an embodiment of the present invention. In step S11, the agency 100 communicates an availability request to the facilitator 200. The availability request may be communicated via any or all of the network 300, a facsimile transmission, email, the U.S. Postal Service, and a face-to-face meeting.

The availability request includes information regarding any or all of the following: the subject of the ad, i.e., the product or service to be advertised; the preferred time and date ranges; the preferred geographic region; the targeted consumer market; and the budget limit. Also included with the request is contact information for the agency representative handling the ad.

The information is stored in the memory system of the computer system 400, and is viewable by authorized users of the facilitator 200 and authorized users of the agency 100.

In step S12, the facilitator 200 communicates with an affiliate 500 to obtain information on any or all of the following: the appropriateness of the subject of the ad for the television station owned or managed by the affiliate 500; the schedule of available spots or time slots; the time lengths (or duration) of the available spots; and the fee per spot for a given duration. The communications may occur via any or all of the following: the network, a facsimile transmission, email, the U.S. Postal Service, and a face-to-face meeting. Information provided by the affiliate 500 is stored in the memory system of the computer system 400, and is viewable by authorized users of the facilitator 200 and authorized users of the affiliate 500.

In step S13, the facilitator 200 responds to the availability request by providing the agency 100 with a proposal for the ad, based on the information provided by the affiliate 500. The proposal is communicated via the network 300 and includes information regarding any or all of the following: the affiliate station; the geographic region covered by the affiliate station; the viewership demographics of the affiliate station; the number of spots available; a proposed time schedule for the ads; the cost per spot; and the total cost for the proposed schedule. Optionally, the proposal may be communicated via any or all of the following: a facsimile transmission, email, the U.S. Postal Service, and a face-to-face meeting. The proposal is stored in the memory system of the computer system 400, and is viewable by authorized users of the facilitator 200 and authorized users of the agency 100.

In step S14, the agency 100 communicates a response to the proposal by accepting it fully, accepting it partially, accepting it with specific modifications, or rejecting it. Preferably, the response is communicated via the network 300 to the facilitator 200. Optionally, the communication may occur via any or all of the following: a facsimile transmission, email, the U.S. Postal Service, and a face-to-face meeting. The response to the proposal may appear as comments added to the proposal viewed via the network 300, and is stored in the memory system of the computer system 400.

If the response is a rejection, in step S15a the process ends.

If the response is a rejection unless specific modifications are made, in step S15b the agency 100 notifies the facilitator 200 of the desired modifications in the response. The process then returns to step S12, in which the facilitator 200 communicates with the affiliate 500 to see whether the modifications are possible. Generally, the communication is performed via the network 300. Optionally, the communication may occur via any or all of the following: a facsimile transmission, email, the U.S. Postal Service, and a face-to-face meeting.

If the response in step S14 is a partial acceptance, in step S16 the agency 100 provides the facilitator 200 with a list or schedule of the accepted spots (or a list or schedule of the rejected spots) for the ad. Generally, the list or schedule of accepted or rejected spots is communicated via the network 300. Optionally, the communication may occur via any or all of the following: a facsimile transmission, email, the U.S. Postal Service, and a face-to-face meeting.

In step S16a the facilitator 200 revises the proposal, and the process returns to step 13. The revised proposal is stored in the memory system of the computer system 400, and is viewable by authorized users of the facilitator 200 and the agency 100.

If the response in step S14 is a full acceptance, the process automatically proceeds to step S17. In step S17, the facilitator 200 generates an order for the schedule of ads from the accepted proposal, and communicates the order to the affiliate 500 via the network 300. The order is stored in the memory system of the computer system 400, and is viewable by authorized users of the facilitator 200, the agency 100, and the affiliate 500. Generally, the communications are performed via the network 300. Optionally, the communications may occur via any or all of the following: a facsimile transmission, email, the U.S. Postal Service, and a face-to-face meeting.

If the order is agreed to or confirmed by the affiliate 500, in step S17a a contract is automatically generated, and the contract is communicated to the agency 100 via the network 300. The contract is stored in the memory system of the computer system 400, and is viewable by authorized users of the facilitator 200, the agency 100, and the affiliate 500. In step S17b, if the order is revised and reconfirmed, a new contract is generated in step S17a. If the agency 100 cancels the ad, in step S17c the order is canceled and the process ends. The status of the order may appear as comments added to the viewable proposal, and is stored in the memory system of the computer system 400.

In step S18, after the contracted order has been fulfilled, the affiliate 500 provides the facilitator 200 with an affidavit, stating that the schedule of ads indicated in the order have been shown. Generally, the affidavit is provided in a communication via the network 300. Optionally, the communication may occur via any or all of the following: a facsimile transmission, email, and a face-to-face meeting. Information regarding the affidavit is stored in the memory system of the computer system 400, and is viewable by authorized users of the facilitator 200, the affiliate 500, and the agency 100. The affidavit itself may also be stored in the memory system of the computer system 400.

In step S19, the facilitator 200 generates an invoice for the shown ads, based on the contracted order and the affidavit, and provides the invoice to the agency 100. Information regarding the invoice is stored in the memory system of the computer system 400, and is viewable by authorized users of the facilitator 200 and authorized users of the agency 100. The invoice itself may also be stored in the memory system of the computer system 400.

Agency Module

The agency module of the program enables an authorized user of the agency 100 to communicate information to the facilitator 200 regarding an ad, and to review information communicated from the facilitator 200 regarding the ad. In the following example, the network 300 is the Internet.

The agency 100 accesses the agency module via the Internet using a computer terminal to input the Internet address corresponding to the agency module. Any known Internet-access provider or other means for accessing the Internet may be used. As mentioned above, only authorized agency users may access information stored in the memory system of the computer system 400. Also, only authorized agency users may add information to the memory system of the computer system 400.

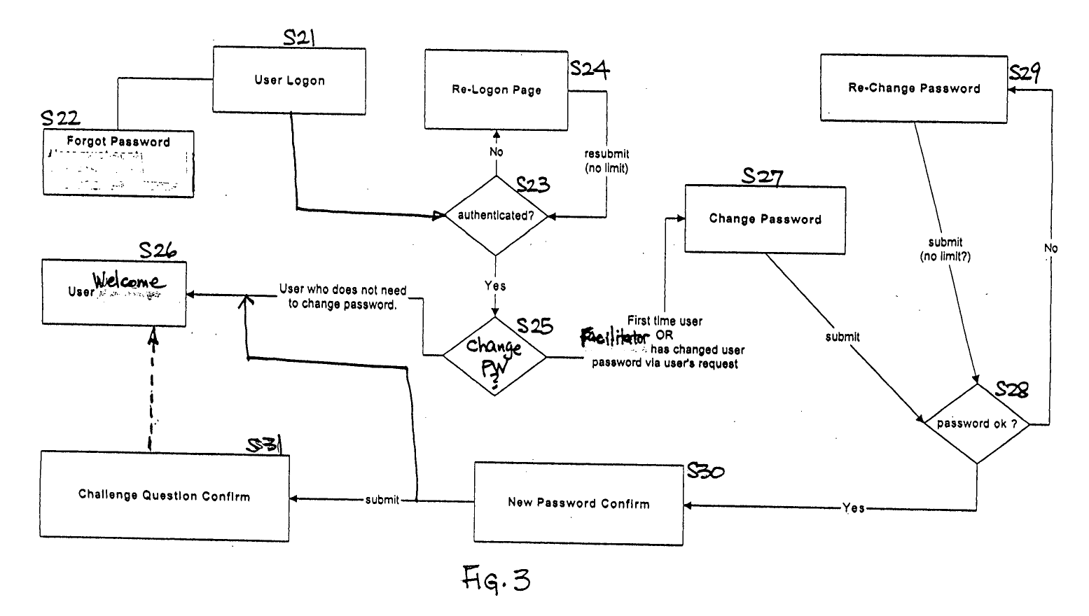

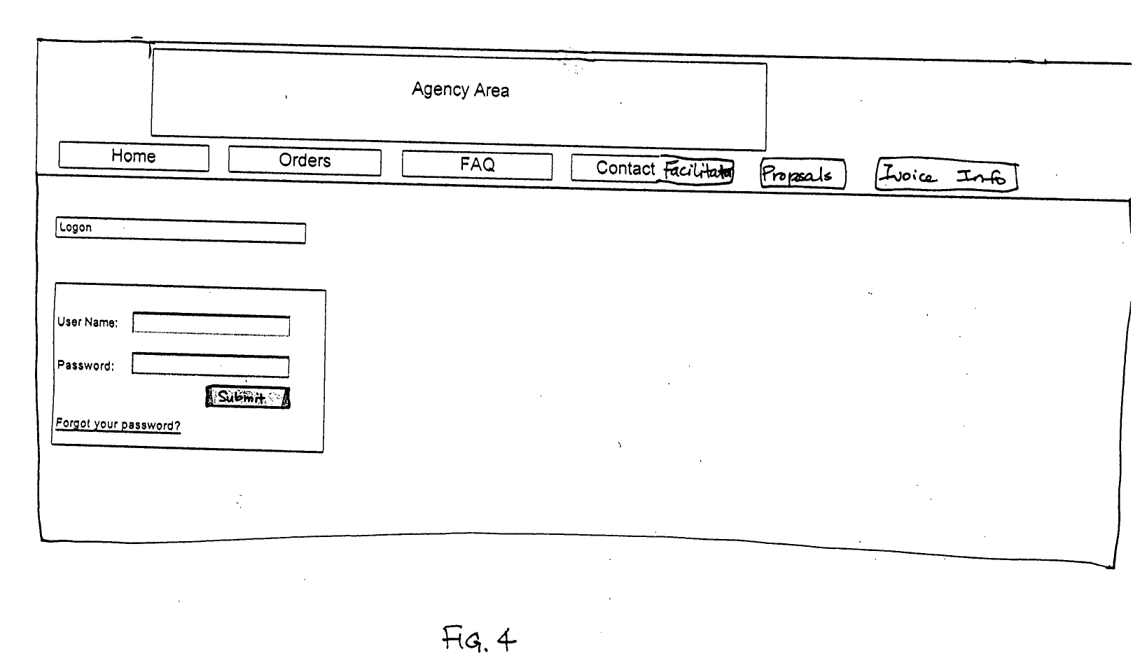

In order to determine whether an agency user has authorization to access databases corresponding to the agency module, a logon sub-module of the agency module may be employed to require the agency user to go through a logon process. FIG. 3 is a flow chart for understanding such a logon process.

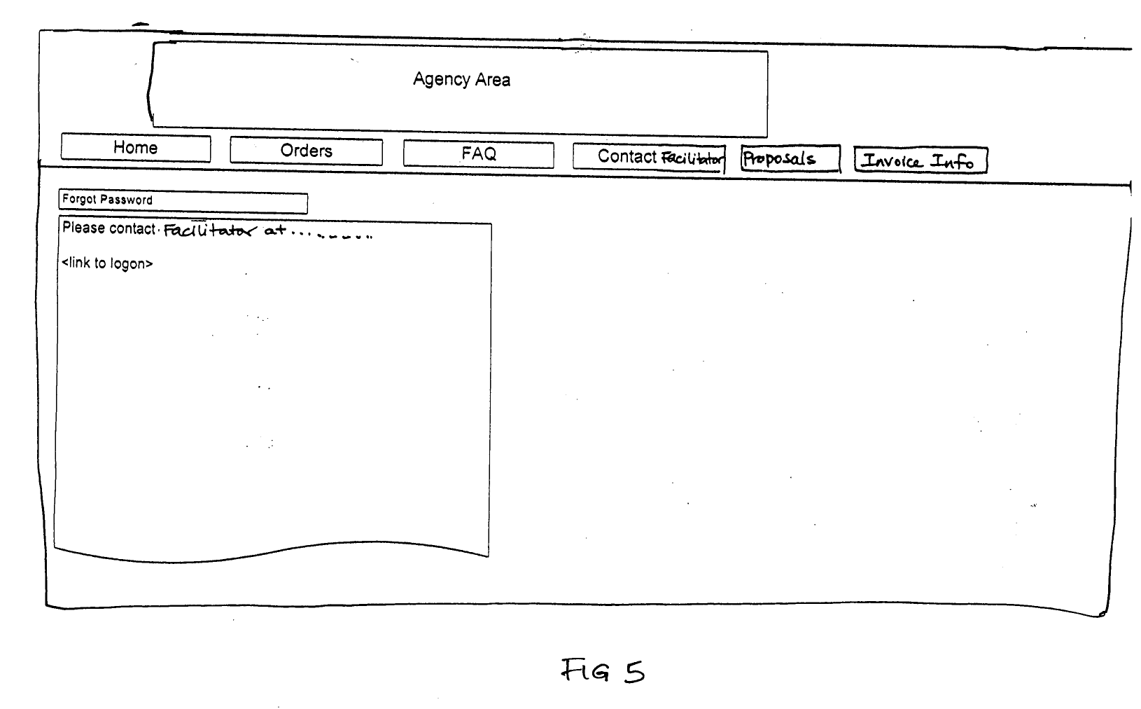

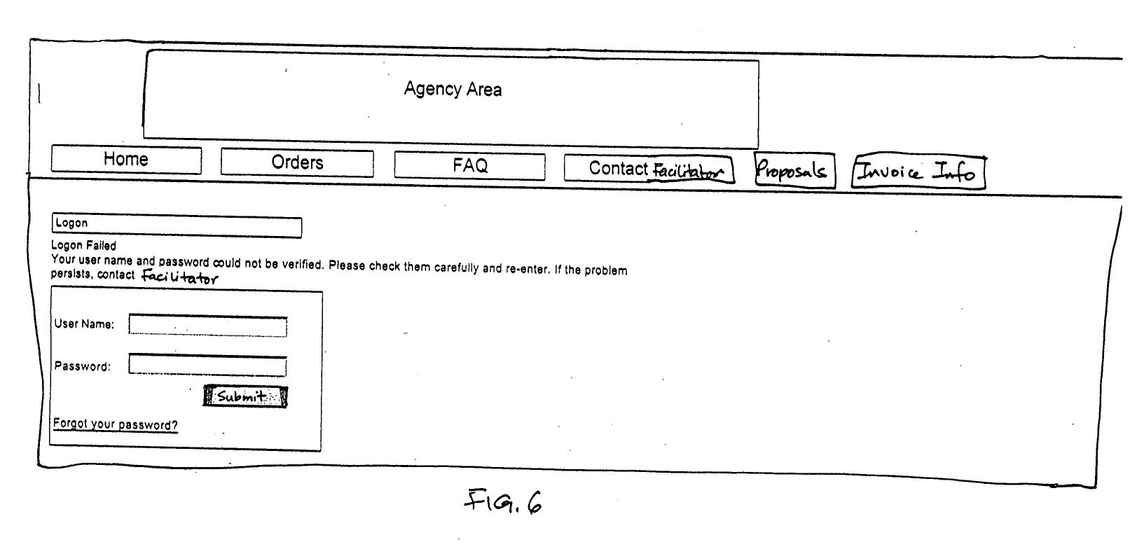

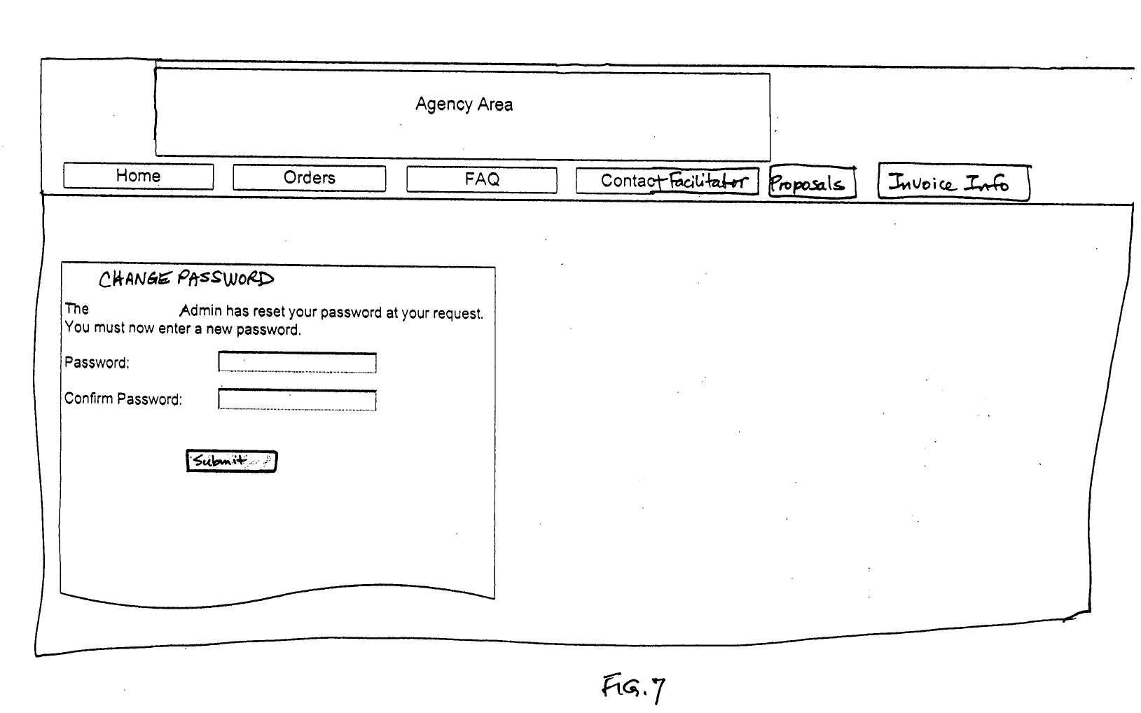

In step S21, a LOGON page, such as shown in FIG. 4, is displayed at the agency user's computer terminal, which prompts the user to input a user name and a password. If the user inputs an indication that the password has been forgotten, in step S22, the logon process causes a FORGOT PASSWORD page to be displayed, such as shown in FIG. 5, with information on how to obtain/change the forgotten password by contacting the facilitator 200. If the user inputs a password, in step S23 the password is authenticated using information stored in a database corresponding to the agency module. If the password is not valid, in step S24 a RE-LOGON page is displayed, such as shown in FIG. 6, with a message indicating that the inputted password is invalid and prompting the user to input a valid password.

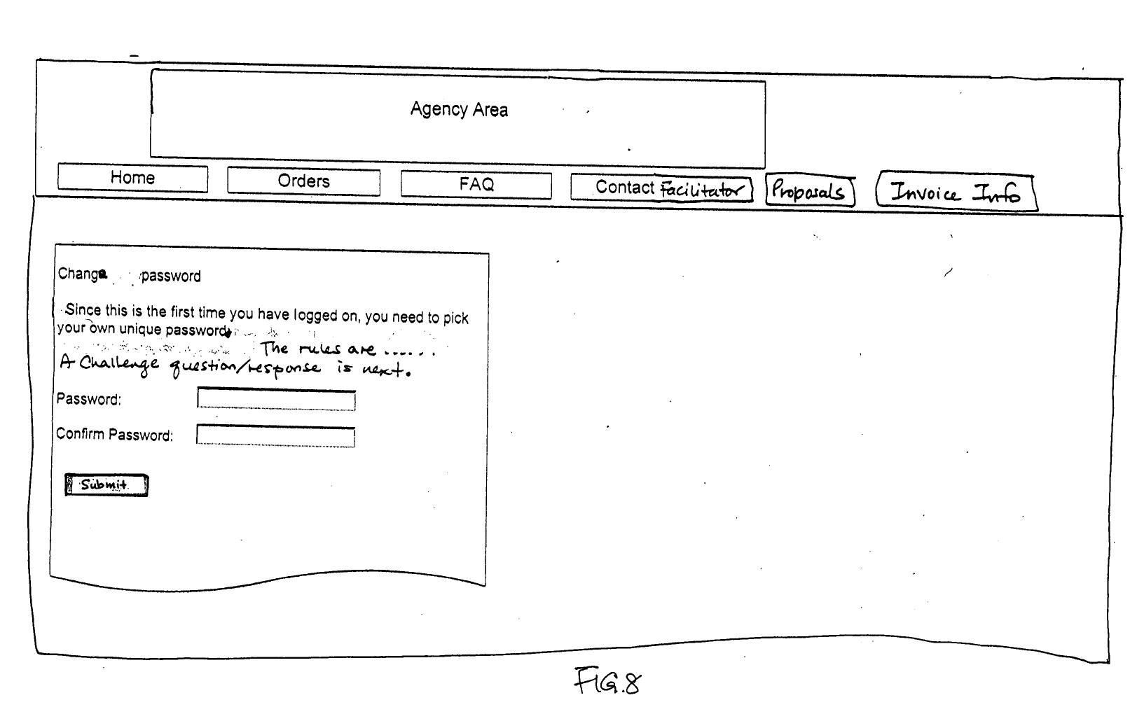

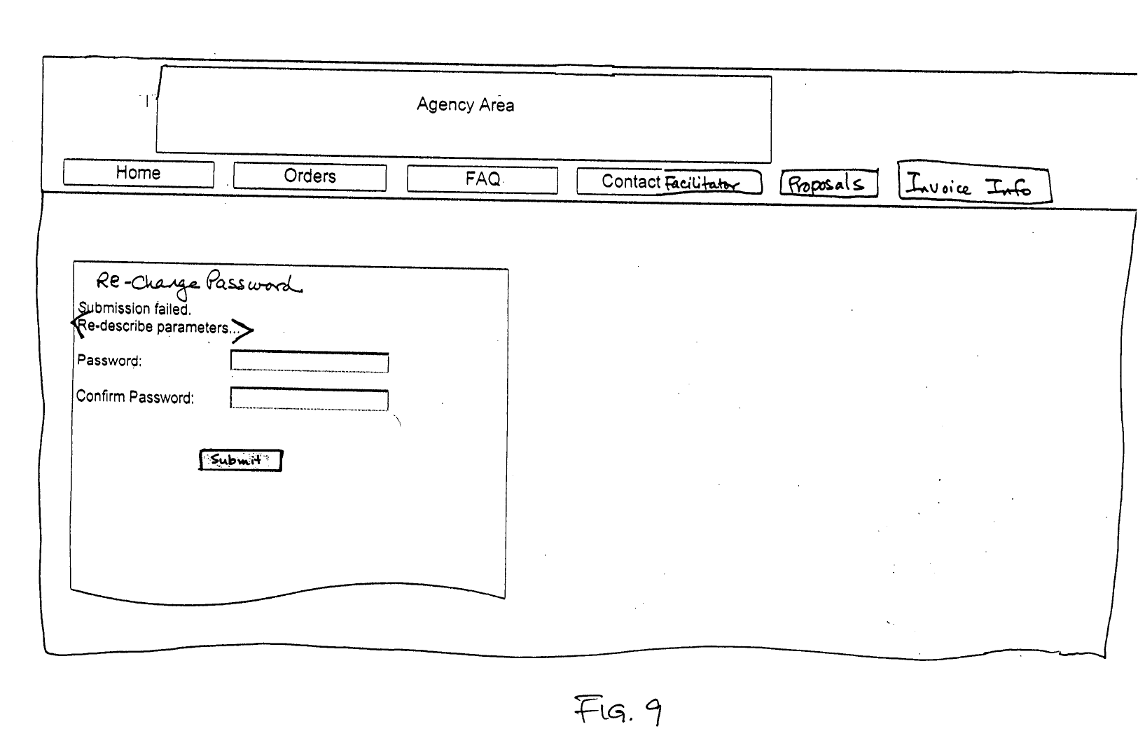

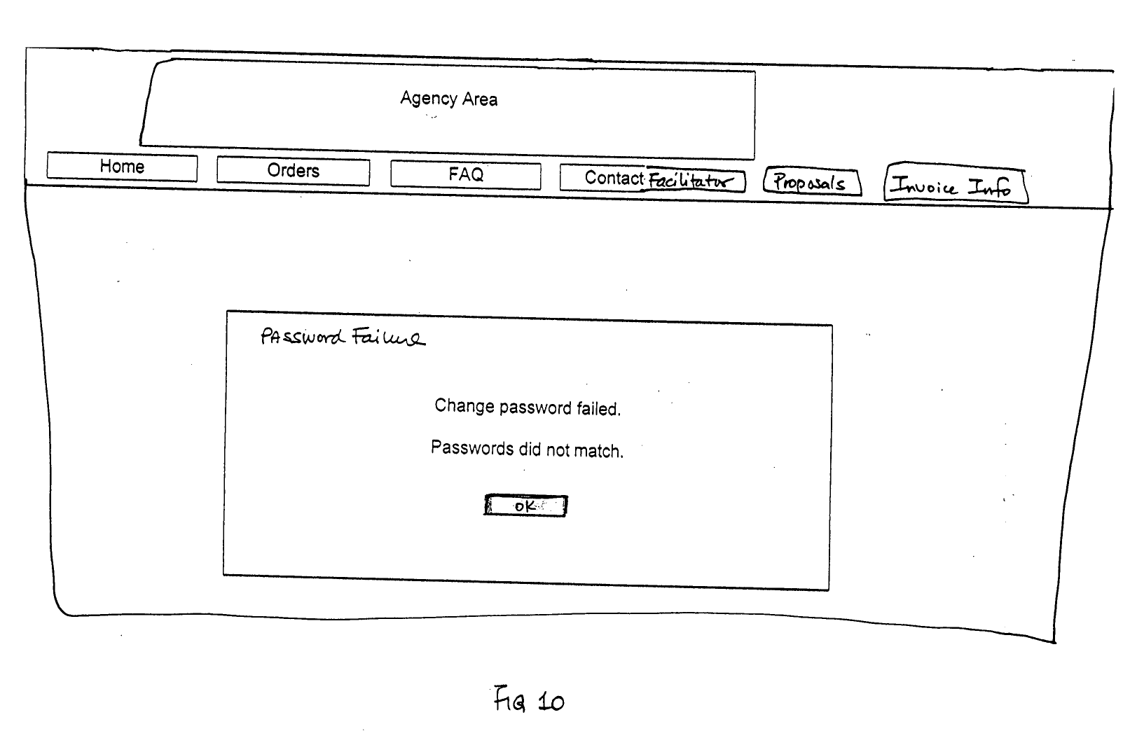

If the password is valid, in step S25 a PASSWORD CHANGE? page is displayed, in which the agency user is asked to indicate whether a change of the password is desired. If the answer is affirmative or if it is the first time that the user has logged on, in step S27 a CHANGE PASSWORD page is displayed, such as respectively shown in FIGS. 7 and 8, is displayed prompting the user to input and confirm a new password. If it is the first time that the user has logged on, the CHANGE PASSWORD page (FIG. 8) also includes a message that a challenge question and response will be required. In step S28, the agency module checks whether the new password is acceptable, such as whether the new password contains sufficient characters, for example. If the new password is not acceptable, in step S29 a RE-CHANGE PASSWORD page is displayed, such as shown in FIG. 9, with a message indicating that the new password is unacceptable and prompting the user to input and confirm an acceptable new password. To guide the user, the criteria for an acceptable password is also displayed.

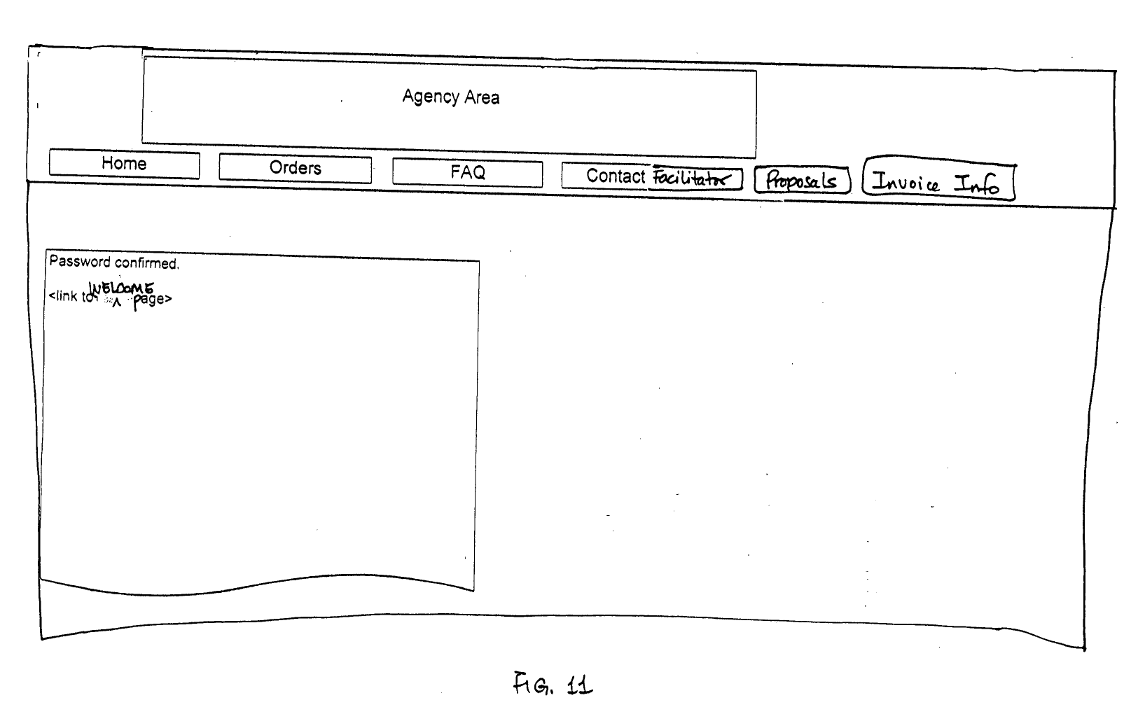

If the confirmation password does not match the newly inputted password, a PASSWORD FAILURE page is displayed to notify the user of the incorrect entry, such as shown in FIG. 10. The logon process then returns to step S27.

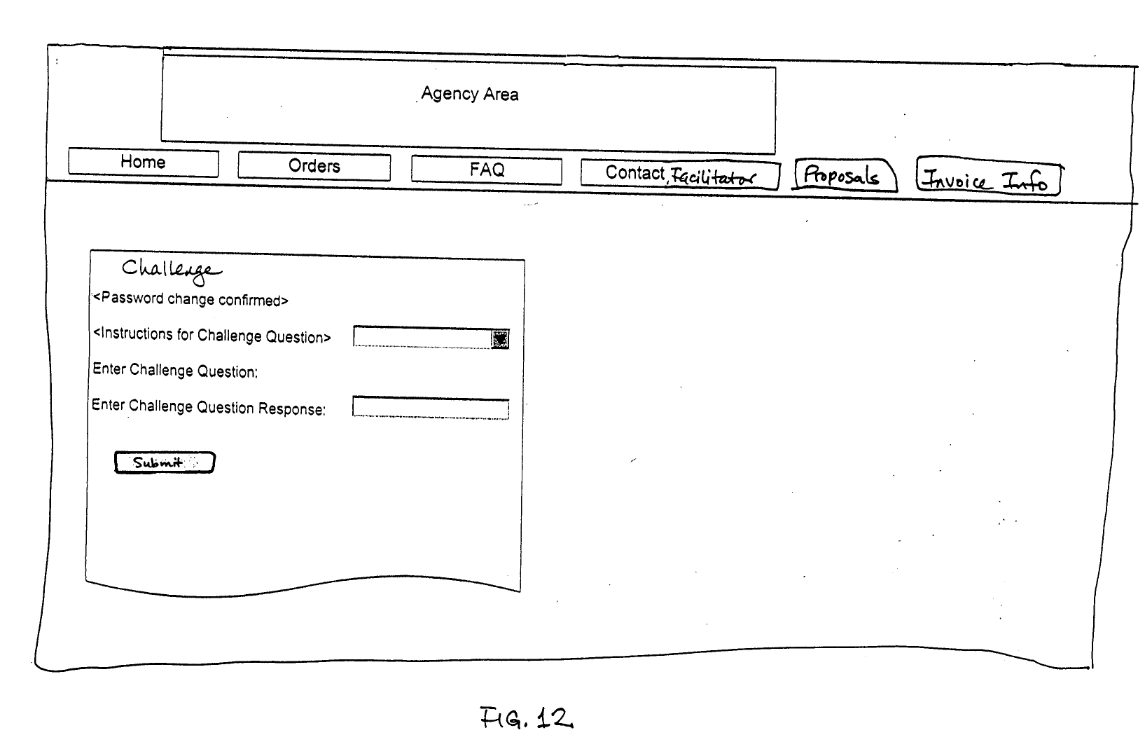

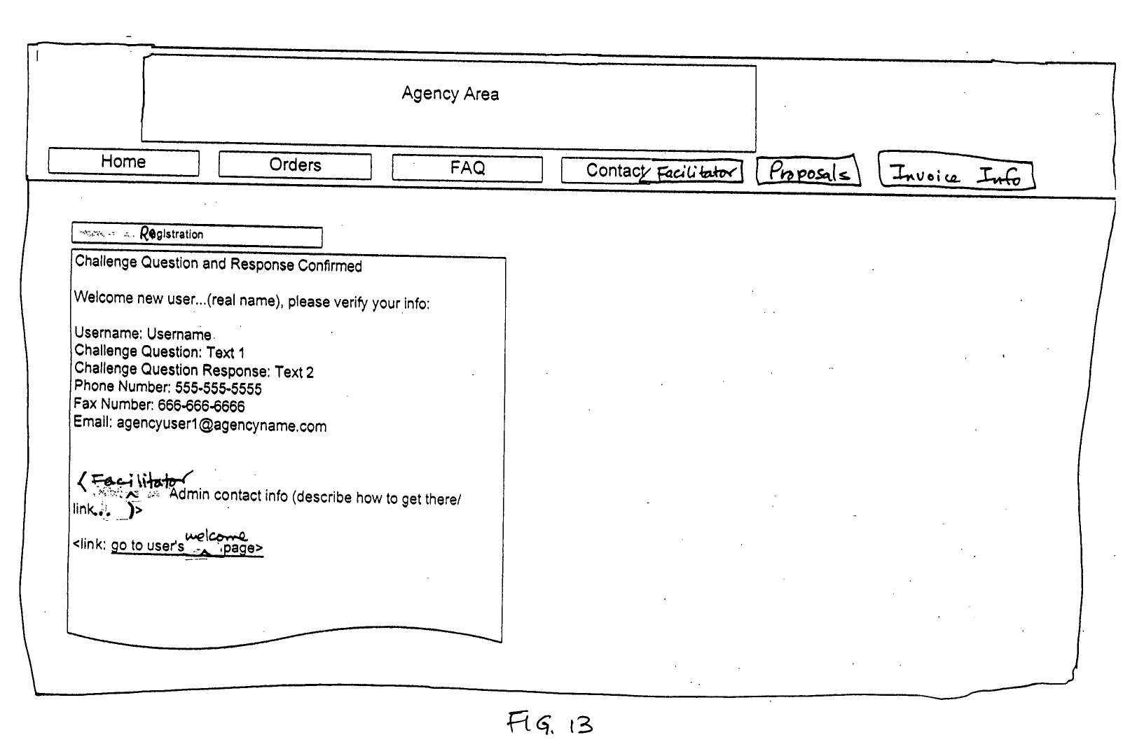

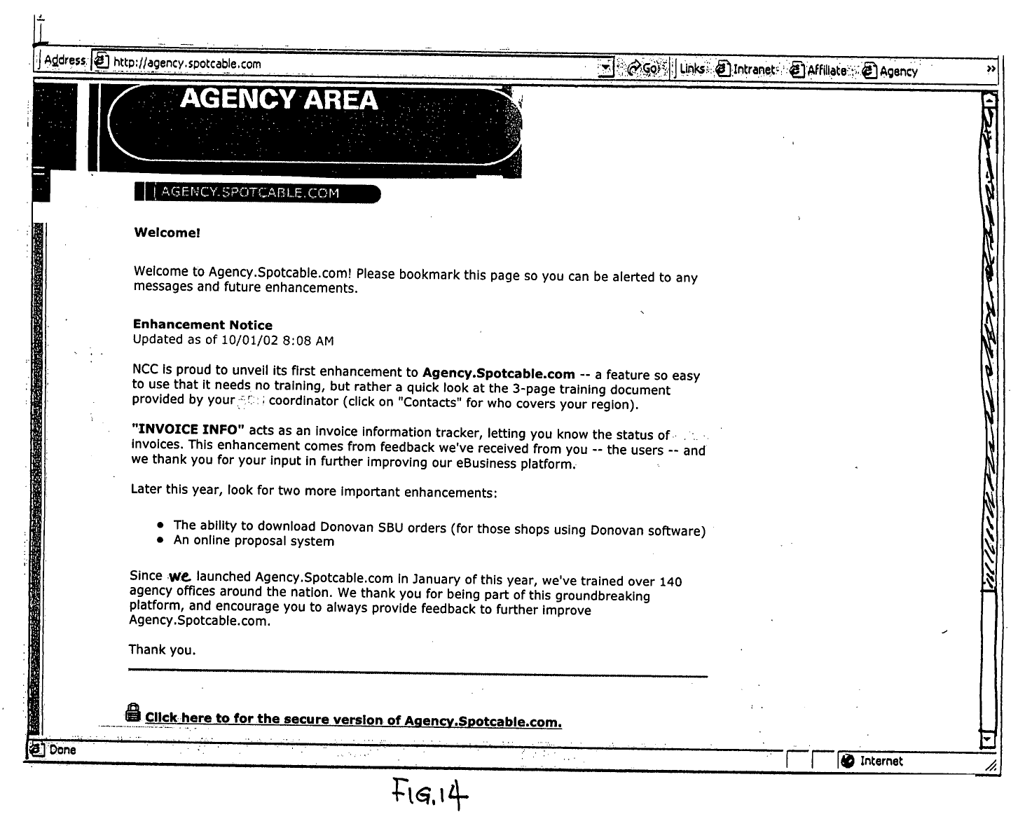

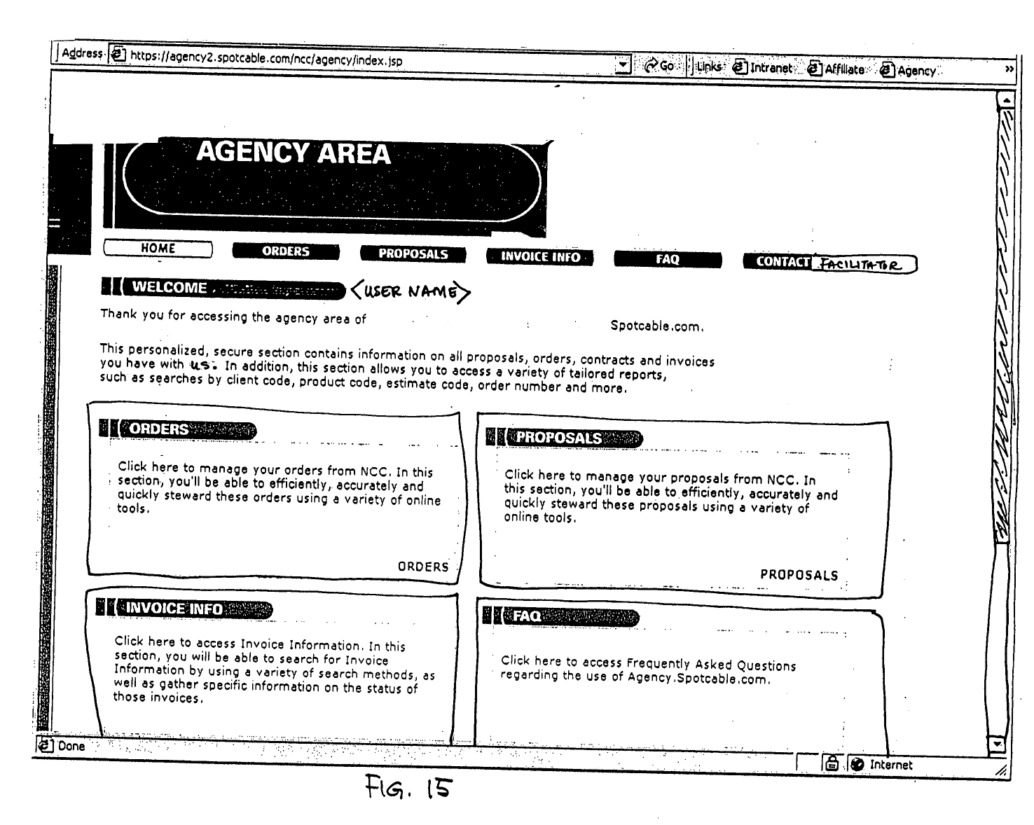

If the new password is acceptable, in step S30 the new password is confirmed and a PASSWORD CONFIRMED page is displayed, such as shown in FIG. 11. Next, in step S31, a CHALLENGE page is displayed, which prompts the agency user to input a challenge question and also to input an answer to the challenge question, to ensure that the password is being changed by an authorized user corresponding to the password, such as shown in FIG. 12. For example, the challenge question may be: “What is your mother's maiden name.” If a correct response is inputted, a REGISTRATION page, such shown in FIG. 13, is displayed. The REGISTRATION PAGE contains information regarding the user, such as the user's contact information, as well as information for contacting the facilitator 200. The flow then proceeds to step S26, and a WELCOME page is displayed, such as shown in FIG. 14.

In step S25, if the agency user chooses not to change the password and if it is not the first time that the user has logged on, the WELCOME page is displayed in step S26.

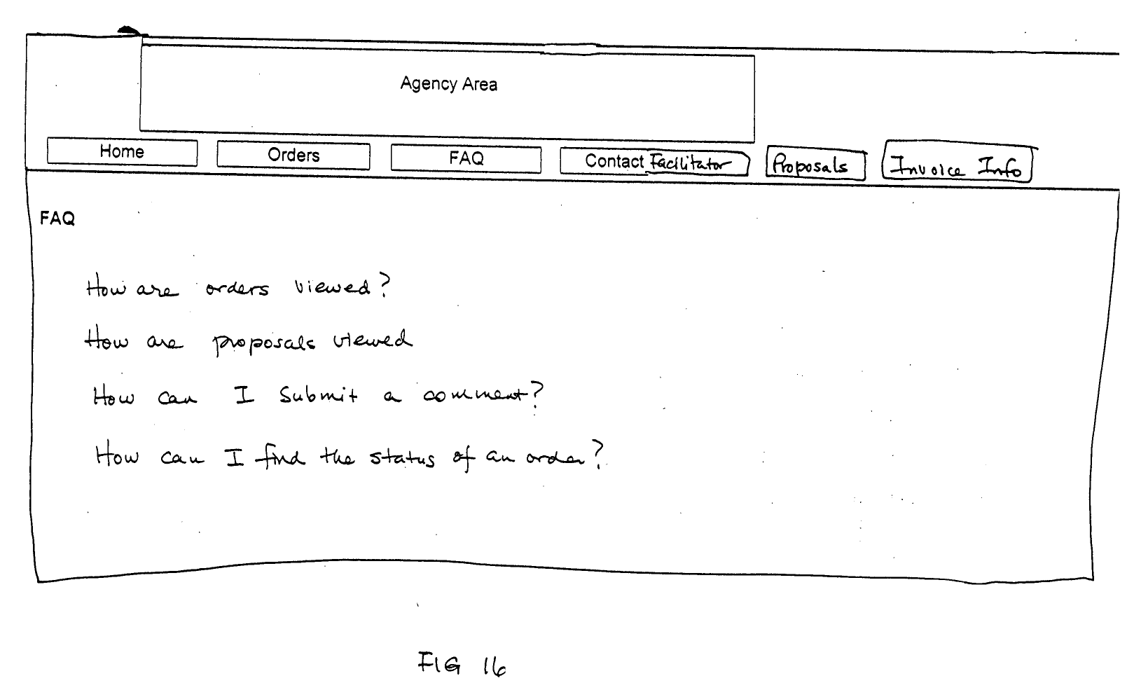

The WELCOME page includes general information of interest to the agency 100, including notices regarding changes and upgrades to the agency module, for example. The WELCOME page may include more than one display page connected by electronic links. For example, to go beyond the display page shown in FIG. 14, the agency user clicks on the lock icon at the lower left, which links the user to a secure information site. Any known linking technique may be used, including linking using Hypertext Markup Language (HTML), for example. FIG. 15 shows an example of an initial display page of the secure information site, which identifies information topics that the user has access to, and provides electronic links to those topics.

As discussed above, the logon process enables authorized agency users to access the agency module. Depending on the agency user's logon ID, the user may have access to any or all of the following information databases associated with the agency module. In the example shown in FIG. 15, the user has access to information regarding proposals, orders, invoice information, and frequently asked questions (FAQ), as well as contact information for contacting personnel of the facilitator 200. Also, depending on the agency user's logon ID, the agency user may have access only to information regarding certain ads being handled by the agency or all ads being handled by the agency.

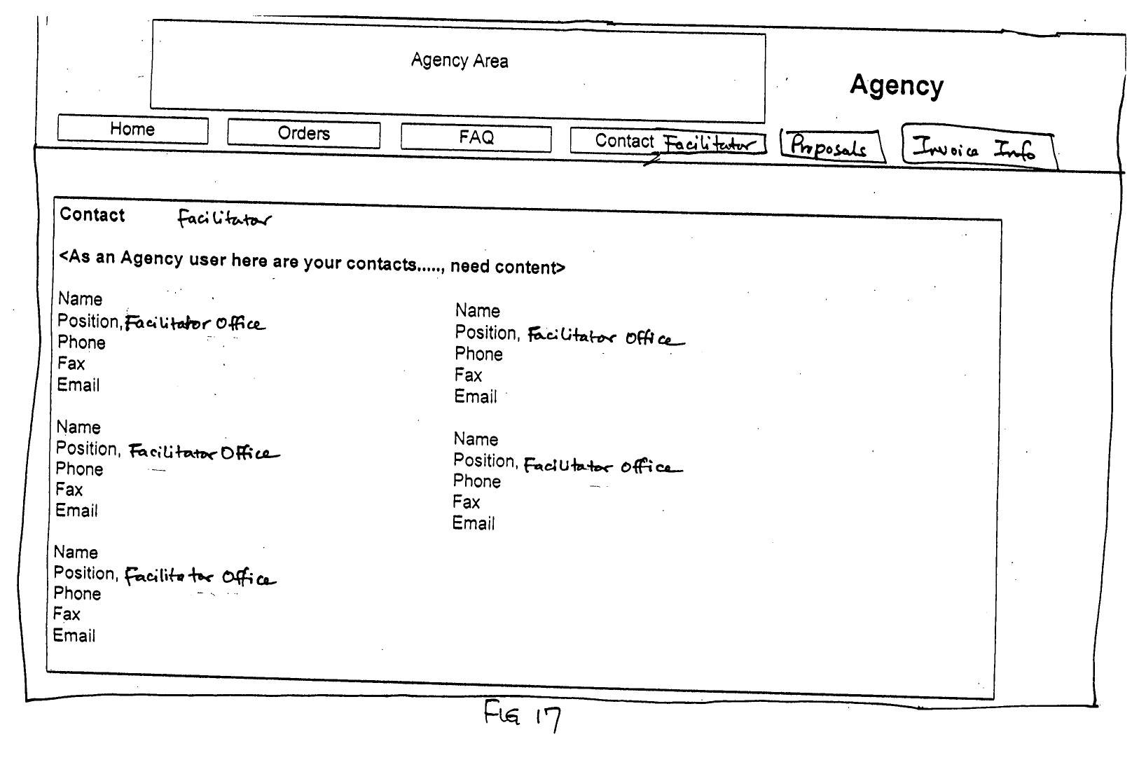

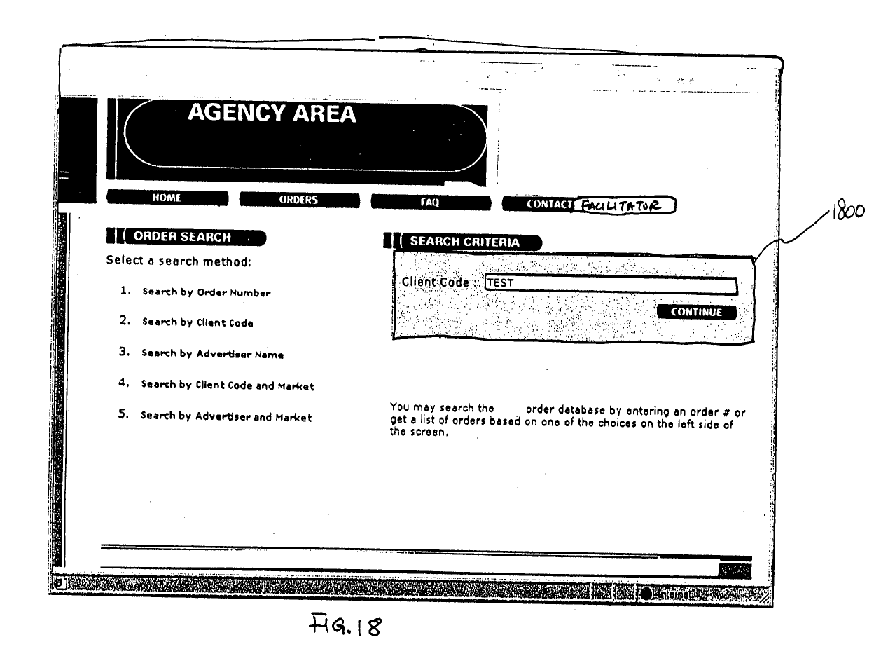

The agency user makes a selection using a pointing device to point at and select relevant text or icons. For example, a mouse may be used to move a cursor to point at the text “FAQ” and to select that topic by clicking on the text. Other known electronic selection devices may also be used, instead of a mouse. If “FAQ” is selected, the relevant information is accessed from the memory system of the computer system 400 and displayed at the agency user's computer terminal, such as shown in FIG. 16. If “CONTACTS” is selected, the contact information of personnel at the facilitator 200 associated with the logon ID is accessed and displayed, such as shown in FIG. 17.

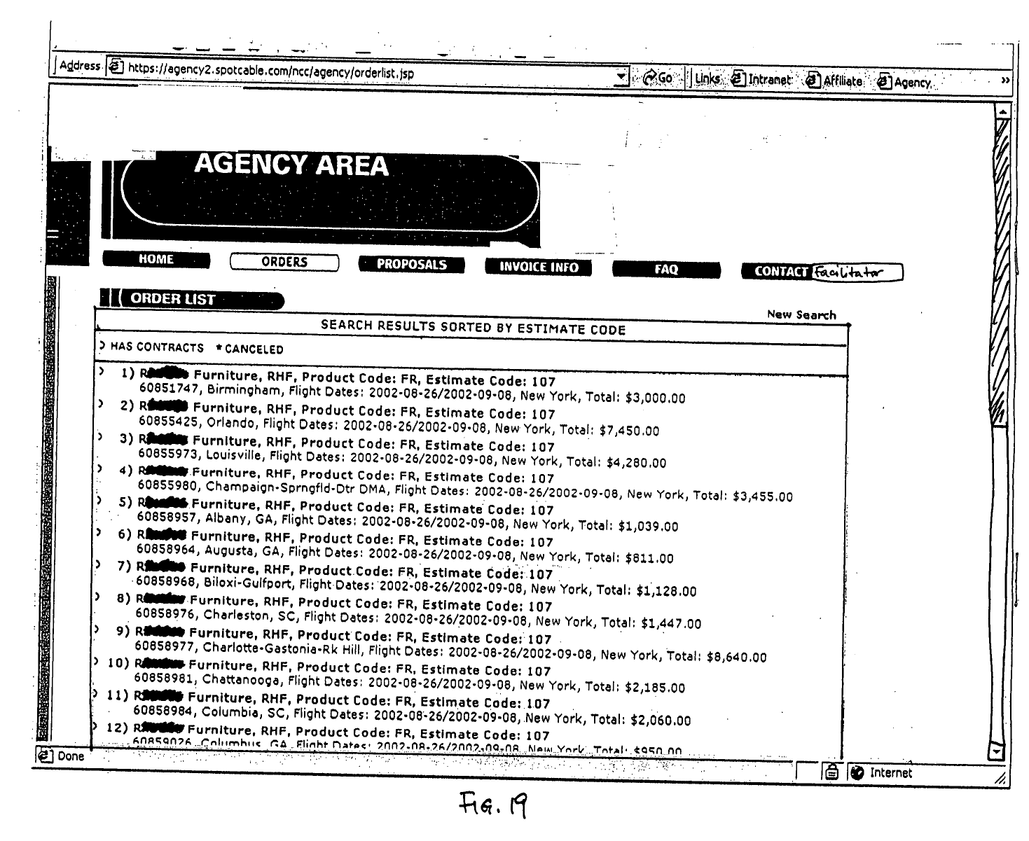

If “ORDERS” is selected, an order-information sub-module of the agency module is activated. Initially, an ORDER SEARCH page is displayed that gives the agency user the options of viewing and searching for orders according to specific criteria, as shown in FIG. 18. For example, the user may choose to search for orders according to order number, client code, advertiser name, geographical region (market), or any combination of such categories. As shown in FIG. 18, if the user selects to search for orders by client code by clicking on that category to highlight the text, a Search Criteria window 1800 appears within the ORDER SEARCH page, with an area for the user to input the client code to be searched.

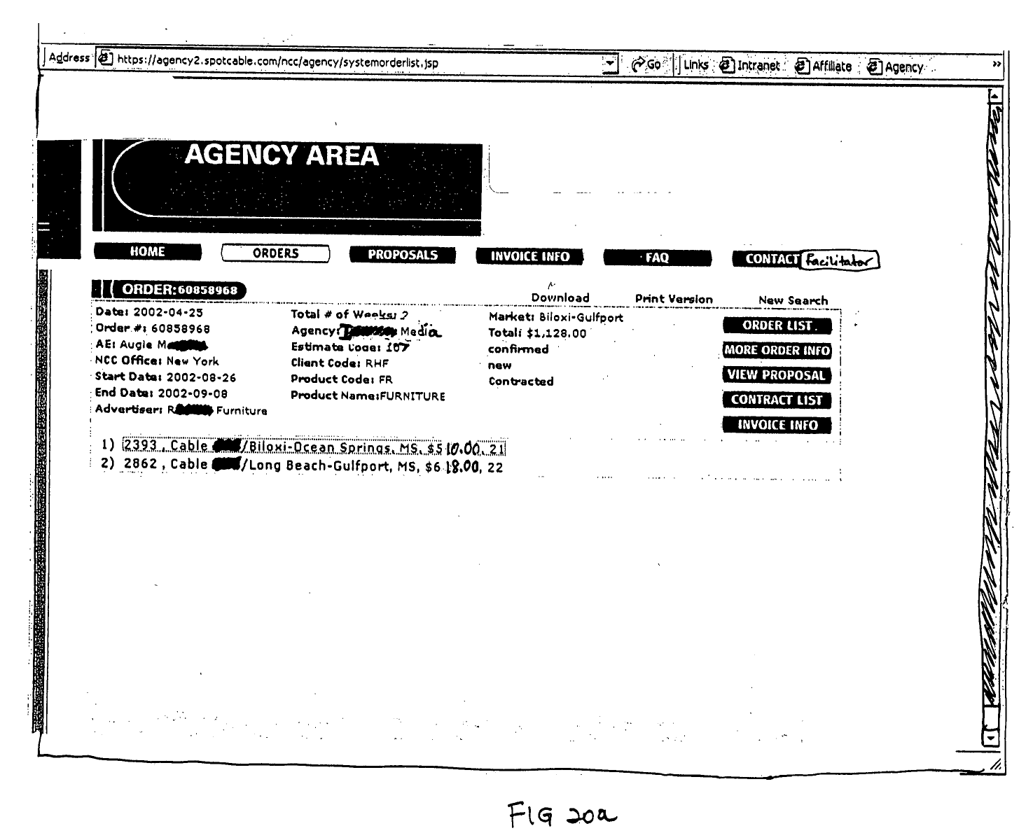

For example, if the user enters an estimate code of “107,” an order list of all orders corresponding to that estimate code is displayed, as shown in FIG. 19. The list of orders may be sorted by order number, geographic region (market), product code, etc.

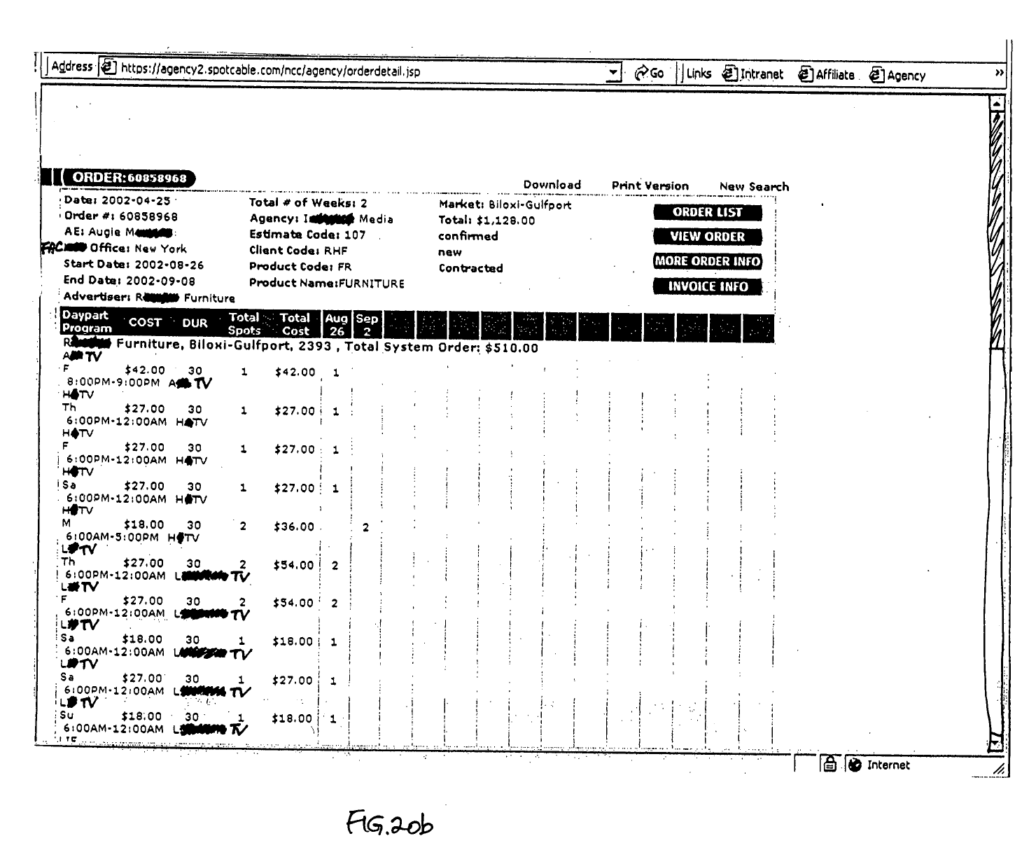

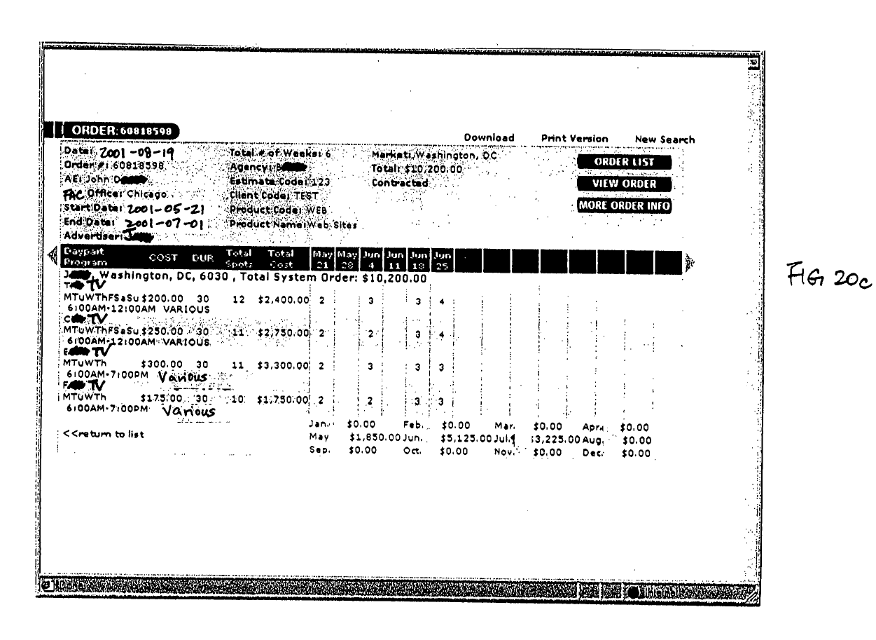

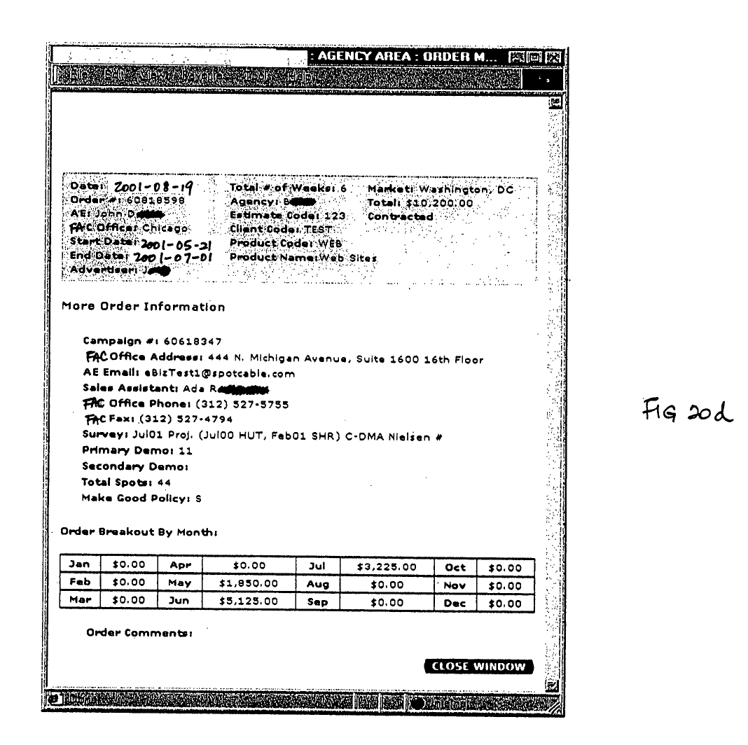

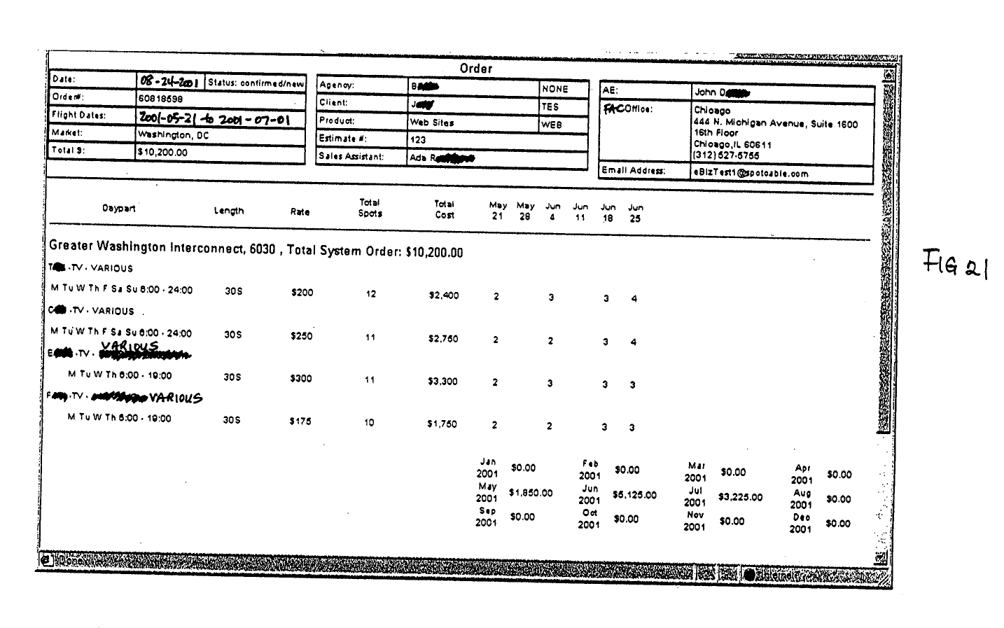

By pointing to and selecting one of the orders in the displayed list, detailed information regarding the selected order is displayed, as shown in FIGS. 20a-20c. The detailed order information includes, for example, the order date, the account executive responsible for the order at the facilitator, the facilitator office, the start and end dates of the ad, the advertiser, the span of time that the ad will run, the agency name, the estimate code, the client code, the product code, the product name, the geographic region or market the ad is scheduled to run in, the total cost, the status of the order, and whether a contract has been established for the order, as shown in FIG. 20a. Also included in the order information is system-order information for contracted orders (i.e., orders with contracts). The system-order information includes the system code, system-code name, system order total, and number of spots.

Electronic links allow the user to select to return to the order list, view additional order information, view the proposal corresponding to the order, view a contract list corresponding to the order, and view invoice information corresponding to the order. Additionally, electronic links allow the user to download the order information, obtain a print version of the order information, and perform a new search. Electronic links also are provided to enable the user to jump to the information topics from the initial page shown in FIG. 15.

The electronic links identified above are only examples of the types of link topics that may be provided. It should be understood that the scope of the present invention encompasses other link topics that are not specifically listed herein.

If the agency user selects to view additional order information by clicking on the text “MORE ORDER INFO,” details of the ad schedule, including the names of the affiliates, the days, the dates, the number of showings, the time ranges, the cost per ad, the duration of each ad, and the total cost per affiliate are displayed, as shown in FIG. 20b. FIG. 20c shows another example of a display of additional detailed order information. If the user selects to view even more order information, an itemized list of costs per month for the ad is displayed, as shown in FIG. 20d. Other displayed information may include campaign number, contact information, survey information, etc.

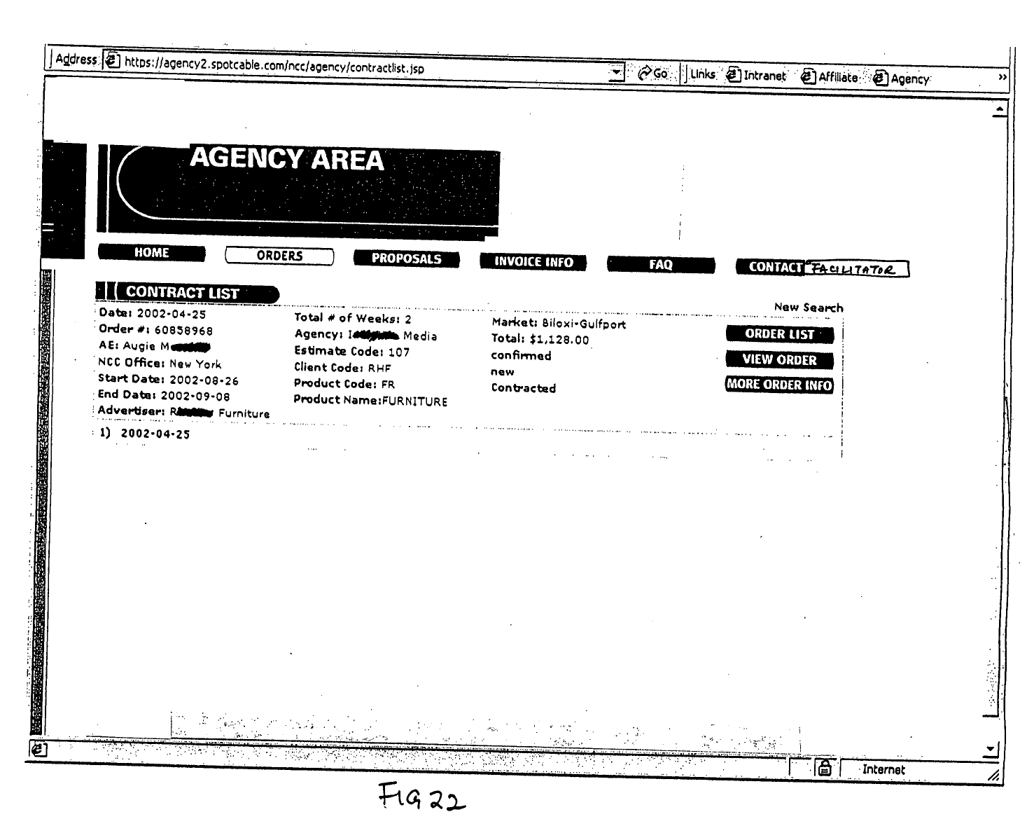

If the user wants to obtain a print version of the order information, by clicking on the text “Print Version” when the order information is being displayed, the print version is displayed, such as shown in FIG. 21.

As shown in the order list of FIG. 19, indicators are provided to designate whether an order has contracts or has been canceled. If an order has been canceled, detailed information regarding the order may not be obtained by clicking on the line entry for the order. However, if an order has an indicator that it has contracts, clicking on the indicator will cause a list of the contracts to be displayed.

If the agency user chooses to search for an order by its order number, by highlighting that option in FIG. 18 and then inputting the order number in the Search Criteria window 1800, information corresponding to the inputted order number is displayed, as shown in FIG. 20a and discussed above.

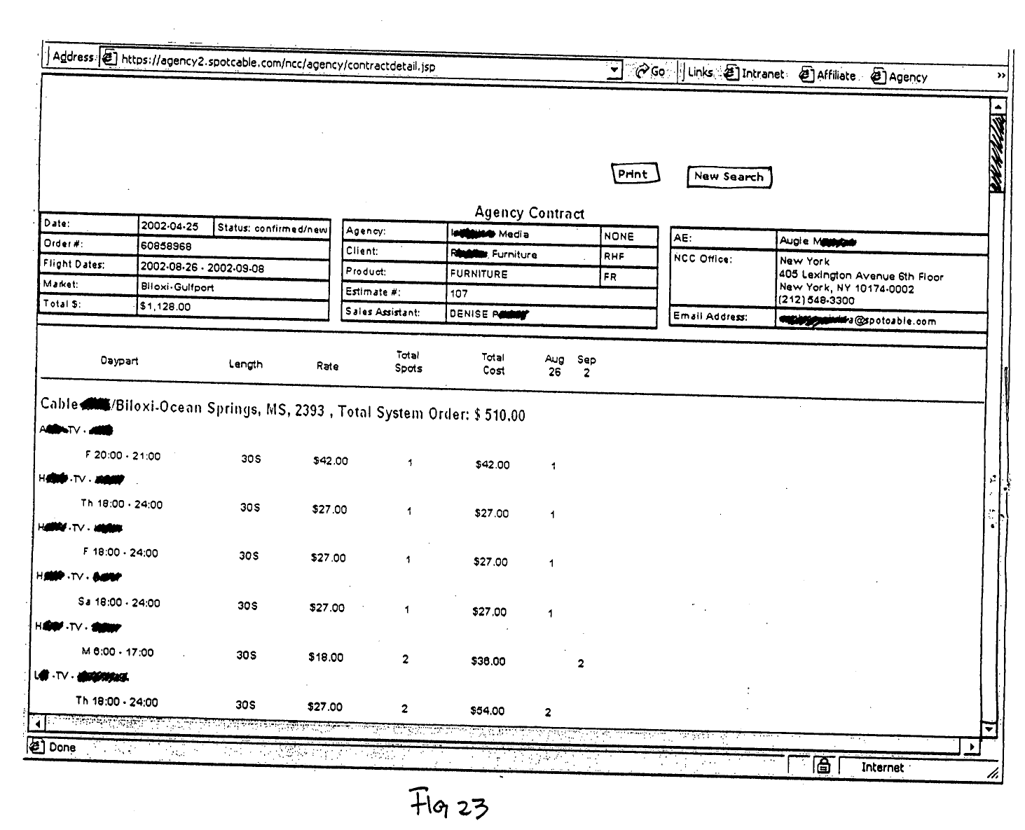

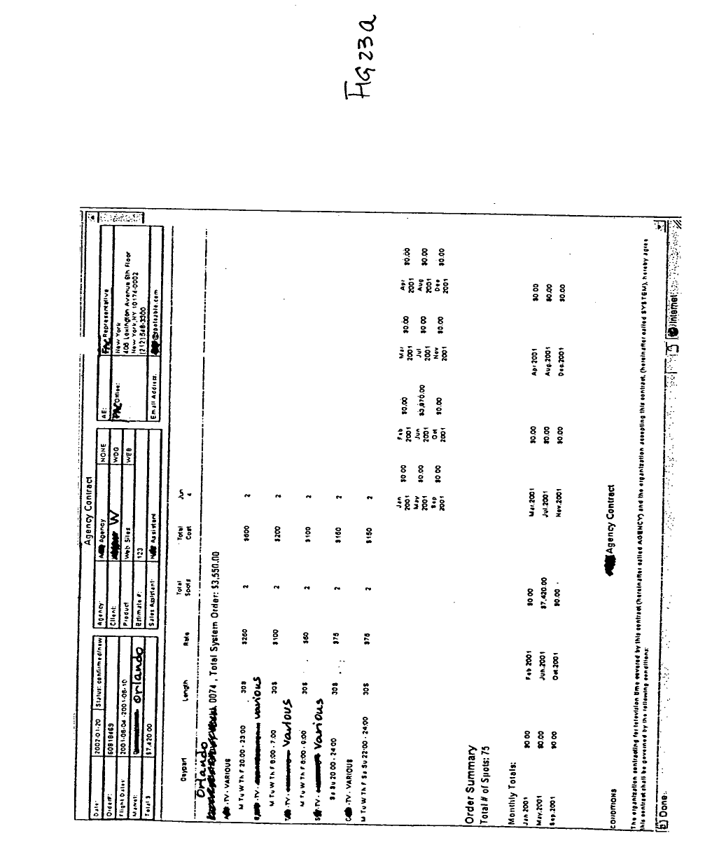

If the agency user selects to view contract information related to the selected order, such as by clicking on the appropriate electronic link “CONTRACT LIST” shown in FIG. 20a, a list of contracts is displayed, such as shown in FIG. 22. If there are no contracts for an order, that electronic link need not appear. By selecting (clicking on) a contract of interest, detailed information regarding the selected contract is displayed, as shown in FIG. 23.

In FIG. 23, the user may select to obtain a print version of the contract. An example of a displayed print version of a contract is shown in FIG. 23a. The user may print any or all of the contracts for an order.

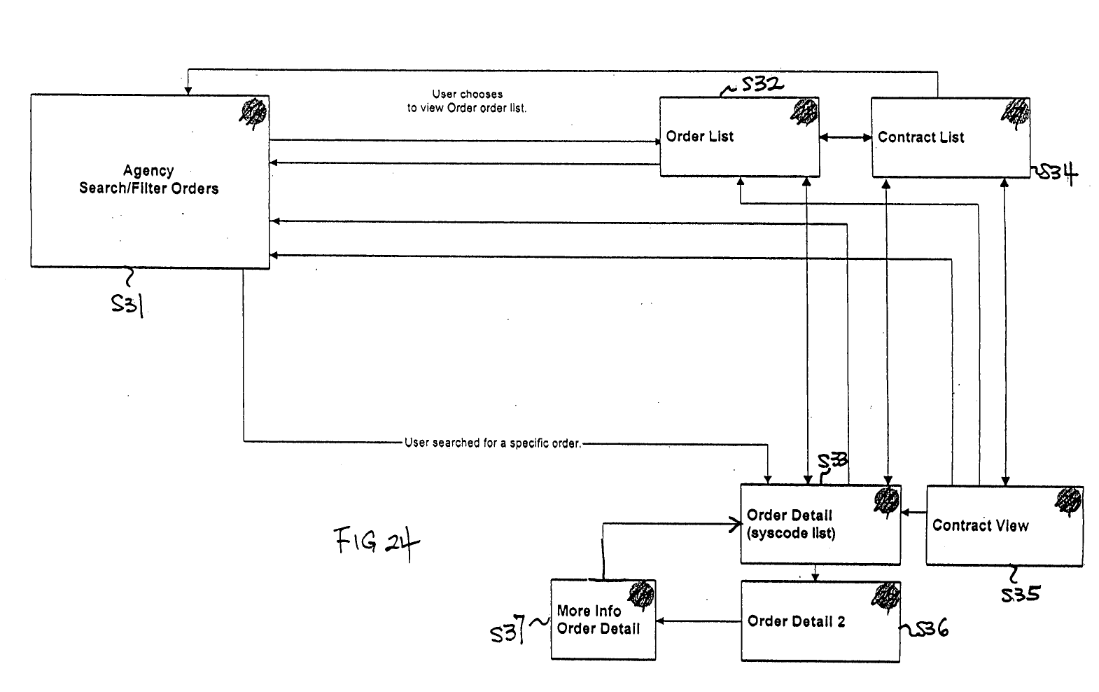

FIG. 24 is a flow chart for understanding the process of viewing orders and contracts. In step S31, the agency user inputs search criteria used to search for an order. In step S32, the agency module searches its databases and displays a list of orders matching the search criteria. If the user makes a selection to start a new search, the process returns to step S31.

From step S32, the agency user may select to view the following: in step S33, the user chooses to view detailed information of a selected order; in step S34, the user chooses to view a list of contracts from the displayed order list. From step S34, when the list of contracts is displayed, the user may choose to view detailed information of a selected contract. In step S35, when the detailed information of the selected contract is displayed, the user may select to view the following: the user may choose to view detailed order information corresponding to the selected contract (step S33); the user may choose to return to the list of contracts (step S34); the user may choose to view the list of orders corresponding to the contract (step S32); and the user may choose to start a new search (step S31).

In step S33, when detailed information regarding an order is displayed, the agency user may select to view the following: the user may choose to start a new search (step S31); the user may choose to view the contract list corresponding to the order (step S34); the user may choose to view the order list corresponding to the order (step S32); and the user may choose to view additional information regarding the order (step S36). In step S37, the user may choose to even view more information regarding the order. The process then returns to step S33.

Optionally, as shown in FIG. 24, detailed information regarding an order (step S33) may be directly displayed from step S31 by inputting the order number for the order as the search criteria.

The order search feature described above enables the agency user to easily track the progress of an order for an ad and to easily view order information and contract information for the ad. The order information and the contract information are arranged in a manner that allows the user to quickly obtain useful information regarding the ad's status, and reduces or eliminates the need for the user to obtain and review a paper file of correspondence and other documents associated with the ad, which generally is more time consuming than using the agency module.

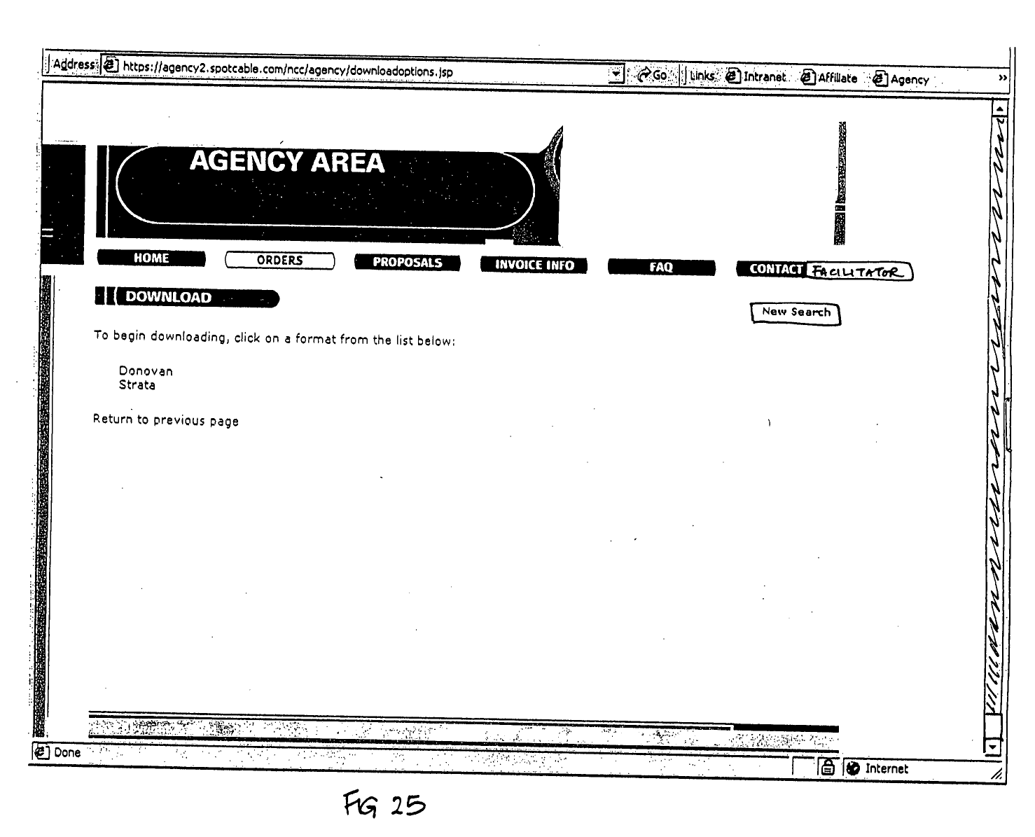

In FIG. 20a, if the agency user selects to download the displayed order information by clicking on the appropriate electronic link, a download sub-module of the agency module is activated. Initially, the user is provided with an option to choose the format of the downloaded information, such as shown in the DOWNLOAD page of FIG. 25. More specifically, the download sub-module enables the order information to be downloaded in a format that is compatible with software applications used by the agency 100, such as Donovan, and Strata, for example. This allows the order information to be further analyzed off-line using the agency's software, and reduces or eliminates the need for personnel at the agency 100 to physically enter information into the agency's computer system for analysis using the agency's software. This enables agencies to easily manage a large amount of information. The computer system 400 includes a conversion unit for converting the order information to a format selected by the user.

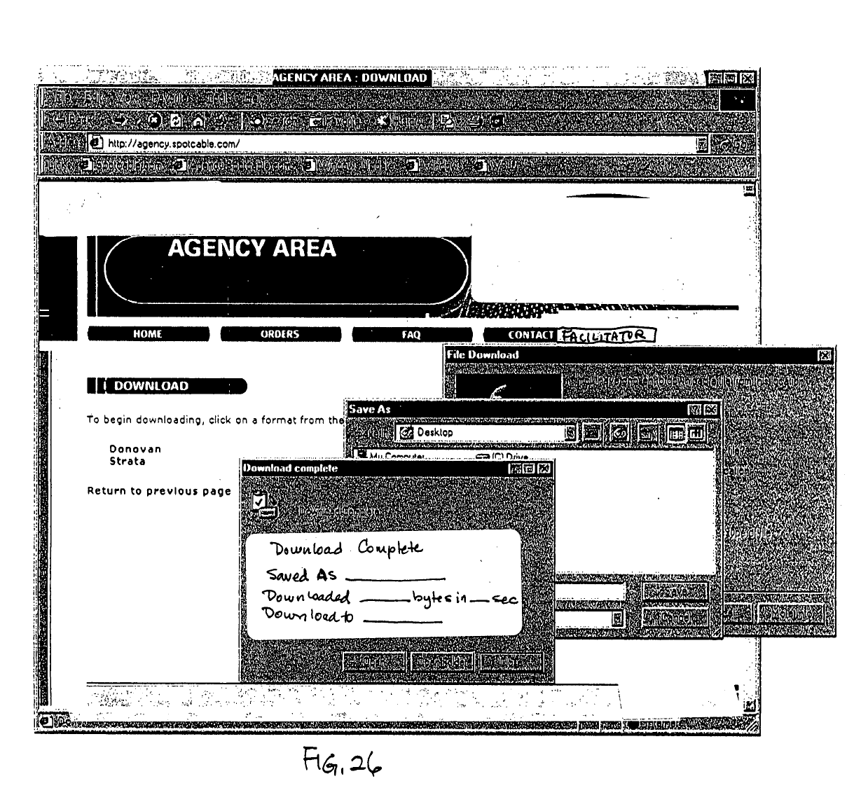

As shown in FIG. 26, once the downloading is complete, the agency module enables the agency user to further analyze the downloaded information off-line, by providing the user the option to open the folder corresponding to the downloaded information or to open the file containing that information. The user may also choose to close the downloading-related windows and continue working from the agency module.

A proposals sub-module of the agency module enables the agency user to receive and make comments on proposals from the facilitator 200 through the Internet. The agency user may select to review information on proposals from the initial page shown in FIG. 15, or from any other displayed page that provides an electronic link to the proposals sub-module.

The agency user may search for proposals by, for example, client code; product code; estimate code; flight month; advertiser name; or a combination thereof. If the agency user selects to search for proposals by client number by clicking on that category to highlight text in a PROPOSAL SEARCH page (not shown), a Search Criteria window appears within the PROPOSAL SEARCH page, with an area for the user to input the client number to be searched.

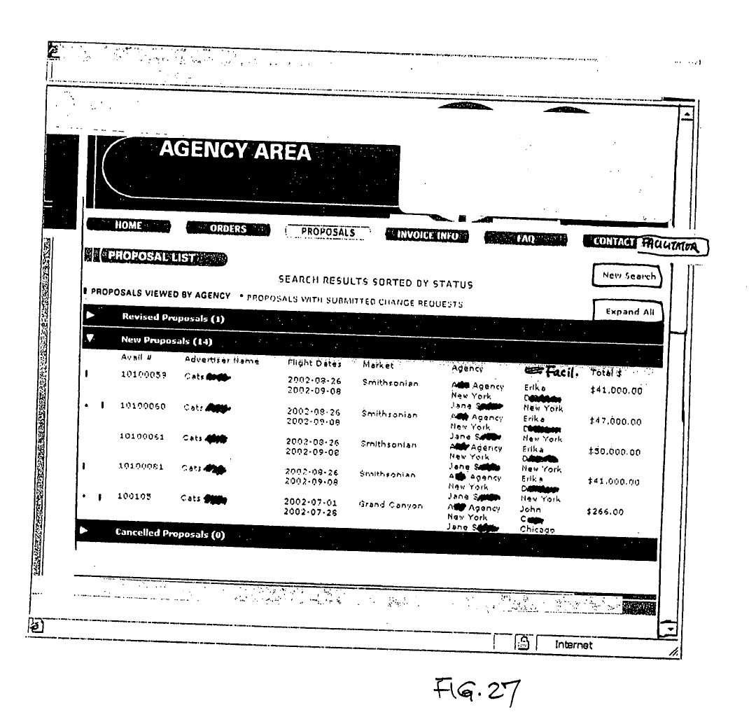

FIG. 27 shows a display of a proposal list resulting from a search performed by the agency module, based on search criteria inputted by the agency user and information stored in one or more databases corresponding to the agency module. For example, the proposal list provides any or all of the following: availability-request numbers; names of the advertisers; “flight” dates, which indicate a range of dates that the ad is proposed to be shown; the geographic regions or markets; information on the agency representatives handling the ad; information on the facilitator representatives handling the ad; and an amount for the total cost of the proposed ad. Status information is also provided in the proposal list, such as whether a proposal has been viewed by the agency 100, whether a change request has been submitted for a proposal, and whether a proposal has been canceled, for example. In addition, as shown in FIG. 27, the proposal list includes electronic links to other sub-modules of the agency module, such as the order-information and invoice-information sub-modules.

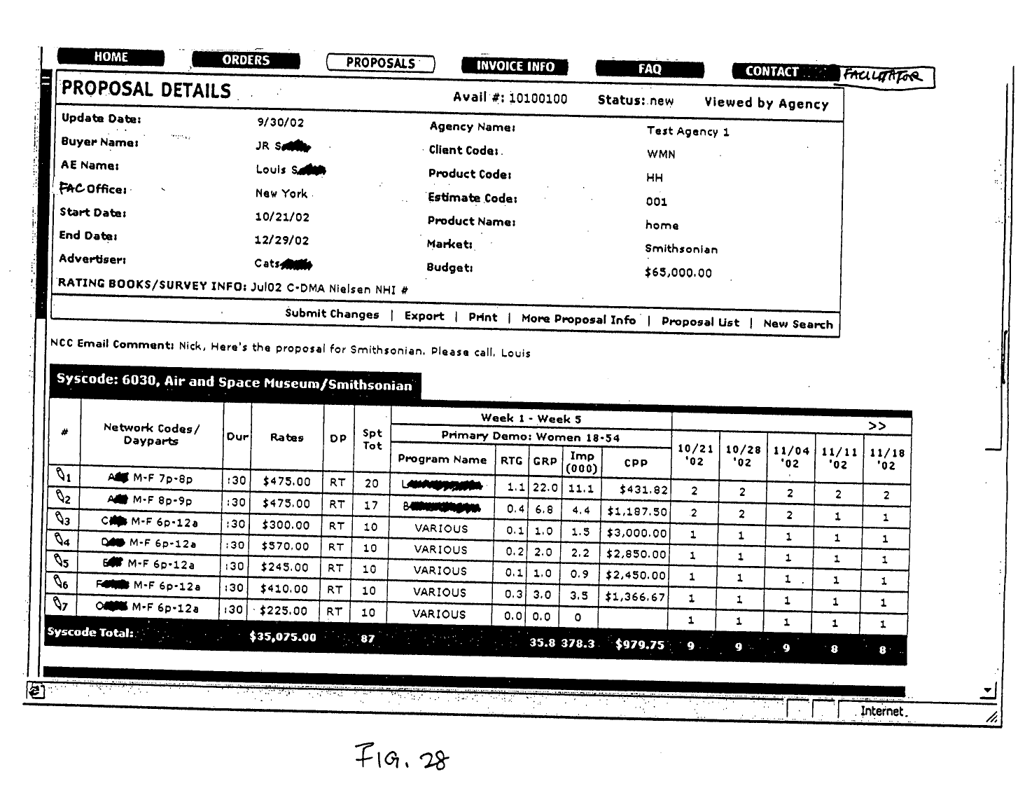

If the agency user selects a proposal by clicking on the text for that proposal in the proposal list, detailed information regarding the selected proposal is displayed, as shown in FIG. 28. For example, the proposal details include any or all of the following information: the update date; the name of the buyer; the account executive responsible for the proposal at the facilitator 200; the facilitator office; the start and end dates of the ad; the advertiser; the span of time that the ad will run; the agency name; the estimate code; the client code; the product code; the product name; the geographic region or market the ad is proposed to run in; and the total budget for the ad. The details also include a proposed schedule for airing the ads, including the affiliates; the date ranges and time ranges; the ad duration; the rates charged by the affiliates; the total number of spots; the name of the television programs that the ads are proposed to be shown during; the dates of the ads and the number of ads per date; and demographic information regarding the viewers of the television programs, for example. Additionally, the status of the proposal and whether it has been viewed by the agency 100 is displayed in the details.

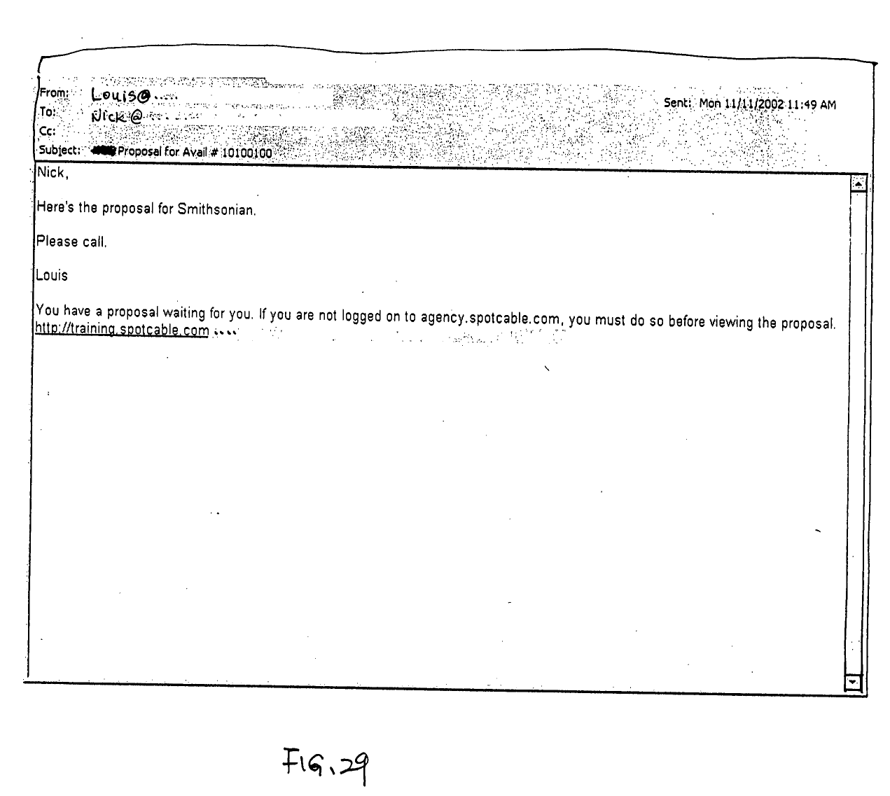

The facilitator representative handling the proposal for the ad may include comments for the agency representative handling the ad, based on information provided in the availability request. The comments are located in the “Email Comment” region of the displayed page. In order to notify the agency representative about the proposal, the proposals sub-module associates the proposal with the email address of the agency representative handling the ad, and sends an email message with the same comments to the agency representative when the proposal is finalized, as shown in FIG. 29. The email message also includes an electronic link to the proposal.

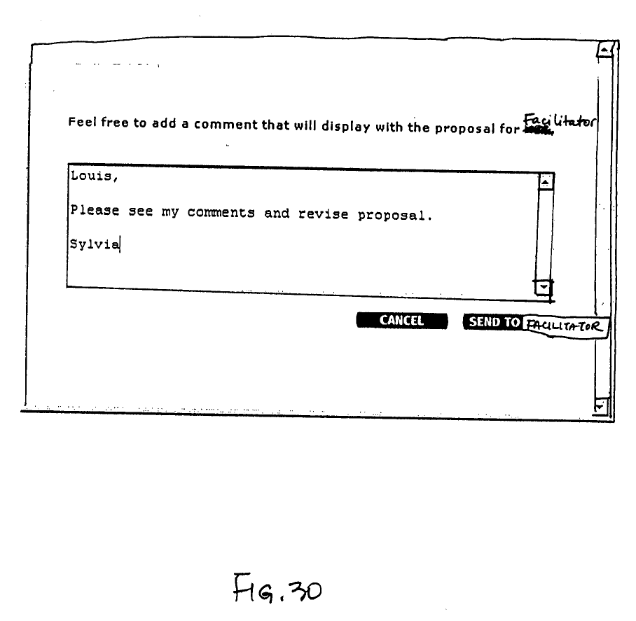

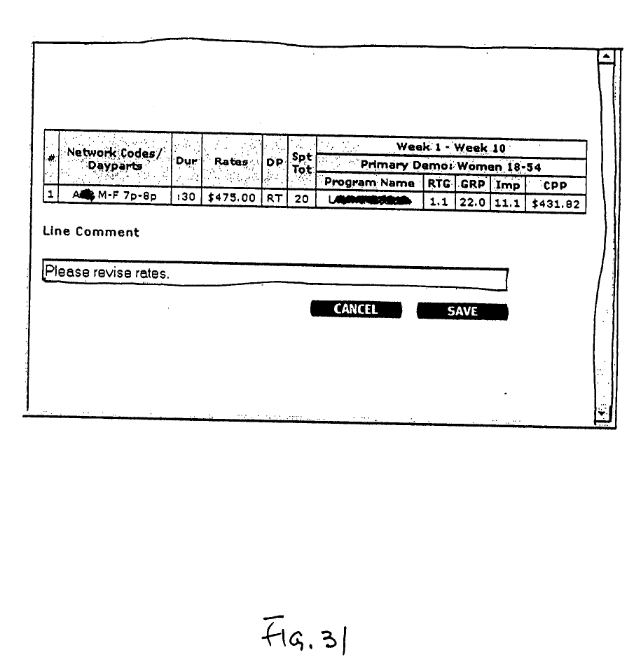

The agency user viewing the proposal may make comments by clicking on “Submit Changes” in the display shown in FIG. 28, which causes a page to be displayed that allows the user to send comments to the facilitator 200, as shown in FIG. 30. Additionally, the user may make specific comments on a line item of the proposal by clicking the pencil icon for the line item, which causes a page to open that allows the user to comment on that particular line item, as shown in FIG. 31.

The proposals sub-module described above enables the agency user to easily keep track of a proposal and to communicate with the facilitator 200 regarding various aspects of the proposal. The proposal information is arranged in a manner that allows the user to quickly obtain useful information regarding the proposal, including status information, without requiring the user to obtain and review a paper file of correspondence and other documents associated with the proposal, which generally is more time consuming than using the agency module.

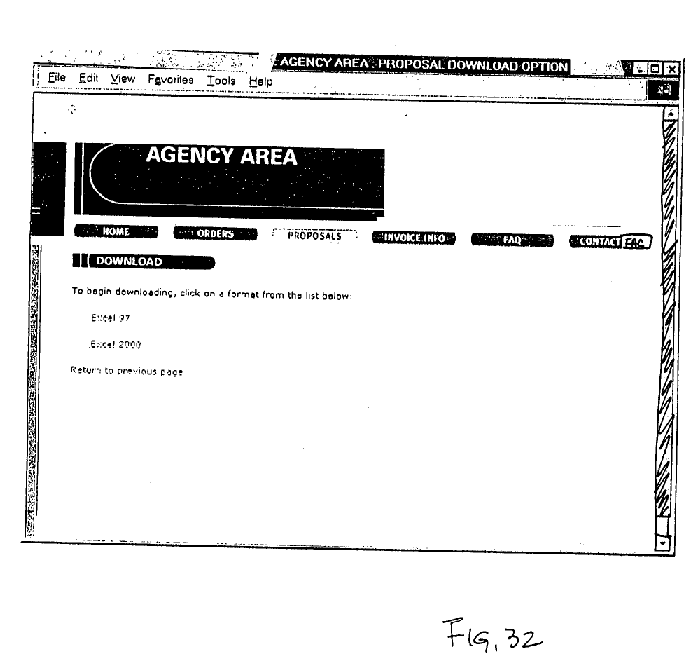

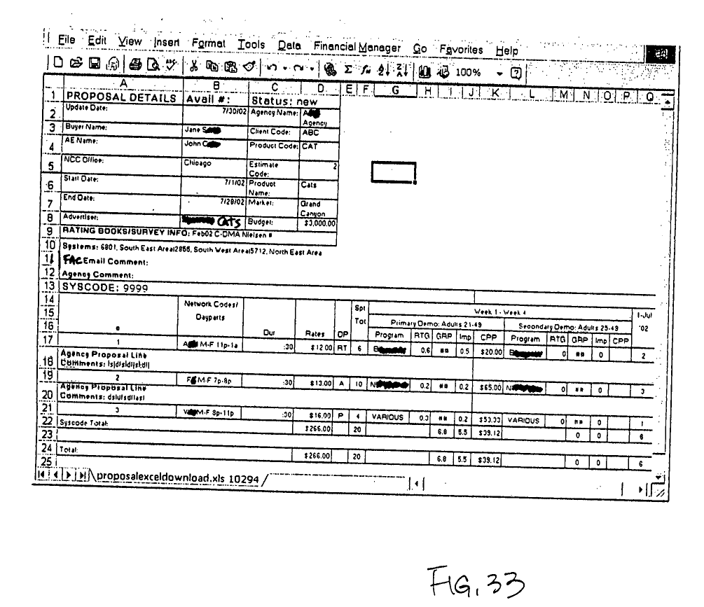

If the agency user clicks on “Export” in the display shown in FIG. 28, the download sub-module is activated, as discussed above. Initially, the user is provided with an option to choose the format of the downloaded proposal information, as shown in FIG. 32. More specifically, the download sub-module enables the proposal information to be downloaded in a format that is compatible with software applications used by the agency 100, such as various versions of Excel®, for example. This allows the proposal information to be further analyzed off-line using the agency's software, and reduces or eliminates the need for personnel at the agency 100 to physically enter information into the agency's computer system for analysis using the agency's software. This enables agencies to easily manage a large amount of information. FIG. 33 shows an example of an exported proposal formatted for Excel®. The computer system 400 includes a conversion unit for converting the proposal information to a format selected by the user.

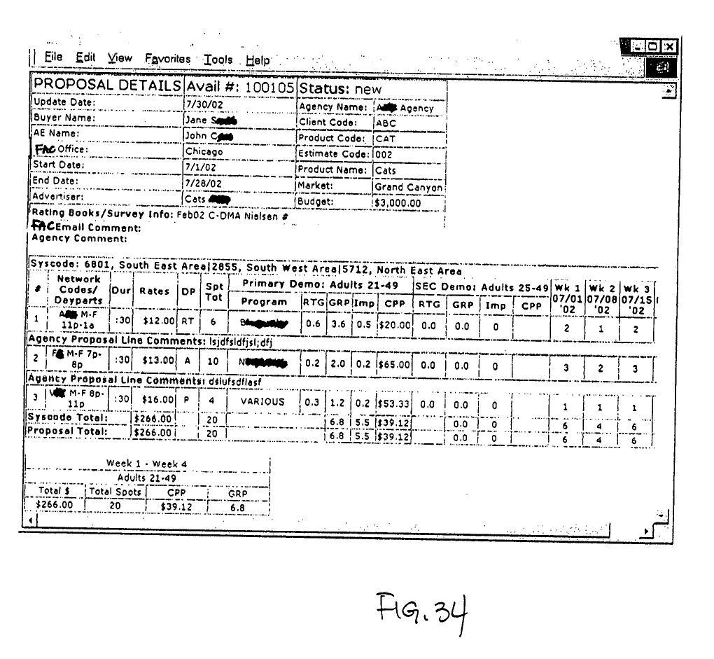

If the agency user clicks on “Print” in the display shown in FIG. 28, a printable version of the proposal is displayed, as shown in FIG. 34.

The agency module allows an authorized facilitator user and the agency user to view the same proposal at the same time, to promote constructive dialog.

An invoice-information sub-module of the agency module enables the agency user to review invoice information regarding an ad through the Internet. The user may select to review invoice information from the initial page shown in FIG. 15, or from any other displayed page that provides an electronic link to the invoice-information sub-module.

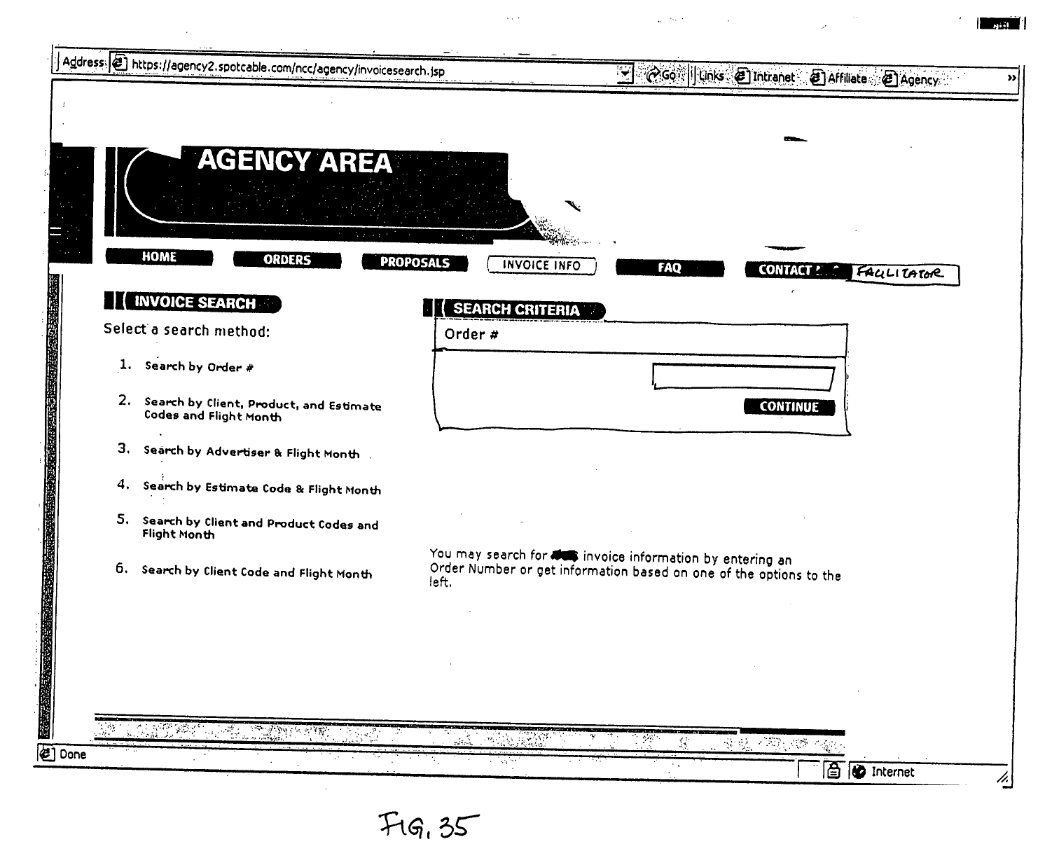

FIG. 35 shows an example of a SEARCH page for searching for invoice information. Searches may be performed by client code; product code; estimate code; flight month; advertiser name; or a combination thereof. If the agency user selects to search for invoices by order number by clicking on that category to highlight the text, a Search Criteria window appears within the SEARCH page, with an area for the user to input the order number to be searched.

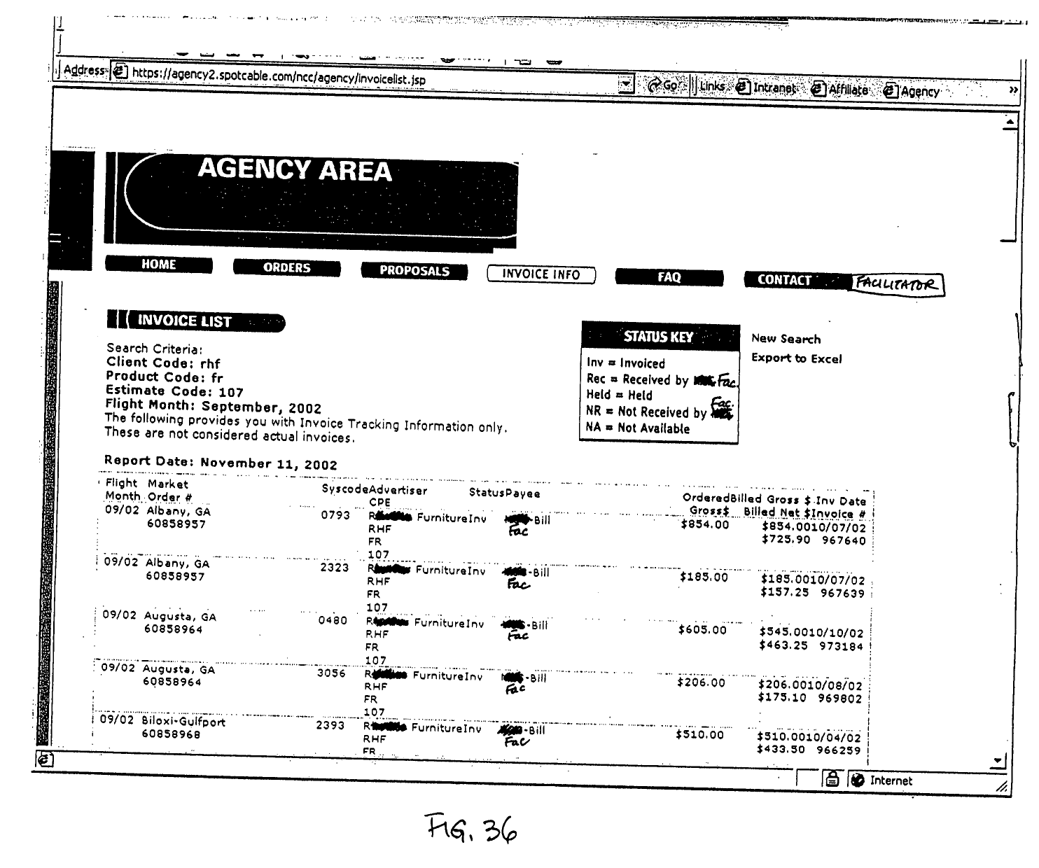

FIG. 36 shows a display of an INVOICE LIST page resulting from a search performed by the agency module, based on search criteria inputted by the agency user and information stored in one or more databases corresponding to the agency module. The invoice list is not a list of invoices per se, but instead lists invoice information for orders, to enable easy tracking of invoices. For example, the invoice list provides information regarding the client code; the product code; the estimate code; the flight month; the market and order number; the system codes, names of the advertisers; the names of the payees; the total cost of the ordered ads; the amount billed (gross and net); and the invoice date and invoice number. Status information is also provided, such as whether an order has been invoiced; whether payment has been received by the facilitator 200; whether an invoice has been held; and whether the status of an invoice is not available, for example.

In addition, as shown in FIG. 36, the invoice list includes electronic links to other sub-modules of the agency module, such as the order-information and proposals sub-modules.

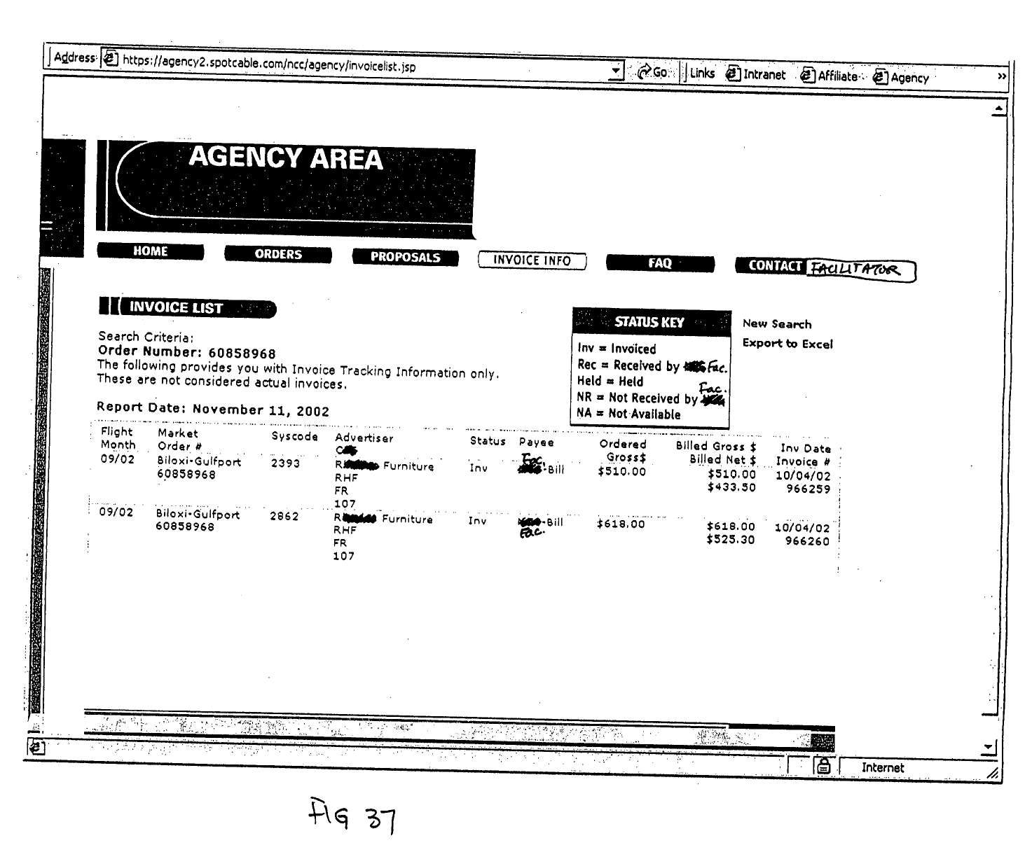

If the agency user searches for invoice information by inputting an order number, the resulting invoice list will only include information on invoices corresponding that order number, as shown in FIG. 37.

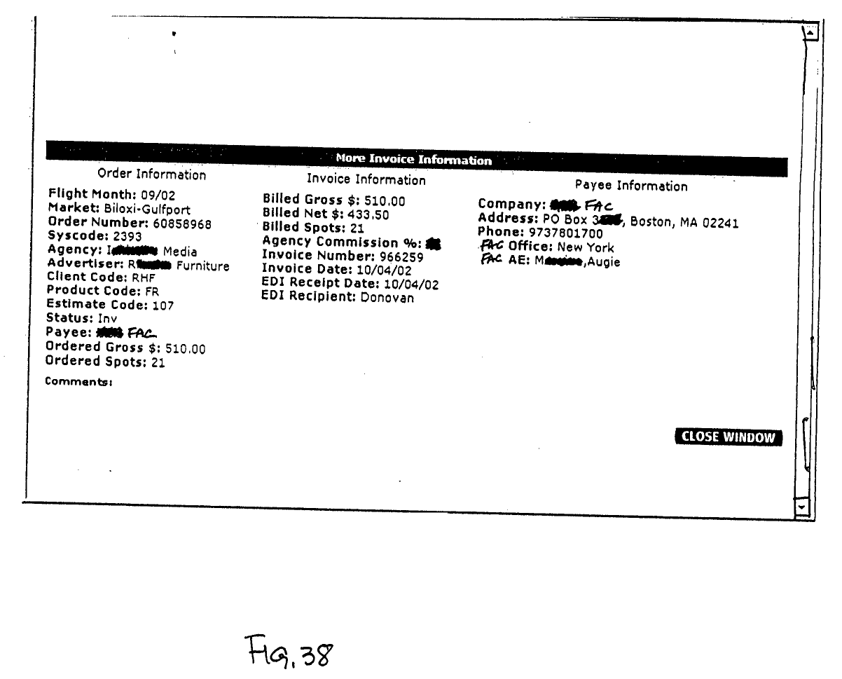

If the agency user clicks on the text for a line entry from the invoice list, detailed information regarding the selected invoice is displayed, as shown in FIG. 38. The invoice details include order-information details; invoice-information details; and payee-information details. The order-information details include flight month; market; order number; system code; agency name; advertiser name; client code; product code; estimate code; invoice status; payee name; total cost of the order; and the number of spots ordered, for example. The invoice-information details include the amount billed (gross and net); the number of spots billed; the percentage of agency commission; the invoice number; the invoice date; the Electronic Data Interchange (EDI) receipt date, which is the date that the electronically transmitted invoice is received by the agency using the agency's software; and the EDI recipient, for example. The payee-information details include the name, address, and telephone number of the payee, as well as the office location and account executive responsible for the invoice.

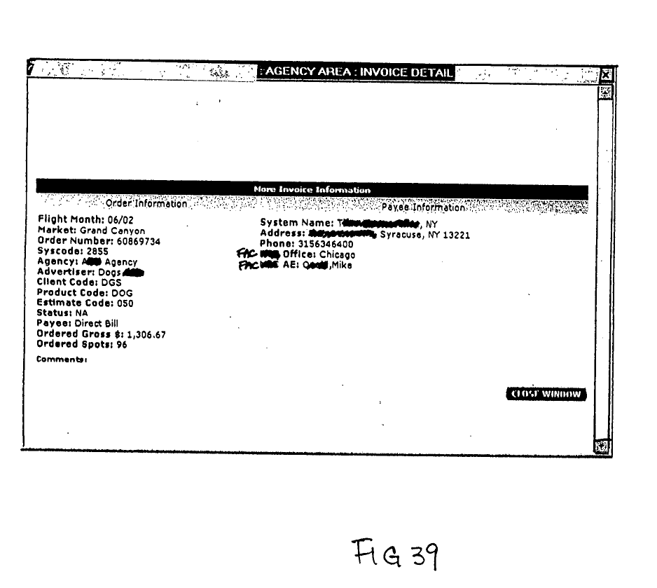

If the payee is not the facilitator 200, but instead the invoice is to be directly billed by the affiliate 500, the invoice details need not include invoice-information details, such as shown in FIG. 39.

The invoice-information sub-module described above enables the agency user to easily keep track of ad invoices. The invoice information is arranged in a manner that allows the user to quickly obtain useful information regarding the invoice, including status information, without requiring the user to obtain and review a paper file of correspondence and other documents associated with the ad, which generally is more time consuming than using the agency module.

If the agency user clicks on “Export” in the display shown in FIG. 36, the download sub-module is activated, as discussed above. The user is provided with an option to choose the format of the downloaded invoice information, so that the invoice information may be converted to a format that is compatible with software applications used by the agency 100, such as various versions of Excel®, for example. This allows the invoice information to be further analyzed off-line using the agency's software, and reduces or eliminates the need for personnel at the agency 100 to physically enter information into the agency's computer system for analysis using the agency's software. This enables agencies to easily manage a large amount of information. The computer system 400 includes a conversion unit for converting the invoice information to a format selected by the user.

The agency module allows an authorized facilitator user and the agency user to view the same invoice information at the same time, to promote constructive dialog.

Affiliate Module

The affiliate module of the program enables an authorized user of the affiliate 500 to communicate information to the facilitator 200 regarding an ad, and to review information communicated from the facilitator 200 regarding the ad. The affiliate 500 accesses the affiliate module via the Internet. Only authorized affiliate users may access information stored in the memory system of the computer system 400. Also, only authorized affiliate users may add information to the memory system of the computer system 400.

The logon authorization process for accessing the affiliate module is similar to the logon authorization process for accessing the agency model discussed above and, therefore, will not be repeated here.

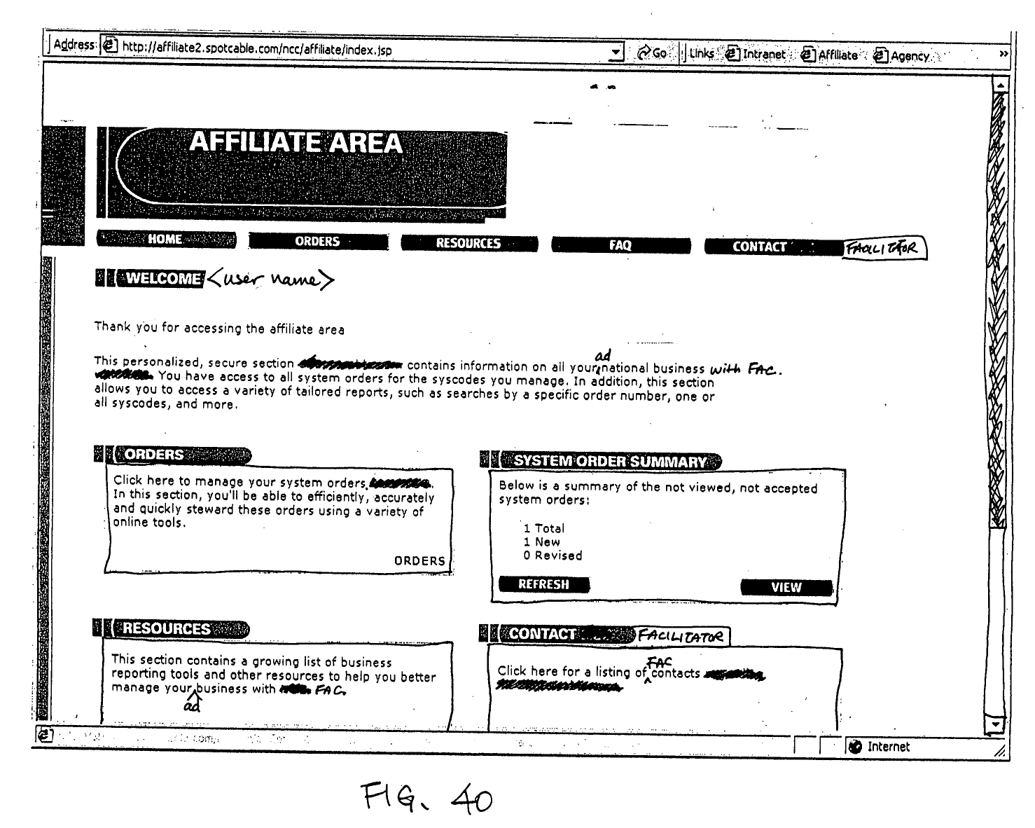

Once an affiliate user has successfully completed the logon process and accessed the secure information site of the affiliate module, an initial page is displayed, as shown in FIG. 40. The initial page identifies information topics that the user has access to and provides electronic links to those topics.

Depending on the affiliate user's logon ID, the user may have access to any or all of the following information databases associated with the affiliate module. In the example shown in FIG. 40, the affiliate user has access to information regarding orders; a summary of system orders; resources for managing the advertising business with the facilitator 200; FAQ; and contact information for contacting personnel of the facilitator 200.

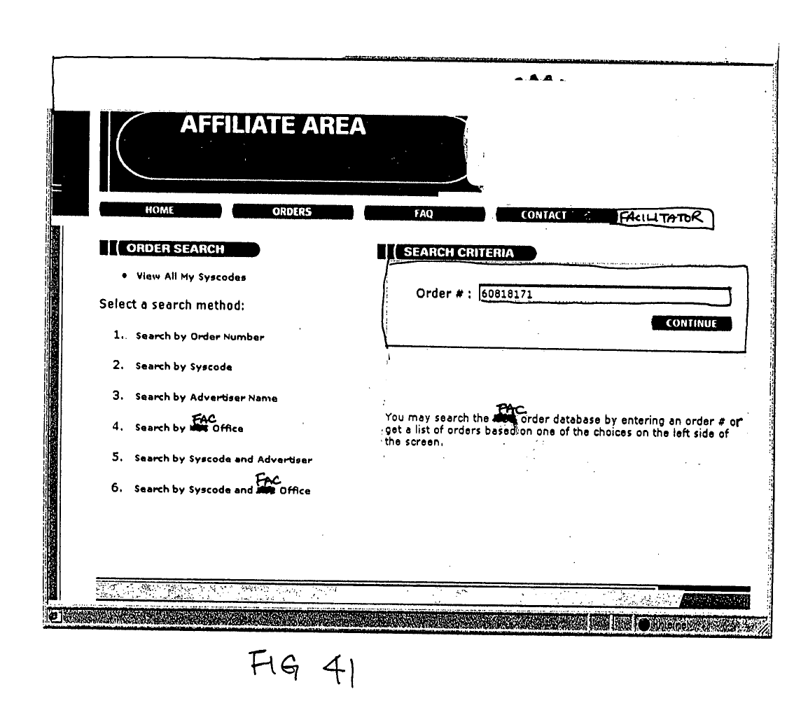

If “ORDERS” is selected, an order-information sub-module of the affiliate module is activated. Initially, an ORDER SEARCH page is displayed that gives the affiliate user the option of searching for system orders according to specific criteria, such as shown in FIG. 41. For example, the user may choose to search for system orders according to order number; system code; advertiser name; facilitator office; or a combination of such categories. The user may also choose to view all the system codes associated with the logon ID.

If the affiliate user selects to search for orders by order number by clicking on that category to highlight the text, a Search Criteria window appears within the ORDER SEARCH page, with an area for the user to input the order number to be searched.

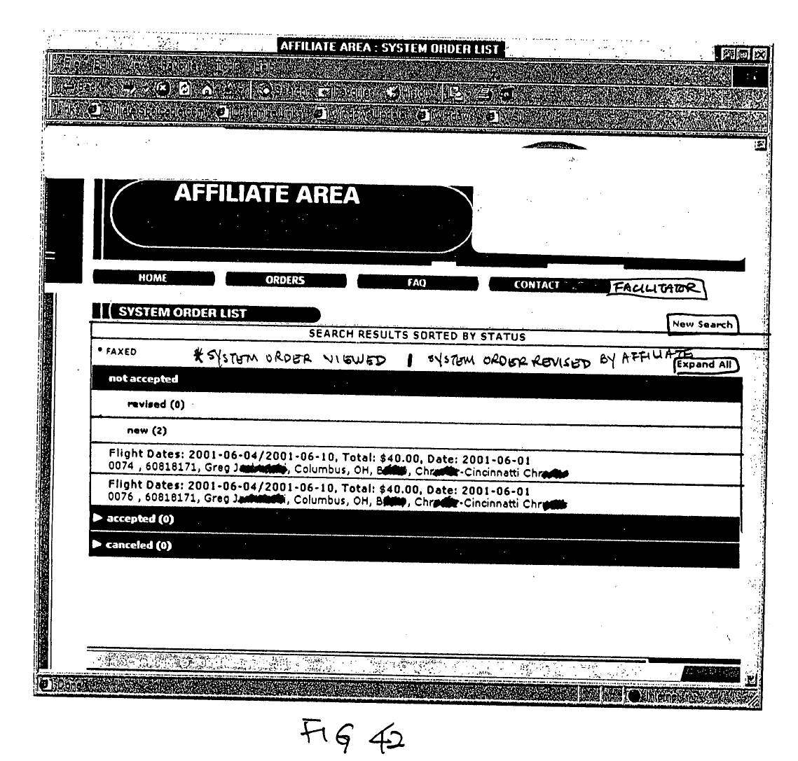

A list of system orders resulting from a search performed based on the affiliate user's inputted search criteria and the information stored in one or more databases of the affiliate module is shown in FIG. 42. The system-order list includes status information on each order, including information on whether the system order has been revised by the affiliate 500, has been viewed, or has been faxed. The system-order list also includes information on whether an order has been accepted by the affiliate 500, revised, or canceled. The user is able to accept all the system orders in the displayed list by clicking on the text “Accept All System Orders.” To view more detailed information on all the listed system orders, the user clicks on the text “Expand All.”

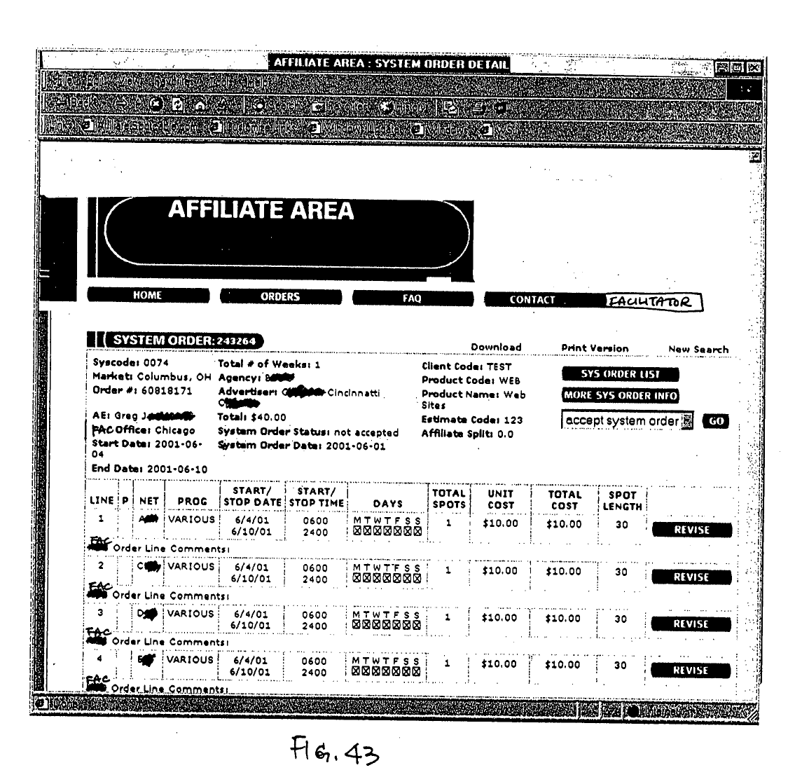

By pointing to and selecting one of the system orders in the displayed list, detailed information regarding the selected order is displayed, as shown in FIG. 43. The detailed system-order information includes, for example, the system order number; the system code; the market; the order number; the account executive responsible for the order at the facilitator; the facilitator office; the start and end dates of the ad; the total number of weeks the ad will or has run; the name of the advertising agency; the advertiser; the total amount of the ad; the status and date of the system order; the estimate code; the client code; the product code; the product name; and the affiliate split. Information on whether the system order has been viewed is also included in the system-order information.

The displayed system-order information also includes a line item for each television station or network that is scheduled to air the ad. Each line item includes information identifying the television station; the program; the range of start and stop dates; the rage of start and stop times; the days of the week; the total number of spots; the cost per spot; the spot duration or length; and the total cost of all the spots, for example. The affiliate user may revise individual line items in the system order by clicking on the text “REVISE” in each line.

From the displayed system-order information, such as shown in FIG. 43, electronic links allow the user to select to return to the system-order list or to view additional system order information. Additionally, electronic links allow the user to select to download the system-order information, obtain a print version of the information, or perform a new search. Electronic links are also provided to enable the user to jump to the information topics from the initial page shown in FIG. 40.

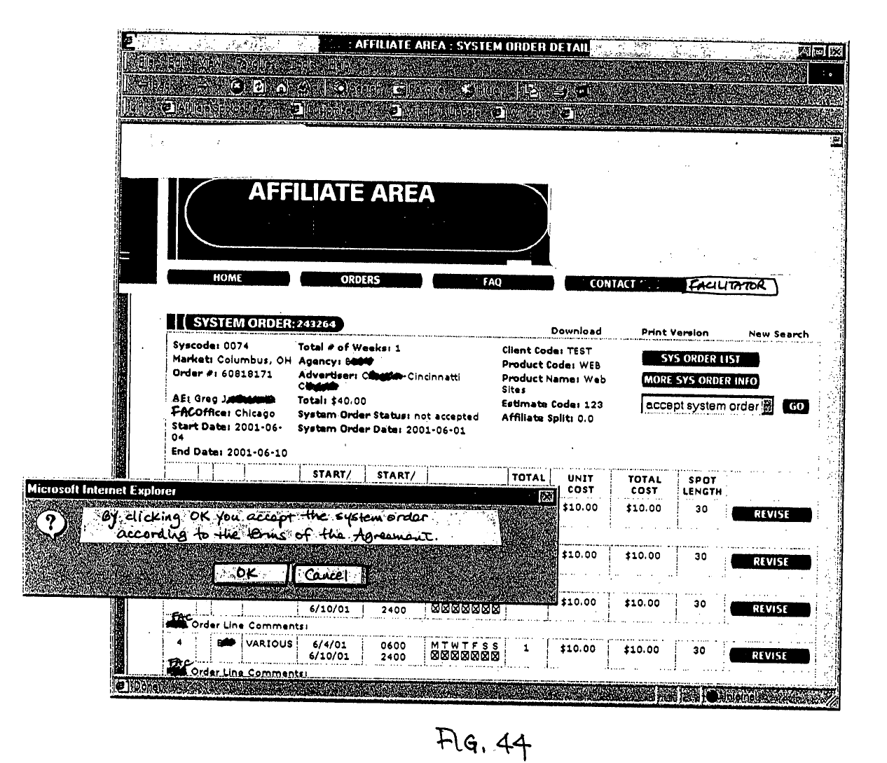

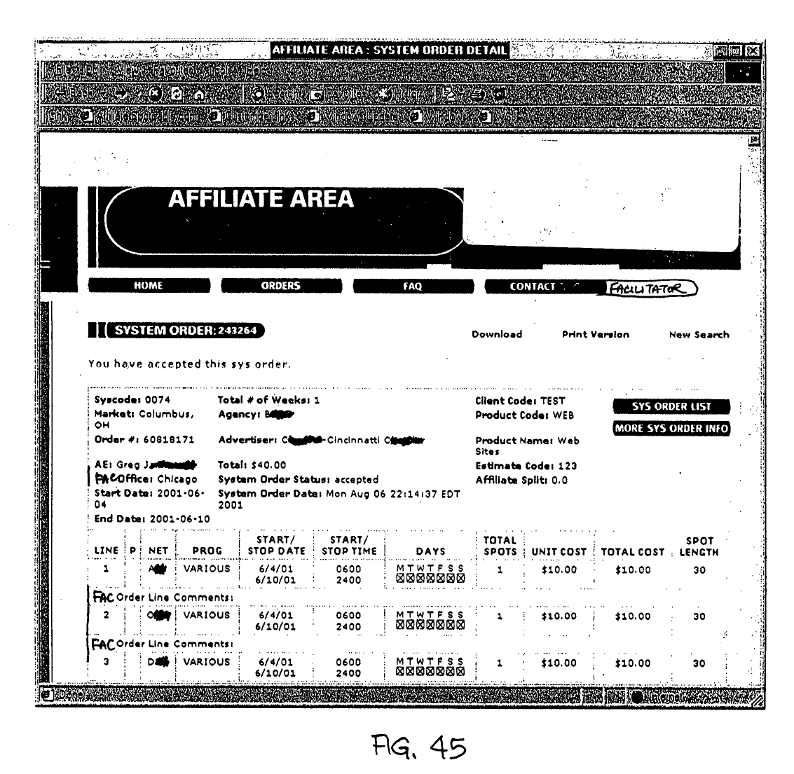

The affiliate module allows the affiliate user to input a command to change the status of a system order. For example, as shown in FIG. 43, the user may click on a scrollable command window to accept the system order or reject it. If the user selects to accept the system order, a window is displayed asking the user to confirm that the system order is to be accepted according to the terms of the agreement with the facilitator 200, as shown in FIG. 44. This allows the user to cancel the command if the command was made in error. If the acceptance is confirmed, the status of the system order is automatically updated in the memory system of the computer system 400 and the displayed system order information is updated as well, as shown in FIG. 45.

The order search feature described above enables the affiliate user to easily keep track of orders, to revise orders, and to accept or reject orders. The feature lets the user easily view order information and contract information for the ad. The order information and the contract information are arranged in a manner that allows the user to quickly obtain useful information regarding the ad, and reduces or eliminates the need for the user to obtain and review a paper file of correspondence and other documents associated with the ad, which generally is more time consuming than using the agency module.

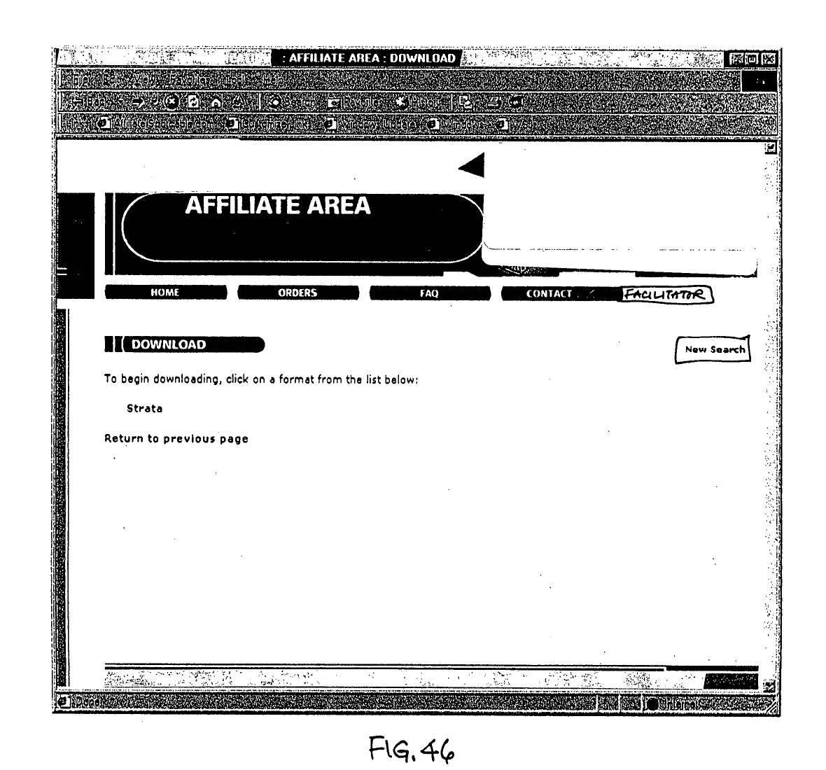

If the affiliate user clicks on the text “Download” when system-order information is displayed, the download sub-module is activated, as discussed above. Initially, the user is provided with an option to choose the format of the downloaded system order information, as shown in FIG. 46. More specifically, the download sub-module enables the system-order information to be downloaded in a format that is compatible with software applications used by the affiliate 500, such as Strata®, for example. This allows the system-order information to be further analyzed off-line using the affiliate's software, and reduces or eliminates the need for personnel at the affiliate 500 to physically enter information into the affiliate's computer system for analysis using the affiliate's software. This enables affiliates to easily manage a large amount of information. The computer system 400 includes a conversion unit for converting the system-order information to a format selected by the user.

If the affiliate user clicks on the text “Print Version” when the system-order information is displayed, a printable version of the system order is displayed.

The affiliate module allows an authorized facilitator user and the affiliate user to view the same information at the same time, to promote constructive dialog.

Facilitator Module

The facilitator module of the program enables an authorized user of the facilitator 200 to communicate information to the agency 100 regarding an ad, or to the affiliate 500 regarding an order. The facilitator module also allows the facilitator user to review information communicated from the agency 100 and/or the affiliate 500. The facilitator 200 accesses the facilitator module via the Internet. Only authorized facilitator users may view and/or edit information stored in the memory system of the computer system 400. Also, only authorized facilitator users may add information to the memory system of the computer system 400.

The logon authorization process of accessing the facilitator module is similar to the logon authorization process for accessing the agency module discussed above and, therefore, will not be repeated here.

Once a facilitator user has successfully completed the logon process and accessed the secure information site of the facilitator module, an initial page is displayed that identifies information topics that the user has access to and provides electronic links to those topics.

Depending on the facilitator user's logon ID, the user may have access to any or all of the following information databases associated with the facilitator module, including information regarding orders; resources for managing the advertising business; FAQ; availability requests/projections; and proposals.

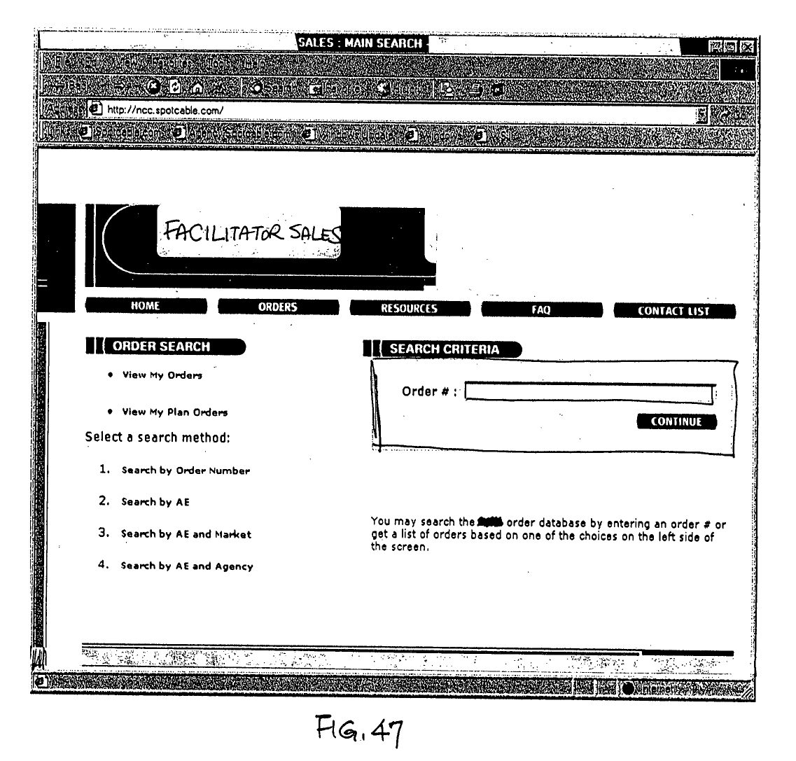

If the facilitator user selects to obtain information regarding orders, an order-information sub-module of the facilitator module is activated. Initially, an ORDER SEARCH page is displayed that gives the facilitator user the option of searching for orders according to specific criteria, such as shown in FIG. 47. For example, the user may choose to search for orders according to order number; name of the account executive; market; agency name; or a combination of such categories.

If the facilitator user selects to search for orders by order number by clicking on that category to highlight the text, a Search Criteria window appears within the ORDER SEARCH page, with an area for the user to input the order number to be searched.

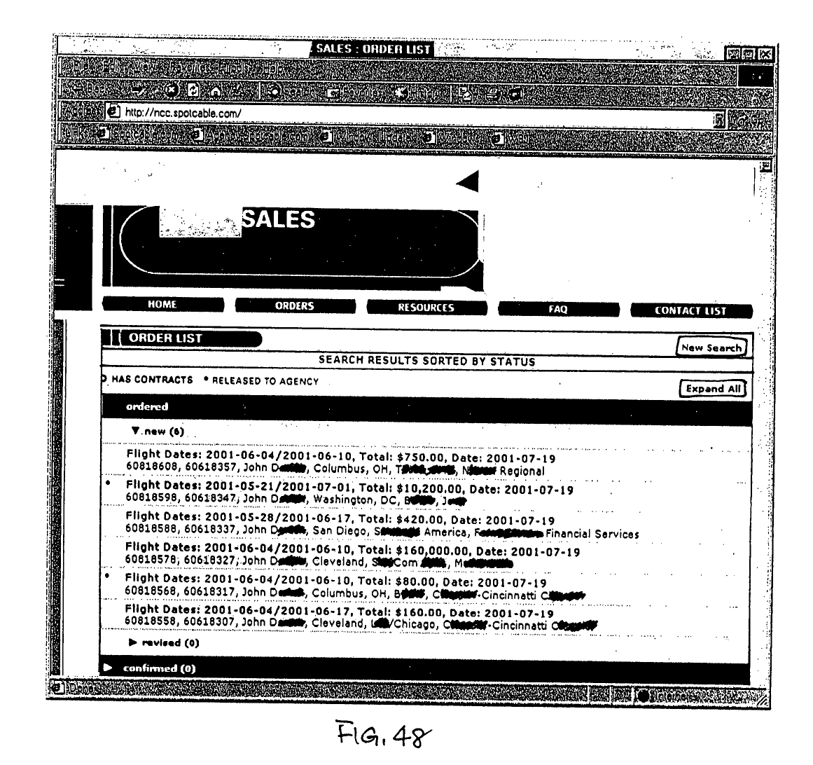

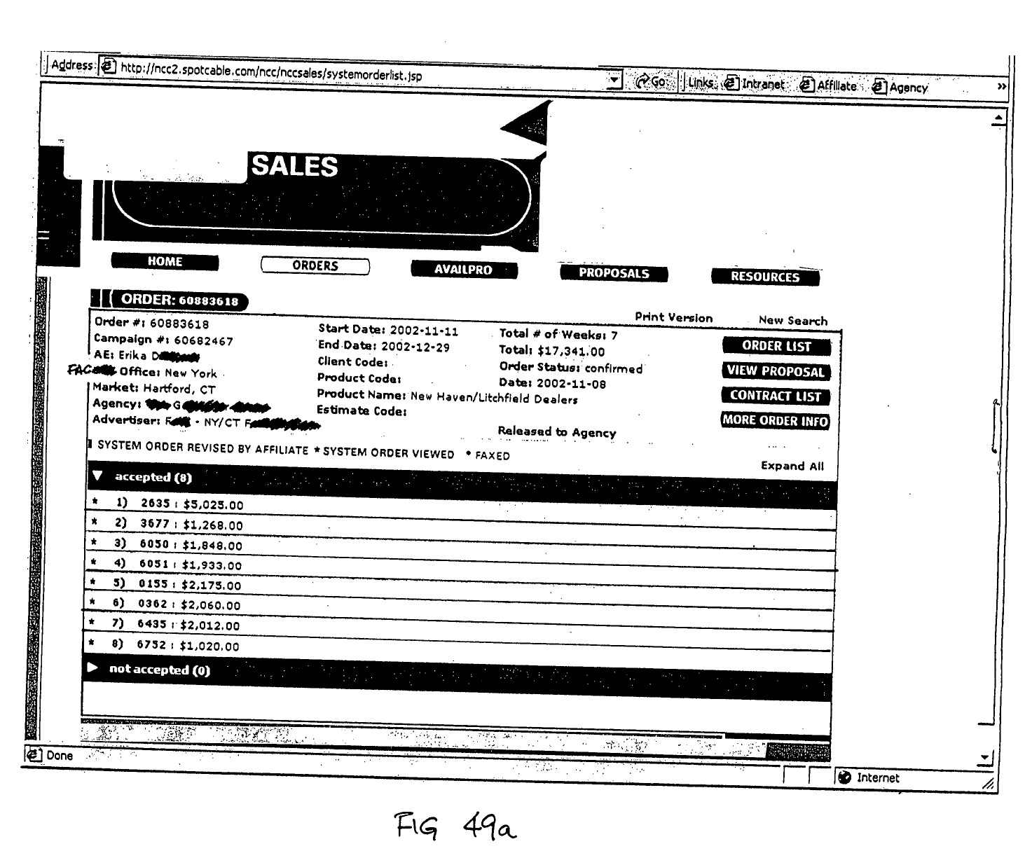

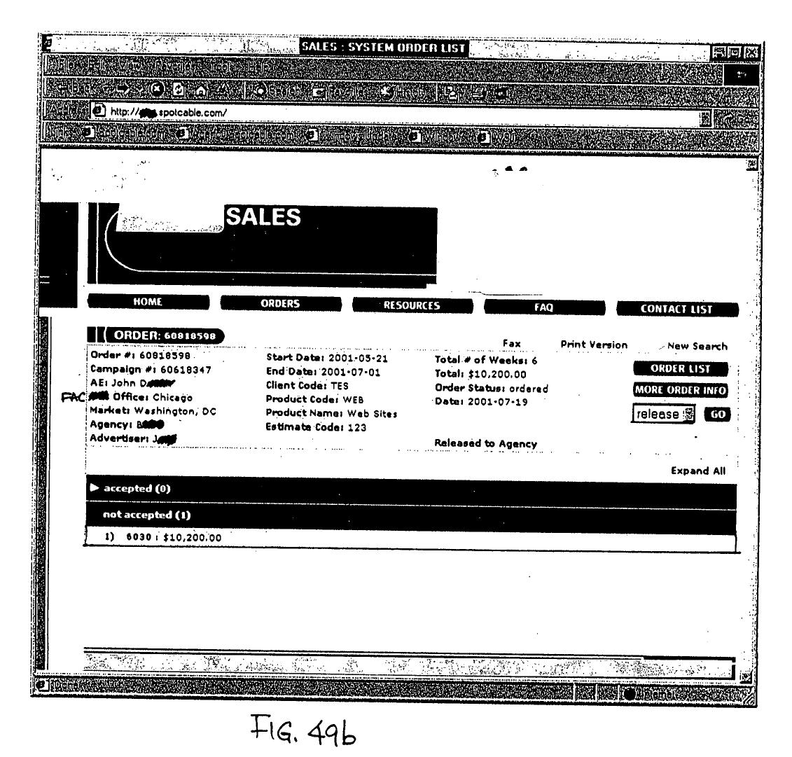

FIG. 48 shows an order list resulting from a search, based on information stored in one or more databases associated with the facilitator module. The order list includes status information on each order, such as information on whether the order has been released to the agency 100; has contracts; has been revised; or is new. To view more detailed information on all of the listed orders, the user clicks on the text “Expand All.”By pointing to and selecting one of the orders in the displayed list, detailed information regarding the selected order is displayed, such as shown in FIGS. 49a and 49b. The detailed information is the same information that an authorized agency user sees for that order.

The detailed order information includes information such as the order number; the campaign number code; the market; the account executive responsible for the order at the facilitator 200; the facilitator office; the start and end dates of the ad; the total number of weeks the ad; the name of the advertising agency; the advertiser; the total amount of the ad; the estimate code; the client code; the product code; the product name. Information on whether the order has been released to the agency 100 is also included in the order information, as well as whether the order has been confirmed by the agency 100.

The detailed order information includes line entries for each system order of the order, and indicates whether a system order has been revised by the affiliate 500, viewed, and/or faxed. (As discussed earlier, an ad may be shown by multiple affiliates; a system order is a portion of the overall order being handled by a particular affiliate.) The line entries also indicate whether a system order has been accepted by the affiliate 500. To view more detailed information on all the listed system orders, the user clicks on the text “Expand All.”

The facilitator module allows the facilitator user to select to release the order to the agency 100, as shown in FIG. 49b.

As shown in FIG. 49a, electronic links allow the facilitator user to select to return to the order list, to view the proposal corresponding to the order, to view a list of contracts corresponding to the order, and view additional order information. Additionally, electronic links allow one to obtain a print version of the displayed order information and to perform a new search.

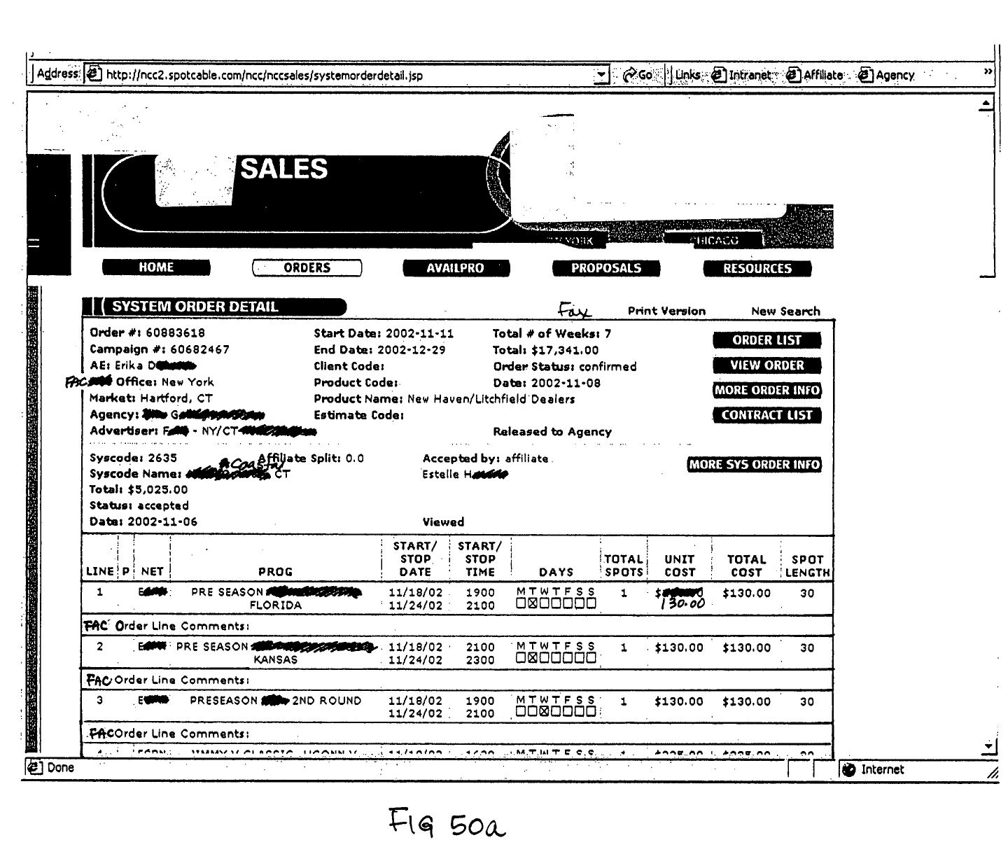

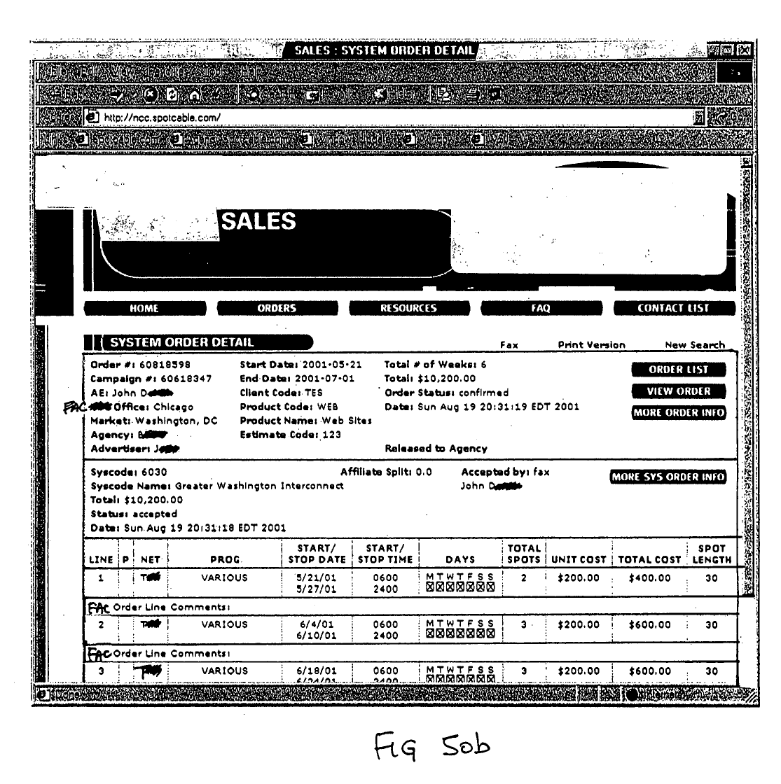

By pointing to and selecting one of the system orders in the displayed order list, detailed information regarding the selected system order is displayed, such as shown in FIGS. 50a and 50b. The detailed information may be the same information that an authorized affiliate user sees for that system order.

The detailed system-order information includes, for example, the system order number; the campaign number code; the market; the order number; the account executive responsible for the order at the facilitator 200; the facilitator office; the start and end dates of the ad; the total number of weeks the ad will or has run; the name of the advertising agency; the advertiser; the total amount of the ad; the status and date of the system order; the estimate code; the client code; the product code; the product name; the affiliate split; the method of acceptance; the name of the person that received the acceptance; the system code; and the name of the system code. Information on whether the system order has been released to the agency 100 is also included in the system-order information.

The displayed system-order information also includes a line item for each television station or network in the ad schedule. Each line item includes information identifying the television station; the program; the range of start and stop dates; the range of start and stop times; the days of the week; the total number of spots; the cost per spot; the spot duration or length; and the total cost of all the spots, for example.

From the displayed system-order information, electronic links allow the facilitator user to select to return to the detailed order-information display; view additional order information; view the order list; view a list of contracts corresponding to the order, and view additional system-order information. Additionally, electronic links allow the user to fax the system-order information; obtain a print version of the information; and perform a new search.

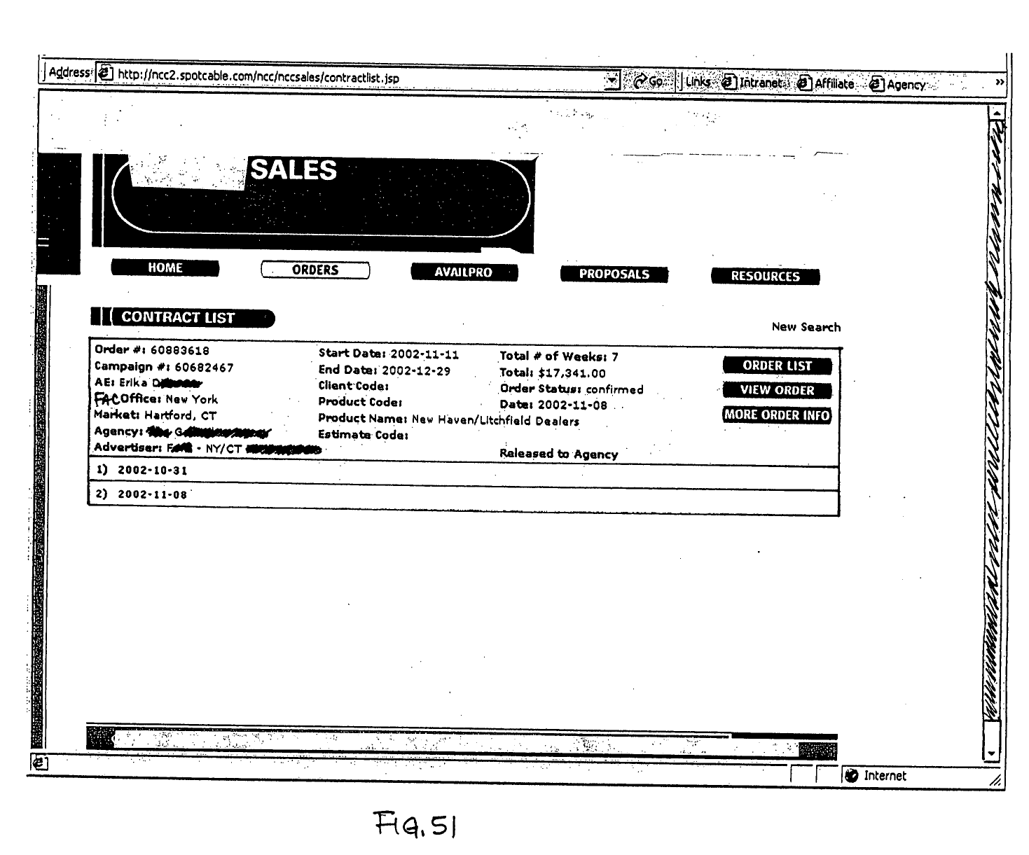

By clicking on the text “CONTRACT LIST” when the system-order information is displayed, a list of contracts is displayed for the order corresponding to the system order, such as shown in FIG. 51.

If the facilitator user clicks on “Print Version” when the system-order information is displayed, a printable version of the system-order information is displayed.

The order search feature described above enables the facilitator user to easily track the progress of an order for an ad and to easily view order information and contract information for the ad. The order information and the contract information are arranged in a manner that allows the user to quickly obtain useful information regarding the ad's status, and reduces or eliminates the need for the user to obtain and review a paper file of correspondence and other documents associated with the ad, which generally is more time consuming than using the facilitator module.

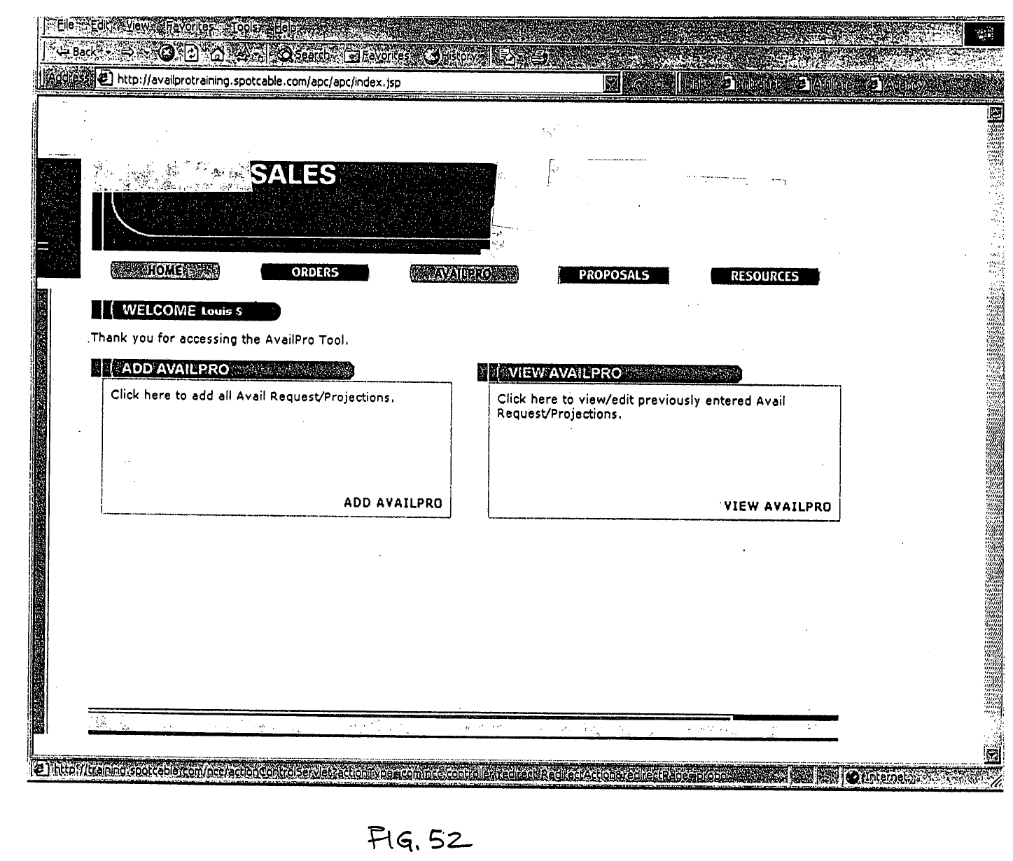

If the facilitator user clicks on the text “AVAILPRO” in the initial page, the facilitator module activates an availability request/projection sub-module, and a WELCOME page is displayed, such as shown in FIG. 52. The WELCOME page allows the user to select to add a new availability request/projection or to view/edit previously entered availability requests/projections.

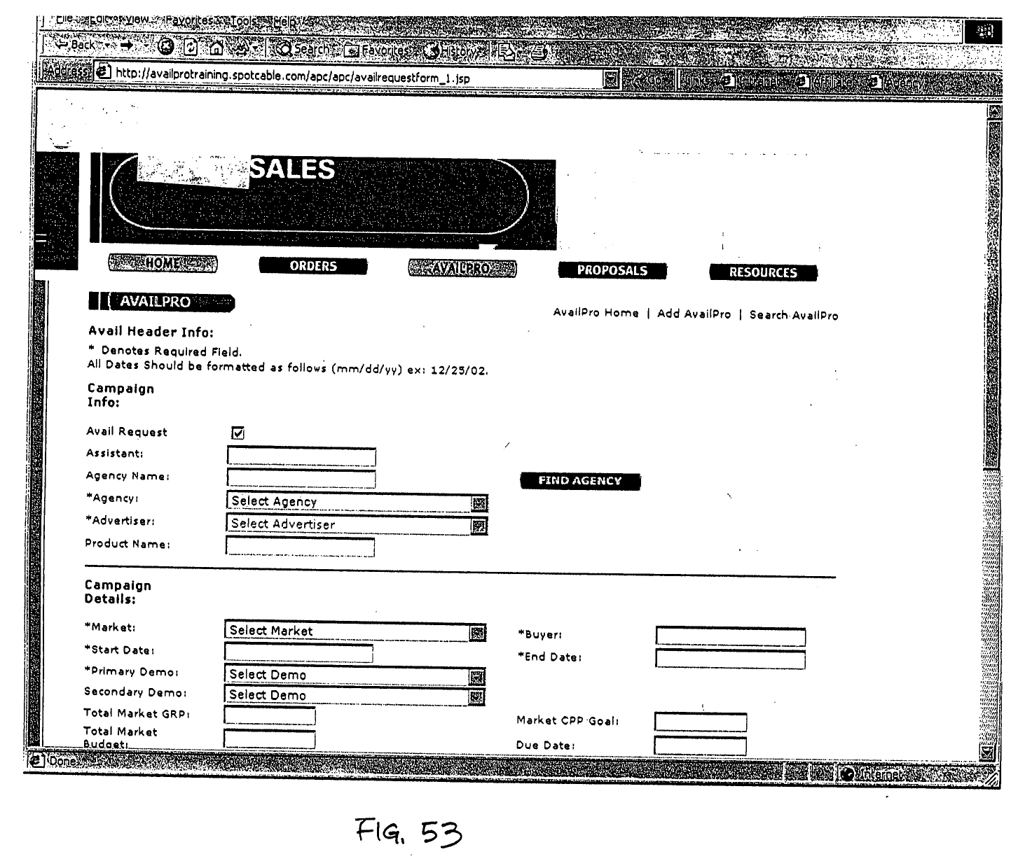

If the facilitator user selects to add an availability request/projection, a data entry page is displayed for the user to enter campaign information regarding the availability request, as shown in FIG. 53, as well as other information regarding the new request.

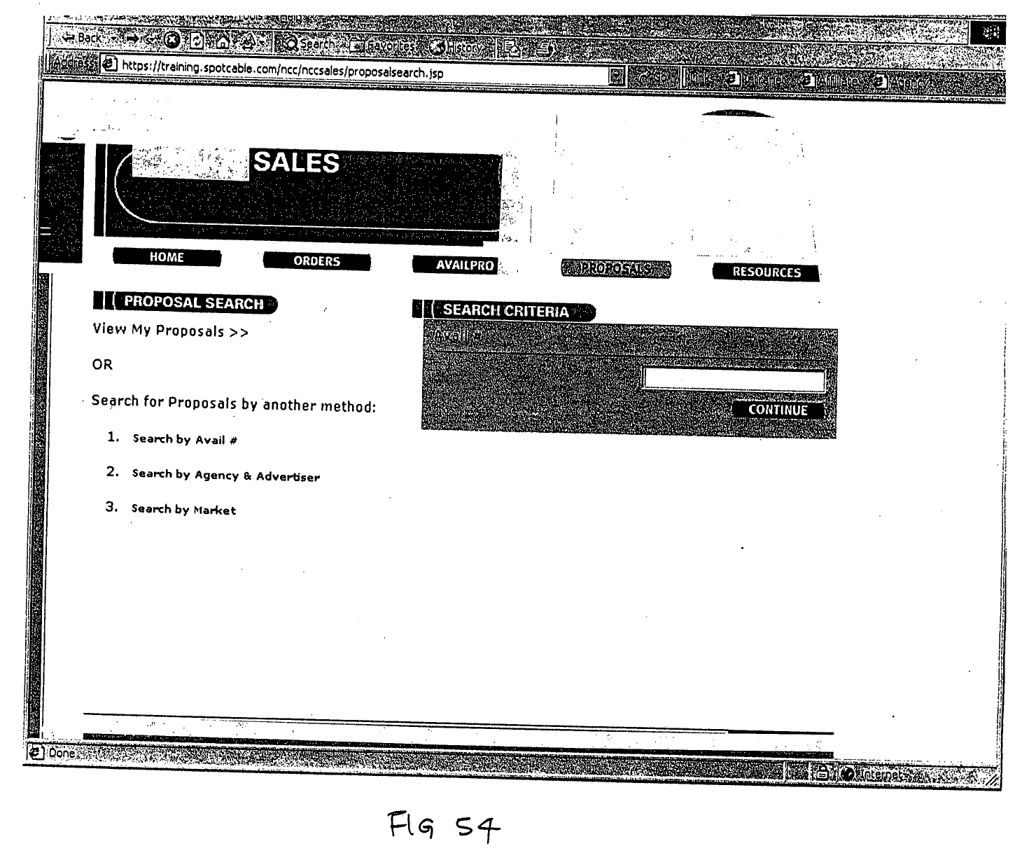

If the facilitator user clicks on the text “PROPOSALS” in the initial page, a PROPOSAL SEARCH page is displayed, as shown in FIG. 54. The PROPOSAL SEARCH page allows the user to view all proposals associated with the logon ID, or search for proposals by availability number; agency; advertiser; and market; and a combination of such categories. If the user selects to search for proposals by availability number by clicking on that category to highlight its text in the PROPOSAL SEARCH page, a Search Criteria window appears within the PROPOSAL SEARCH page, with an area for the user to input the availability number to be searched.

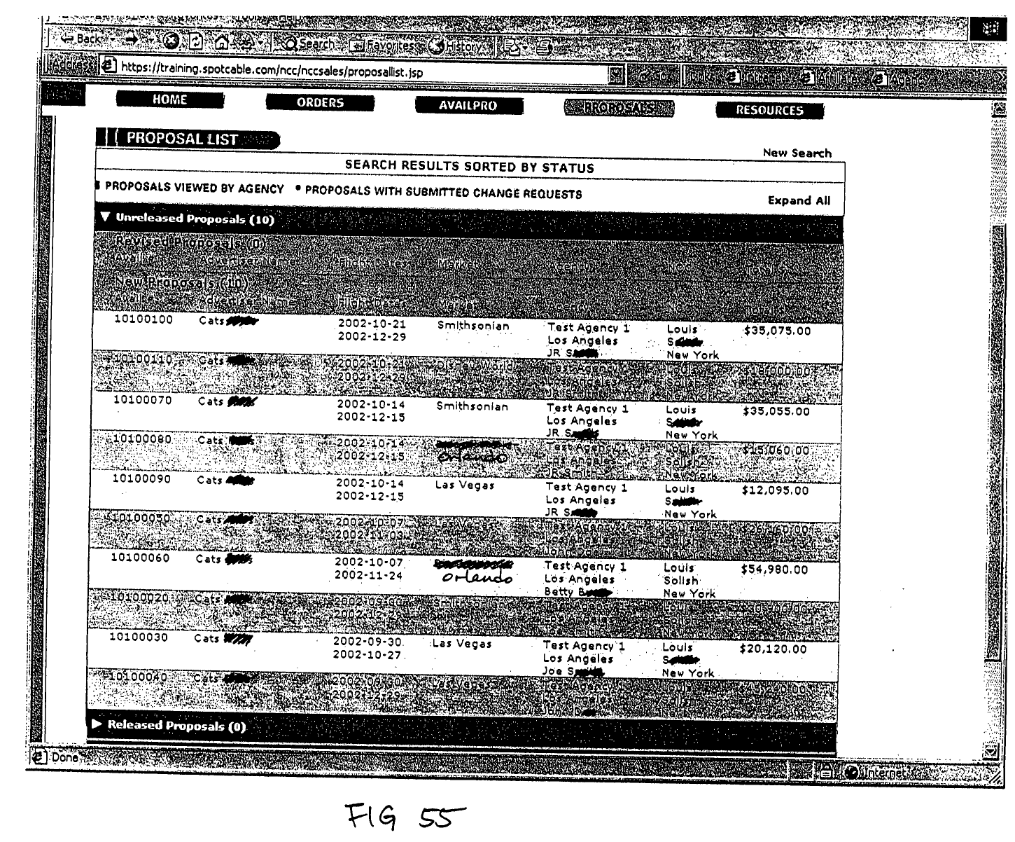

FIG. 55 shows a display of a proposal list resulting from a search performed by the facilitator module, based on search criteria inputted by the facilitator user and information stored in a database corresponding to the facilitator module. The proposal list provides information such as availability-request numbers; names of the advertisers; “flight” dates, which indicates a range of dates that the ads are proposed to be shown; geographic regions or markets; names of agency representatives handling the ads; names of facilitator representatives handling the ads; and amounts for the total cost of the proposed ads, for example. Status information is also provided in the proposal list, such as whether a proposal has been viewed by the agency 100; whether a change request has been submitted for a proposal; whether a proposal has been canceled; and whether a proposal has been released to the agency 100, for example.

In addition, as shown in FIG. 55, the proposal list includes electronic links to other sub-modules of the facilitator module, such as the order-information and availability request/projections sub-modules.

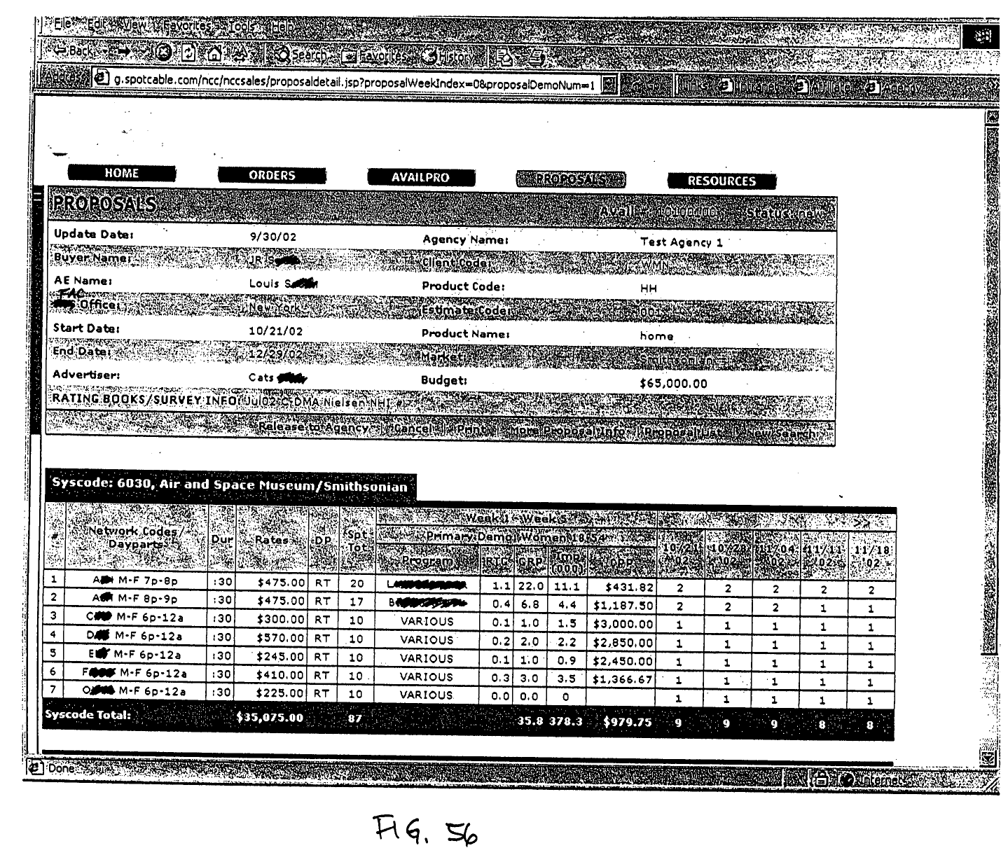

If the facilitator user selects a proposal by clicking on the text for that proposal in the proposal list, detailed information regarding the selected proposal is displayed, as shown in FIG. 56. The proposal details include information such as the update date; the name of the buyer; the account executive responsible for the proposal at the facilitator 200; the facilitator office; the start and end dates of the ad; the advertiser; the agency name; the estimate code; the client code; the product code; the product name; the geographic region or market the ad is proposed to run in; and the total budget for the ad, for example. The details also include a proposed schedule for airing the ads, including the affiliates; the date ranges and time ranges; the ad duration; the rates charged by the affiliates; the total number of spots; the name of the television programs that the ads are proposed to be shown during; the dates of the ads and the number of ads per date; and demographic information regarding the viewers of the television programs, for example. Additionally, the status of the proposal and whether it has been viewed by the agency 100 are displayed in the details.

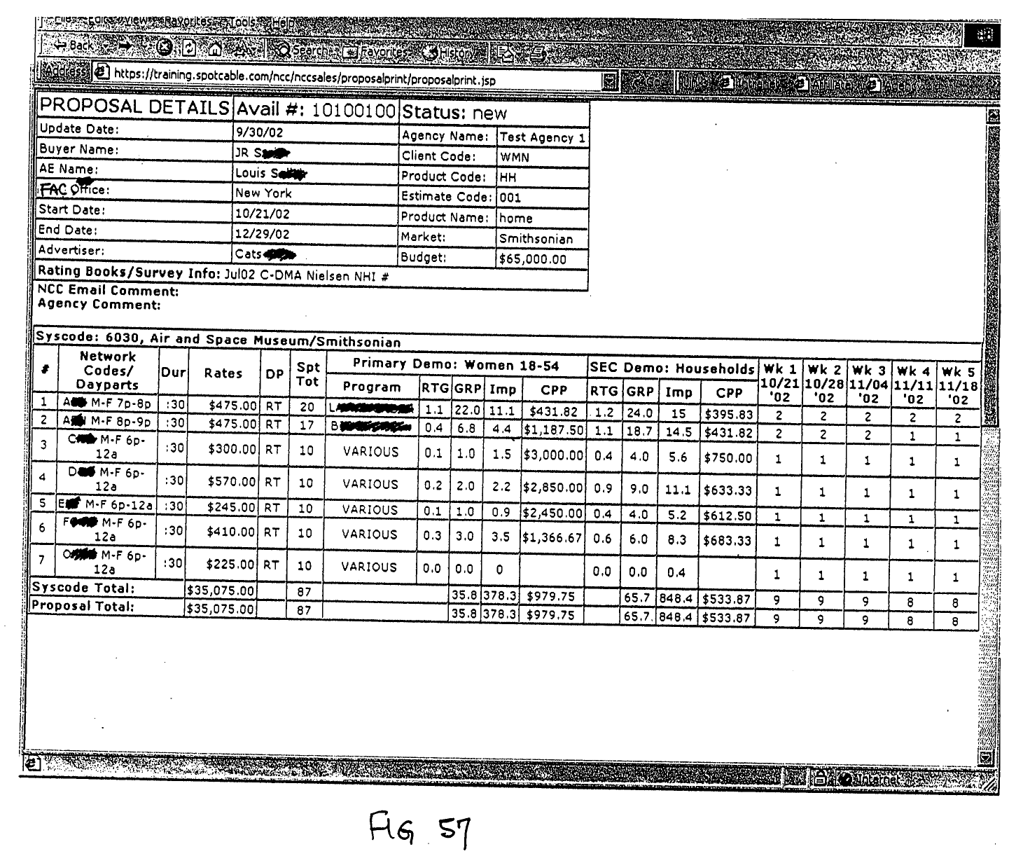

If the facilitator user clicks on the text “Print” in the display shown in FIG. 56, a printable version of the proposal is displayed, as shown in FIG. 57.

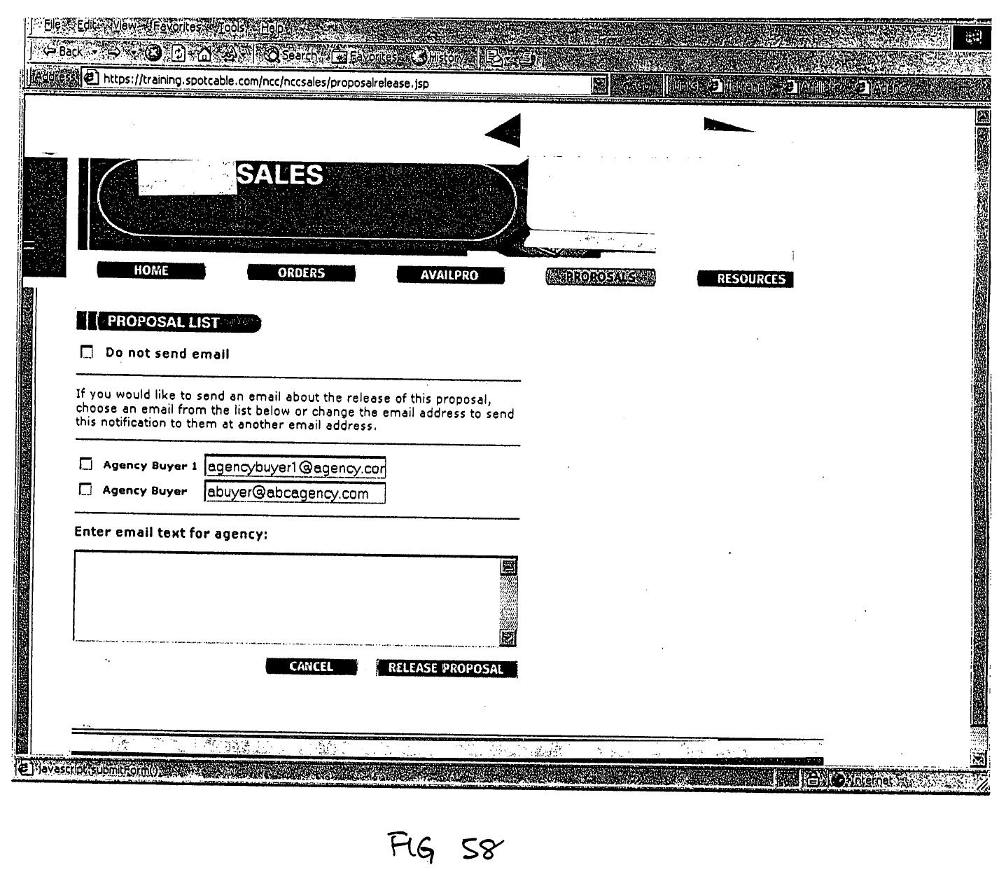

If the facilitator user clicks on the text “Release to Agency” in the display shown in FIG. 56, the proposal is released so that an authorized agency user (the agency representative handling the ad) may view that proposal via the agency module. The facilitator user may include comments for the agency representative. When the proposal is designated for release, a window is displayed for the facilitator user to input any comments that will appear with the proposal, as shown in FIG. 58. The comments also may be sent as an email message to the agency representative, by designating or inputting an email address. The message notifies the agency representative about the proposal, in case the agency representative is not logged-on to the agency module. The message also includes an electronic link to the proposal.

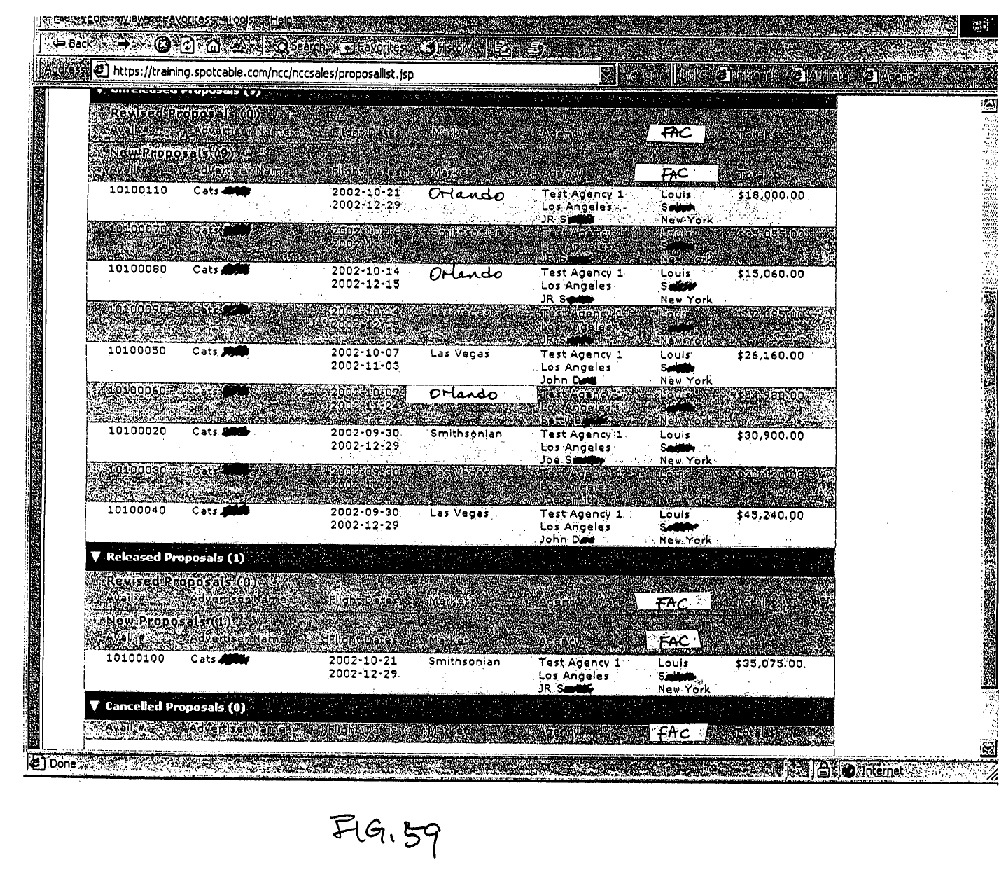

Once the proposal is released, its status is updated in the proposal list to a released proposal, as shown in FIG. 59.

The proposals sub-module described above enables the facilitator user to easily keep track of a proposal and to communicate with the agency 100 regarding various aspects of the proposal. The proposal information is arranged in a manner that allows the user to quickly obtain useful information regarding the proposal, including status information, without requiring the user to obtain and review a paper file of correspondence and other documents associated with the proposal, which generally is more time consuming than using the facilitator module.

The agency module allows an authorized facilitator user and the agency user to view the exact same proposal at the same time, to promote constructive dialog.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. For example, while the system has been described in a preferred embodiment as including three modules: agency, facilitator, and affiliate, it need not include all three modules. Further, although the foregoing discussion focuses on buying and selling spots for ads to be shown by local cable-television affiliates or television stations, the scope of the present invention is not limited only to ads for television broadcasts, but encompasses ads for any mass-market communication medium, including radio broadcasts, newspapers, and magazines, for example.

The scope of the following claims is to be accorded the broadest interpretation so as to encompass all such modifications and equivalent structures and functions.

What is claimed is:

1. A system for buying and selling spots for advertisements, said system comprising:
a central computer system connected to a global communications network;
an agency unit connected to the global communications network, said agency unit including a plurality of terminals for receiving information from and transmitting information to said computer system via the network, and said agency unit being used by an agency in a process for buying advertisement spots;
a facilitator unit connected to the global communications network, said facilitator unit including a plurality of terminals for receiving information from and transmitting information to said computer system via the network, and said facilitator unit being used by a facilitator in the process for buying advertisement spots and in a process for selling advertisement spots;
an affiliate unit connected to the global communications network, said affiliate unit including a plurality of terminals for receiving information from and transmitting information to said computer system via the network, and said affiliate unit being used by an affiliate in the process for selling advertisement spots,
wherein said computer system comprises a memory system storing a computer-executable program that includes an agency module, a facilitator module, and an affiliate module, such that:
the facilitator module enables an authorized facilitator user to input information to the memory system of the computer system regarding an advertisement, to view and/or edit the inputted information, and to perform communications with the agency and the affiliate regarding the advertisement,
the agency module enables an authorized agency user to view and/or obtain information regarding the advertisement from the memory system of the computer system, and to perform communications with the facilitator regarding the advertisement, and
the affiliate module enables an authorized affiliate user to view and/or obtain information regarding the advertisement from the memory system of the computer system, and to perform communications with the facilitator regarding the advertisement.

2. A system according to claim 1, wherein the agency module is adapted to enable the authorized agency user to:
submit an availability request to the facilitator regarding the advertisement;
view proposal information for a proposal from the facilitator regarding the availability request;
submit a response to the proposal to the facilitator;
if the proposal is accepted by the agency, view order information for an order to the affiliate regarding the advertisement, the order information including a schedule of spots for the advertisement;
if the order is accepted by the affiliate, view contract information for a contract automatically generated from the accepted order;
view invoice information for an invoice corresponding to the order;
download a version of the proposal information, the order information, the contract information, and/or the invoice information formatted for analysis using agency software; and
view and/or print a printable version of the proposal, the order, the contract, and/or the invoice information.

3. A system according to claim 2, wherein each of the proposal information, the order information, the contract information, and the invoice information includes status information for tracking a status of the proposal, the order, the contract, and the invoice, respectively.

4. A system according to claim 1, wherein the affiliate module is adapted to enable the authorized affiliate user to:
submit availability information to the facilitator regarding available spots for advertisements;
view order information for an order from the facilitator regarding the advertisement, the order information including a schedule of spots for the advertisement;
submit a response to the order to the facilitator;
if the order is accepted by the affiliate, view contract information for a contract automatically generated from the accepted order;
submit information regarding an affidavit of performance of the contract to the facilitator;
download a version of the order and/or the contract formatted for analysis using affiliate software; and
view and/or print a printable version of the order and/or the contract.

5. A system according to claim 4, wherein each of the order information and the contract information includes status information for tracking a status of the order and the contract, respectively.

6. A system according to claim 1, wherein the facilitator module is adapted to enable the authorized facilitator user to:
receive an availability request from the agency regarding the advertisement;
exchange availability information with the affiliate regarding available of spots for advertisements;
prepare a proposal for an advertisement schedule;
submit the proposal to the agency;
receive a response to the proposal from the agency;
revise the proposal;
if the proposal is accepted by the agency, generate an order from the accepted proposal;
submit the order to the affiliate;
receive a response to the order from the affiliate to the facilitator;
if the order is accepted by the affiliate, automatically generate a contract from the accepted order;
revise the order and submit the revised order to the affiliate;
if the revised order is accepted by the affiliate, automatically generate a contract from the accepted revised order;
store and update invoice information for an invoice corresponding to the order; and
receive information regarding an affidavit of performance of the contract from the affiliate.

7. A system according to claim 1, wherein multiple authorized agency users from multiple agencies may access the agency module.

8. A system according to claim 1, wherein multiple authorized affiliate users from multiple affiliates may access the affiliate module.

9. A system according to claim 1, wherein the network is comprised of an Internet network.

10. A system for buying spots for advertisements, said system comprising:
a central computer system connected to a global communications network;
an agency unit connected to the global communications network, said agency unit including a plurality of terminals for receiving information from and transmitting information to said computer system via the network, and said agency unit being used by an agency in a process for buying advertisement spots;
a facilitator unit connected to the global communications network, said facilitator unit including a plurality of terminals for receiving information from and transmitting information to said computer system via the network, and said facilitator unit being used by a facilitator in the process for buying advertisement spots;
wherein said computer system comprises a memory system storing a computer-executable program that includes an agency module and a facilitator module, such that:
the facilitator module enables an authorized facilitator user to input information to the memory system of the computer system regarding an advertisement, to view and/or edit the inputted information, and to perform communications with the agency, and
the agency module enables an authorized agency user to obtain information regarding the advertisement from the memory system of the computer system, and to perform communications with the facilitator user regarding the advertisement, and
wherein the agency module is adapted to implement any or all of:
a logon authorization process to permit only an authorized agency user to access the agency module;
a search of the memory system for orders associated with a logon ID of the authorized agency user, based on search criteria inputted by the authorized agency user;
cause a list of orders resulting from the search to be displayed;
cause information corresponding to an order selected from the list to be displayed;
cause proposal information, contract information, and/or invoice information corresponding to the selected order to be displayed;
convert the order information, the proposal information, the contract information, and/or the invoice information to a format selected by the authorized agency user, the format being compatible with agency software; and
download the converted order information, the converted proposal information, the converted contract information, and/or the converted invoice information to the agency unit.

11. A system according to claim 10, wherein the agency module is adapted to implement any or all of:
search of the memory system for proposals associated with a logon ID of the authorized agency user, based on search criteria inputted by the authorized agency user;
cause a list of proposals resulting from the search to be displayed;
cause information corresponding to a proposal selected from the list of proposals to be displayed;
enable the authorized agency user to input comments on each schedule entry of a plurality of schedule entries of the selected proposal;
generate a printable version of the proposal information.

12. A system according to claim 10, wherein the agency module is adapted to implement any or all of:
perform a search of the memory system for invoice information associated with a logon ID of the authorized agency user, based on search criteria inputted by the authorized agency user;
cause a list of invoices resulting from the search to be displayed;
cause information corresponding to an invoice selected from the list of invoices to be displayed;
convert the invoice information to a format selected by the authorized agency user, the format being compatible with agency software; and
download the converted invoice information to the agency unit.

13. A system according to any one of claims 10, 11, and 12, wherein the network is comprised of an Internet network.

14. A system for selling spots for advertisements, said system comprising:
a central computer system connected to a global communications network;
an affiliate unit connected to the global communications network, said affiliate unit including a plurality of terminals for receiving information from and transmitting information to said computer system via the network, and said affiliate unit being used by an affiliate in a process for selling advertisement spots;
a facilitator unit connected to the global communications network, said facilitator unit including a plurality of terminals for receiving information from and transmitting information to said computer system via the network, and said facilitator unit being used by a facilitator in the process for selling advertisement spots;
wherein said computer system comprises a memory system storing a computer-executable program that includes an affiliate module and a facilitator module, such that:
the facilitator module enables an authorized facilitator user to input information to the memory system of the computer system regarding an advertisement, to view and/or edit the inputted information, and to perform communications with the affiliate, and
the affiliate module enables an authorized affiliate user to obtain information regarding the advertisement from the memory system of the computer system, and to perform communications with the facilitator user regarding the advertisement, and
wherein the affiliate module is adapted to implement any or all of:
a logon authorization process to permit only an authorized affiliate users to access the affiliate module;
a search of the memory system for orders associated with a logon ID of the authorized affiliate user, based on search criteria inputted by the authorized affiliate user;
cause a list of orders resulting from the search to be displayed;
cause information corresponding to an order selected from the list to be displayed;
cause contract information corresponding to the selected order to be displayed;
convert the order information and/or the contract information to a format selected by the authorized agency user, the format being compatible with agency software; and
download the converted order information and/or the converted contract information to the affiliate unit.

15. A system according to claim 13, wherein the network is comprised of an Internet network.

16. A method for buying spots for advertisements utilizing a central computer system with a memory system storing a computer-executable program that includes an agency module, a facilitator module, and an affiliate module, and utilizing a global communications network interconnecting the computer system, an agency, a facilitator, and an affiliate, said method comprising the steps of:
the agency submitting, via the agency module and the network, an availability request to the facilitator regarding the advertisement;
the agency viewing, via the agency module and the network, proposal information for a proposal from the facilitator regarding the availability request;
the agency submitting, via the agency module and the network, a response to the proposal to the facilitator;
if the proposal is accepted by the agency, the agency viewing, via the agency module and the network, order information for an order to the affiliate regarding the advertisement, the order information including a schedule of spots for the advertisement;
if the order is accepted by the affiliate, the agency viewing, via the agency module and the network, contract information for a contract automatically generated from the accepted order;
the agency viewing, via the agency module and the network, invoice information for an invoice corresponding to the order;
the agency selecting, via the agency module, a format for downloading the proposal information, the order information, the contract information, and/or the invoice information, such that information downloaded in the selected format is compatible with and may be is further analyzed using agency software; and
the agency viewing and/or printing, via the agency module and the network, a printable version of the proposal, the order, the contract, and/or the invoice information.

17. A method according to claim 16, wherein each of the proposal information, the order information, the contract information, and the invoice information includes status information for tracking a status of the proposal, the order, the contract, and the invoice, respectively.

18. A method for selling spots for advertisements utilizing a central computer system with a memory system storing a computer-executable program that includes an agency module, a facilitator module, and an affiliate module, and utilizing a global communications network interconnecting the computer system, an agency, a facilitator, and an affiliate, said method comprising the steps of:
the affiliate submitting, via the affiliate module and the network, availability information to the facilitator regarding available spots for advertisements;
the affiliate viewing, via the affiliate module and the network, order information for an order from the facilitator regarding the advertisement, the order information including a schedule of spots for the advertisement;
the affiliate submitting, via the affiliate module and the network, a response to the order to the facilitator;
if the order is accepted by the affiliate, the affiliate viewing, via the affiliate module and the network, contract information for a contract automatically generated from the accepted order;
the affiliate submitting, via the affiliate module and the network, information regarding an affidavit of performance of the contract to the facilitator;
the affiliate selecting, via the affiliate module, a format for downloading the order information and/or the contract information, such that information downloaded in the selected format is compatible with and may be analyzed using affiliate software; and
the affiliate viewing and/or printing, via the affiliate module and the network, a printable version of the order and/or the contract.

19. A method according to claim 18, wherein each of the order information and the contract information includes status information for tracking a status of the order and the contract, respectively.

20. A method according to any one of claims 16 and 18, wherein the facilitator module is adapted to enable the authorized facilitator user to:
receive an availability request from the agency regarding the advertisement;
exchange availability information with the affiliate regarding available of spots for advertisements;
prepare a proposal for an advertisement schedule;
submit the proposal to the agency;
receive a response to the proposal from the agency;
revise the proposal;
if the proposal is accepted by the agency, generate an order from the accepted proposal;
submit the order to the affiliate;
receive a response to the order from the affiliate to the facilitator;
if the order is accepted by the affiliate, automatically generate a contract from the accepted order;
revise the order and submit the revised order to the affiliate;
if the revised order is accepted by the affiliate, automatically generate a contract from the accepted revised order;
store and update invoice information for an invoice corresponding to the order; and
receive information regarding an affidavit of performance of the contract from the affiliate.

21. A method according to any one of claims 16 and 18, wherein the network is comprised of an Internet network.

22. A method for buying spots for advertisements utilizing a central computer system with a memory system storing a computer-executable program that includes an agency module, a facilitator module, and an affiliate module, and utilizing a global communications network interconnecting the computer system, an agency, a facilitator, and an affiliate, said method comprising the steps of:
performing, via the agency module and the network, a logon authorization process to permit only an authorized agency user to access the agency module;
inputting, via the agency module and the network, search criteria for searching for orders;
searching the memory system, via the agency module and the network, for orders associated with a logon ID of the authorized agency user, based on the inputted search criteria;
the agency module causing a list of orders resulting from the search to be displayed;
selecting, via the agency module and the network, an order from the list of orders;
the agency module causing information corresponding to the selected order to be displayed;
the agency module causing proposal information, contract information, and/or invoice information corresponding to the selected order to be displayed;
selecting, via the agency module and the network, a download format that is compatible with agency software;
the agency module converting the order information, the proposal information, the contract information, and/or the invoice information to the selected format; and
the agency module downloading the converted order information, the converted proposal information, the converted contract information, and/or the converted invoice information to the agency unit.

23. A method according to claim 22, further comprising the steps of:
inputting, via the agency module and the network, search criteria for searching for proposals;
searching, via the agency module and the network, the memory system for proposals associated with the logon ID of the authorized agency user, based on the inputted search criteria;
the agency module causing a list of proposals resulting from the search to be displayed;
selecting, via the agency module and the network, a proposal from the list of proposals;
the agency module causing information corresponding to the selected proposal to be displayed;
inputting, via the agency module and the network, comments on each schedule entry of a plurality of schedule entries of the selected proposal; and
generating, via the agency module and the network, a printable version of the proposal information.

24. A method according to claim 22, further comprising the steps of:
inputting, via the agency module and the network, search criteria for searching for invoice information;
searching, via the agency module and the network, the memory system for invoice information associated with the logon ID of the authorized agency user, based on the inputted search criteria;
the agency module causing a list of invoices resulting from the search to be displayed;
selecting, via the agency module and the network, an invoice from the list of invoices;
the agency module causing information corresponding to the selected invoice to be displayed;
selecting, via the agency module and the network, a download format that is compatible with agency software;
the agency module converting the invoice information to the selected format; and
the agency module downloading the converted invoice information to the agency unit.

25. A method according to any one of claims 22, 23, and 24, wherein the network is comprised of an Internet network.

26. A method for selling spots for advertisements utilizing a central computer system with a memory system storing a computer-executable program that includes an agency module, a facilitator module, and an affiliate module, and utilizing a global communications network interconnecting the computer system, an agency, a facilitator, and an affiliate, said method comprising the steps of:
performing, via the affiliate module and the network, a logon authorization process to permit only an authorized affiliate users to access the affiliate module;
inputting, via the affiliate module and the network, search criteria for searching for orders;
searching the memory system, via the affiliate module and the network, for orders associated with a logon ID of the authorized affiliate user, based on the inputted search criteria;
the affiliate module causing a list of orders resulting from the search to be displayed;
selecting, via the affiliate module and the network, an order from the list of orders;
the affiliate module causing information corresponding to the selected order to be displayed;
the affiliate module causing contract information corresponding to the selected order to be displayed;
selecting, via the affiliate module and the network, a download format that is compatible with affiliate software;
the affiliate module converting the order information and/or the contract information to the selected format; and
the agency module downloading the converted order information and/or the converted contract information to the affiliate unit.

27. A method according to claim 26, wherein the network is comprised of an Internet network.

28. A programmable computer for implementing a method of buying spots for an advertisement, said programmable computer comprising a memory system storing a computer-executable program that includes an agency module, a facilitator module, and an affiliate module,
wherein said programmable computer is connected to an agency, a facilitator, and an affiliate via a global communications network, and
wherein the method comprising the steps of:
the agency submitting, via the agency module and the network, an availability request to the facilitator regarding the advertisement;
the agency viewing, via the agency module and the network, proposal information for a proposal from the facilitator regarding the availability request;
the agency submitting, via the agency module and the network, a response to the proposal to the facilitator;
if the proposal is accepted by the agency, the agency viewing, via the agency module and the network, order information for an order to the affiliate regarding the advertisement, the order information including a schedule of spots for the advertisement;
if the order is accepted by the affiliate, the agency viewing, via the agency module and the network, contract information for a contract automatically generated from the accepted order;
the agency viewing, via the agency module and the network, invoice information for an invoice corresponding to the order;
the agency selecting, via the agency module, a format for downloading the proposal information, the order information, the contract information, and/or the invoice information, such that information downloaded in the selected format is compatible with and may be is further analyzed using agency software; and
the agency viewing and/or printing, via the agency module and the network, a printable version of the proposal, the order, the contract, and/or the invoice information.

29. A programmable computer for implementing a method of selling spots for an advertisement, said programmable computer comprising a memory system storing a computer-executable program that includes an agency module, a facilitator module, and an affiliate module,
wherein said programmable computer is connected to an agency, a facilitator, and an affiliate via a global communications network, and
wherein the method comprising the steps of:
the affiliate submitting, via the affiliate module and the network, availability information to the facilitator regarding available spots for advertisements;
the affiliate viewing, via the affiliate module and the network, order information for an order from the facilitator regarding the advertisement, the order information including a schedule of spots for the advertisement;
the affiliate submitting, via the affiliate module and the network, a response to the order to the facilitator;
if the order is accepted by the affiliate, the affiliate viewing, via the affiliate module and the network, contract information for a contract automatically generated from the accepted order;
the affiliate submitting, via the affiliate module and the network, information regarding an affidavit of performance of the contract to the facilitator;
the affiliate selecting, via the affiliate module, a format for downloading the order information and/or the contract information, such that information downloaded in the selected format is compatible with and may be analyzed using affiliate software; and
the affiliate viewing and/or printing, via the affiliate module and the network, a printable version of the order and/or the contract.

30. A programmable computer according to any one of claims 28 and 29, wherein the facilitator module is adapted to the facilitator to:
receive an availability request from the agency regarding the advertisement;
exchange availability information with the affiliate regarding available of spots for advertisements;
prepare a proposal for an advertisement schedule;
submit the proposal to the agency;
receive a response to the proposal from the agency;
revise the proposal;
if the proposal is accepted by the agency, generate an order from the accepted proposal;
submit the order to the affiliate;
receive a response to the order from the affiliate to the facilitator;
if the order is accepted by the affiliate, automatically generate a contract from the accepted order;
revise the order and submit the revised order to the affiliate;
if the revised order is accepted by the affiliate, automatically generate a contract from the accepted revised order;
store and update invoice information for an invoice corresponding to the order; and
receive information regarding an affidavit of performance of the contract from the affiliate.

31. A programmable computer for implementing a method of buying spots for an advertisement, said programmable computer comprising a memory system storing a computer-executable program that includes an agency module, a facilitator module, and an affiliate module,
wherein said programmable computer is connected to an agency, a facilitator, and an affiliate via a global communications network, and
wherein the method comprises the steps of:
performing, via the agency module and the network, a logon authorization process to permit only an authorized agency user to access the agency module;
inputting, via the agency module and the network, search criteria for searching for orders;
searching the memory system, via the agency module and the network, for orders associated with a logon ID of the authorized agency user, based on the inputted search criteria;
the agency module causing a list of orders resulting from the search to be displayed;
the authorized agency user selecting, via the agency module and the network, an order from the list of orders;
the agency module causing information corresponding to the selected order to be displayed;
the agency module causing proposal information, contract information, and/or invoice information corresponding to the selected order to be displayed;
selecting, via the agency module and the network, a download format that is compatible with agency software;
the agency module converting the order information, the proposal information, the contract information, and/or the invoice information to the selected format; and
the agency module downloading the converted order information, the converted proposal information, the converted contract information, and/or the converted invoice information to the agency unit.

32. A programmable computer according to claim 31, wherein the method further comprises the steps of:
inputting, via the agency module and the network, search criteria for searching for proposals;
searching, via the agency module and the network, the memory system for proposals associated with a logon ID of the authorized agency user, based on the inputted search criteria;
the agency module causing a list of proposals resulting from the search to be displayed;
selecting, via the agency module and the network, a proposal from the list of proposals;
the agency module causing information corresponding to the selected proposal to be displayed;
inputting, via the agency module and the network, comments on each schedule entry of a plurality of schedule entries of the selected proposal; and
generating, via the agency module and the network, a printable version of the proposal information.

33. A programmable computer according to claim 31, wherein the method further comprises the steps of:
inputting, via the agency module and the network, search criteria for searching for invoice information;
searching, via the agency module and the network, the memory system for invoice information associated with a logon ID of the authorized agency user, based on the inputted search criteria;
the agency module causing a list of invoices resulting from the search to be displayed;
selecting, via the agency module and the network, an invoice from the list of invoices;
the agency module causing information corresponding to the selected invoice to be displayed;
selecting, via the agency module and the network, a download format that is compatible with agency software;
the agency module converting the invoice information to the selected format; and
the agency module downloading the converted invoice information to the agency unit.

34. A programmable computer for implementing a method of selling spots for an advertisement, said programmable computer comprising a memory system storing a computer-executable program that includes an agency module, a facilitator module, and an affiliate module,
wherein said programmable computer is connected to an agency, a facilitator, and an affiliate via a global communications network, and
wherein the method comprises the steps of:
performing, via the affiliate module and the network, a logon authorization process to permit only an authorized affiliate users to access the affiliate module;
inputting, via the affiliate module and the network, search criteria for searching for orders;
searching the memory system, via the affiliate module and the network, for orders associated with a logon ID of the authorized affiliate user, based on the inputted search criteria;
the affiliate module causing a list of orders resulting from the search to be displayed;
selecting, via the affiliate module and the network, an order from the list of orders;
the affiliate module causing information corresponding to the selected order to be displayed;
the affiliate module causing contract information corresponding to the selected order to be displayed;
selecting, via the affiliate module and the network, a download format that is compatible with affiliate software;
the affiliate module converting the order information and/or the contract information to the selected format; and
the agency module downloading the converted order information and/or the converted contract information to the affiliate unit.

35. A computer-program product embodying a computer-executable program for implementing a method of buying spots for an advertisement using a programmable computer, said computer-program product comprising:
an agency module;
a facilitator module; and
an affiliate module,
wherein the programmable computer is connected to an agency, a facilitator, and an affiliate via a global communications network, and
wherein the method comprises the steps of:
the agency submitting, via the agency module and the network, an availability request to the facilitator regarding the advertisement;
the agency viewing, via the agency module and the network, proposal information for a proposal from the facilitator regarding the availability request;
the agency submitting, via the agency module and the network, a response to the proposal to the facilitator;
if the proposal is accepted by the agency, the agency viewing, via the agency module and the network, order information for an order to the affiliate regarding the advertisement, the order information including a schedule of spots for the advertisement;
if the order is accepted by the affiliate, the agency viewing, via the agency module and the network, contract information for a contract automatically generated from the accepted order;
the agency viewing, via the agency module and the network, invoice information for an invoice corresponding to the order;
the agency selecting, via the agency module, a format for downloading the proposal information, the order information, the contract information, and/or the invoice information, such that information downloaded in the selected format is compatible with and may be is further analyzed using agency software; and
the agency viewing and/or printing, via the agency module and the network, a printable version of the proposal, the order, the contract, and/or the invoice information.

36. A computer-program product embodying a computer-executable program for implementing a method of selling spots for an advertisement using a programmable computer, said computer-program product comprising:
an agency module;
a facilitator module; and
an affiliate module,
wherein the programmable computer is connected to an agency, a facilitator, and an affiliate via a global communications network, and
wherein the method comprises the steps of:
the affiliate submitting, via the affiliate module and the network, availability information to the facilitator regarding available spots for advertisements;
the affiliate viewing, via the affiliate module and the network, order information for an order from the facilitator regarding the advertisement, the order information including a schedule of spots for the advertisement;
the affiliate submitting, via the affiliate module and the network, a response to the order to the facilitator;
if the order is accepted by the affiliate, the affiliate viewing, via the affiliate module and the network, contract information for a contract automatically generated from the accepted order;
the affiliate submitting, via the affiliate module and the network, information regarding an affidavit of performance of the contract to the facilitator;
the affiliate selecting, via the affiliate module, a format for downloading the order information and/or the contract information, such that information downloaded in the selected format is compatible with and may be analyzed using affiliate software; and
the affiliate viewing and/or printing, via the affiliate module and the network, a printable version of the order and/or the contract.

37. A computer-program product according to any one of claims 35 and 36, wherein the facilitator module is adapted to enable an authorized facilitator user to:
receive an availability request from the agency regarding the advertisement;
exchange availability information with the affiliate regarding available of spots for advertisements;
prepare a proposal for an advertisement schedule;
submit the proposal to the agency;
receive a response to the proposal from the agency;
revise the proposal;
if the proposal is accepted by the agency, generate an order from the accepted proposal;
submit the order to the affiliate;
receive a response to the order from the affiliate to the facilitator;
if the order is accepted by the affiliate, automatically generate a contract from the accepted order;
revise the order and submit the revised order to the affiliate;
if the revised order is accepted by the affiliate, automatically generate a contract from the accepted revised order;
store and update invoice information for an invoice corresponding to the order; and
receive information regarding an affidavit of performance of the contract from the affiliate.

38. A computer-program product embodying a computer-executable program for implementing a method of buying spots for an advertisement using a programmable computer, said computer-program product comprising:
an agency module;
a facilitator module; and
an affiliate module,
wherein the programmable computer is connected to an agency, a facilitator, and an affiliate via a global communications network, and
wherein the method comprises the steps of:
performing, via the agency module and the network, a logon authorization process to permit only an authorized agency user to access the agency module;
inputting, via the agency module and the network, search criteria for searching for orders;
searching the memory system, via the agency module and the network, for orders associated with a logon ID of the authorized agency user, based on the inputted search criteria;
the agency module causing a list of orders resulting from the search to be displayed;
selecting, via the agency module and the network, an order from the list of orders;
the agency module causing information corresponding to the selected order to be displayed;
the agency module causing proposal information, contract information, and/or invoice information corresponding to the selected order to be displayed;
selecting, via the agency module and the network, a download format that is compatible with agency software;
the agency module converting the order information, the proposal information, the contract information, and/or the invoice information to the selected format; and
the agency module downloading the converted order information, the converted proposal information, the converted contract information, and/or the converted invoice information to the agency unit.

39. A computer-program product according to claim 38, wherein the method further comprises the steps of:
inputting, via the agency module and the network, search criteria for searching for proposals;
searching, via the agency module and the network, the memory system for proposals associated with the logon ID of the authorized agency user, based on the inputted search criteria;
the agency module causing a list of proposals resulting from the search to be displayed;
selecting, via the agency module and the network, a proposal from the list of proposals;
the agency module causing information corresponding to the selected proposal to be displayed;
inputting, via the agency module and the network, comments on each schedule entry of a plurality of schedule entries of the selected proposal; and
generating, via the agency module and the network, a printable version of the proposal information.

40. A computer-program product according to claim 38, wherein the method further comprises the steps of:
inputting, via the agency module and the network, search criteria for searching for invoice information;
searching, via the agency module and the network, the memory system for invoice information associated with the logon ID of the authorized agency user, based on the inputted search criteria;
the agency module causing a list of invoices resulting from the search to be displayed;
selecting, via the agency module and the network, an invoice from the list of invoices;
the agency module causing information corresponding to the selected invoice to be displayed;
selecting, via the agency module and the network, a download format that is compatible with agency software;
the agency module converting the invoice information to the selected format; and
the agency module downloading the converted invoice information to the agency unit.

41. A computer-program product embodying a computer-executable program for implementing a method of selling spots for an advertisement using a programmable computer, said computer-program product comprising:
an agency module;
a facilitator module; and
an affiliate module,
wherein the programmable computer is connected to an agency, a facilitator, and an affiliate via a global communications network, and
wherein the method comprises the steps of:
performing, via the affiliate module and the network, a logon authorization process to permit only an authorized affiliate users to access the affiliate module;
inputting, via the affiliate module and the network, search criteria for searching for orders;
searching the memory system, via the affiliate module and the network, for orders associated with a logon ID of the authorized affiliate user, based on the inputted search criteria;
the affiliate module causing a list of orders resulting from the search to be displayed;
selecting, via the affiliate module and the network, an order from the list of orders;
the affiliate module causing information corresponding to the selected order to be displayed;
the affiliate module causing contract information corresponding to the selected order to be displayed;
selecting, via the affiliate module and the network, a download format that is compatible with affiliate software;
the affiliate module converting the order information and/or the contract information to the selected format; and
the agency module downloading the converted order information and/or the converted contract information to the affiliate unit.
